(19) United States
(12) Patent Application Publication
(10) Pub. No.: US 2026/0048671 A1
(43) Pub. Date: Feb. 19, 2026

(54) BATTERY MODULE SYSTEMS, ASSEMBLIES, AND METHODS OF MANUFACTURE

(71) Applicant: ELECTRIC POWER SYSTEMS, INC., North Logan, UT (US)

(72) Inventors: Joseph James, Hyde Park, UT (US); Michael Armstrong, North Logan, UT (US); Daniel Lane, North Logan, UT (US); Wyatt Brown, North Logan, UT (US)

(73) Assignee: ELECTRIC POWER SYSTEMS, INC., North Logan, UT (US)

(21) Appl. No.: 19/366,955

(22) Filed: Oct. 23, 2025

Related U.S. Application Data
(63) Continuation of application No. PCT/US2024/026608, filed on Apr. 26, 2024.
(60) Provisional application No. 63/462,177, filed on Apr. 26, 2023.
(60) Provisional application No. 63/462,179, filed on Apr. 26, 2023.
(60) Provisional application No. 63/462,185, filed on Apr. 26, 2023.
(60) Provisional application No. 63/462,188, filed on Apr. 26, 2023.
(60) Provisional application No. 63/614,365, filed on Dec. 22, 2023.

(51) Int. Cl. B60L 50/64; H01M 10/613; H01M 10/625; H01M 10/6556; H01M 10/656; H01M 50/204; H01M 50/249; H01M 50/258

(52) U.S. Cl. CPC B60L 50/64; H01M 10/613; H01M 10/625; H01M 10/6556; H01M 10/656; H01M 50/204; H01M 50/249; H01M 50/258; H01M 2220/20

(57) ABSTRACT

A battery system for powering an electric vehicle can comprise a plurality of battery modules, each of the plurality of battery modules comprising a housing and a plurality of cells disposed within the housing. A plumbing arrangement include a straight tube disposed between adjacent modules in the plurality of modules. An anchor arrangement for each of the plurality of battery modules can facilitate various mounting configurations for each respective battery module. An exhaust system for the battery system can be reconfigurable with a 1:1 vent tube to module ratio. Custom adapters can be configured for mounting airframer exhaust systems to each of the plurality of battery modules.

### CROSS-REFERENCE TO RELATED APPLICATIONS

This application is a continuation of, claims priority to International Application, PCT/US2024/026608 filed Apr. 26, 2024 entitled “BATTERY MODULE SYSTEMS, ASSEMBLIES, AND METHODS OF MANUFACTURE.” The '608 PCT claims, priority to, and benefit of, U.S. Provisional Application No. 63/462,177 filed Apr. 26, 2023, entitled “LOW-PROFILE CONNECTOR ASSEMBLIES FOR BATTERY SYSTEMS,” U.S. Provisional Application No. 63/462,179 filed Apr. 26, 2023, entitled “CUSTOM GANG VENT ADAPTERS FOR BATTERY MODULES,” U.S. Provisional Application No. 63/462,185 filed Apr. 26, 2023, entitled “BATTERY HOUSING ANCHOR ARRANGEMENT,” U.S. Provisional Application No. 63/462,188 filed Apr. 26, 2023 entitled “SHORT AND LONG VENT TUBES,” and U.S. Provisional Application No. 63/614,365 filed Dec. 22, 2023 entitled “BATTERY MODULE SYSTEMS, ASSEMBLIES, AND METHODS OF MANUFACTURE.” Each of the foregoing applications are hereby incorporated by reference in their entirety for all purposes.

### FIELD

The present disclosure generally relates to apparatus, systems, and methods for providing interconnected battery modules

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may be inventions.

A battery module, for purposes of this disclosure, includes a plurality of electrically connected cell-brick assemblies. These cell-brick assemblies may, in turn, include a parallel, series, or combination of both, collection of electrochemical or electrostatic cells hereafter referred to collectively as “cells,” that can be charged electrically to provide a static potential for power or released electrical charge when needed. When cells are assembled into a battery module, the cells are often linked together through metal strips, straps, wires, bus bars, etc., that are welded, soldered, or otherwise fastened to each cell to link them together in the desired configuration.

A cell may be comprised of at least one positive electrode and at least one negative electrode. One common form of such a cell is the well-known secondary cells packaged in a cylindrical metal can or in a prismatic case. Examples of chemistry used in such secondary cells are lithium cobalt oxide, lithium manganese, lithium iron phosphate, nickel cadmium, nickel zinc, and nickel metal hydride. Such cells are mass produced, driven by an ever-increasing consumer market that demands low-cost rechargeable energy for portable electronics.

Custom battery solutions may be expensive for a respective customer. Custom battery solutions may include longer lead times due to the customization desired by the customer. Custom battery solutions may be engineering intensive to meet desired characteristics by a customer.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 illustrates a schematic view of an electrically powered aircraft, in accordance with various embodiments.

FIG. 2 illustrates an exploded view of a battery module for use in a battery system of the electrically powered aircraft from FIG. 1, in accordance with various embodiments.

FIG. 3 illustrates various views of the battery module from FIG. 2 during an assembly of the battery module, in accordance with various embodiments.

FIG. 4 illustrates cross-sectional view of a vent port connection of a battery system, in accordance with various embodiments.

FIG. 5 illustrates a cross-sectional view of an electrical connector, in accordance with various embodiments.

FIG. 6 illustrates a cross-sectional view of an electrical connector, in accordance with various embodiments.

FIG. 7 illustrates an exploded view of the electrical connector from FIG. 5, in accordance with various embodiments.

FIG. 8 illustrates an exploded view of the electrical connector from FIG. 6, in accordance with various embodiments.

FIG. 9 illustrates a cross-sectional view of a communications connector, in accordance with various embodiments.

FIG. 10 illustrates a cross-sectional view of a communications connector, in accordance with various embodiments.

FIG. 11 illustrates an exploded view of the communications connector from FIG. 9, in accordance with various embodiments.

FIG. 12 illustrates an exploded view of the communications connector from FIG. 10, in accordance with various embodiments.

FIG. 13 illustrates a side view of a connector shield of a battery module, in accordance with various embodiments.

FIG. 14 illustrates a side view of a connector shield of a battery module, in accordance with various embodiments.

FIG. 15 illustrates a perspective view of a portion of a battery system, in accordance with various embodiments.

FIG. 16 illustrates an electrical connection between electrical connectors of adjacent battery modules, in accordance with various embodiments.

FIG. 17 illustrates an electrical connection between adjacent communications connectors of adjacent battery modules, in accordance with various embodiments.

FIG. 18A illustrates a perspective view of a tube assembly, in accordance with various embodiments.

FIG. 18B illustrates a cross-sectional perspective view of the tube assembly from FIG. 18A, in accordance with various embodiments.

FIG. 19 illustrates a side view of a fluid connection between a first battery module and a second battery module in a battery system, in accordance with various embodiments.

FIG. 20 illustrates a method of assembling a tube assembly from FIGS. 18A-B, in accordance with various embodiments.

FIG. 21 illustrates a plumbing arrangement for fluidly connecting fluid conduits of adjacent battery modules together, in accordance with various embodiments.

FIG. 22 illustrates a cross-sectional view of a portion of an exhaust system from a battery module, in accordance with various embodiments.

FIG. 23 illustrates a perspective view of a portion of an exhaust system for a battery system, in accordance with various embodiments.

FIG. 24 illustrates a cross-sectional view of a portion of an exhaust system without an exhaust tube assembly, in accordance with various embodiments.

FIG. 25 illustrates a perspective view of a custom adapter for connecting an exhaust tube assembly to a vent port of a battery module, in accordance with various embodiments.

FIG. 26 illustrates a perspective view of a custom adapter for connecting an exhaust tube assembly to a vent port of a battery module, in accordance with various embodiments.

FIG. 27 illustrates a perspective view of a custom adapter for connecting an exhaust tube assembly to a vent port of a battery module, in accordance with various embodiments.

FIG. 28 illustrates a perspective view of a battery module, in accordance with various embodiments.

FIG. 29 illustrates a cross-sectional view of an anchor for use in an anchor arrangement of a battery module, in accordance with various embodiments.

FIG. 30 illustrates a perspective and exploded view of a plurality of sidewall assemblies that each include a portion of an anchor arrangement, in accordance with various embodiments.

FIG. 31 illustrates a perspective exploded view of a bracket arrangement that is coupled to a housing of a battery module, in accordance with various embodiments.

FIG. 32 illustrates a cross-sectional view of a fastener coupling a bracket to a housing of a battery module, in accordance with various embodiments.

FIG. 33 illustrates a method of manufacturing a battery module, in accordance with various embodiments.

FIG. 34 illustrates various mounting arrangements for a battery module to a support structure, in accordance with various embodiments.

FIG. 35A illustrates a perspective view of a portion of an exhaust arrangement for a battery system, in accordance with various embodiments.

FIG. 35B illustrates a cross-sectional view of a portion of the exhaust arrangement for a battery system of FIG. 35A, in accordance with various embodiments.

FIG. 36A illustrates a perspective view of a portion of an exhaust arrangement for a battery system, in accordance with various embodiments.

FIG. 36B illustrates a cross-sectional view of a portion of the exhaust arrangement for a battery system of FIG. 36A, in accordance with various embodiments.

FIG. 37A illustrates a perspective view of a portion of an exhaust arrangement for a battery system, in accordance with various embodiments.

FIG. 37B illustrates a cross-sectional view of a portion of the exhaust arrangement for a battery system of FIG. 37A, in accordance with various embodiments.

FIG. 38 illustrates a top-down view of a portion of an exhaust arrangement for a battery system, in accordance with various embodiments.

FIG. 39 illustrates a plumbing arrangement for battery system, in accordance with various embodiments.

### DETAILED DESCRIPTION

The following detailed description of various embodiments herein refers to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

As referred to herein, “generally” refers to being within a 1 inch (2.54 cm) profile of a respective shape, or within 0.5 inches (1.25 cm) of a respective shape, or within 0.25 inches (0.625 cm) of a respective shape, or within 0.125 inches (0.312 cm) of a respective shape. As referred to herein, “substantially” when referring to an angle is within 20 degrees of the respective angle, or within 10 degrees of the respective angle, or within 5 degrees of the respective angle.

Disclosed herein is a battery system adaptable to power an electrically powered vehicle (e.g., an electrically powered aircraft, an electrically powered boat, an electrically powered submarine, or the like). The battery system comprises a plurality of battery modules coupled together to form an energy storage device. Each of the plurality of battery modules are configured to be electrically coupled to an adjacent of the plurality of battery modules via electrical connectors to form an electrical path between modules. Similarly, each of the plurality of battery modules are configured to form a communications path via communications connectors. In this regard, each of the plurality of battery modules are designed and configured for an ease of assembly. Stated another way, by having a connector interface and a communications interface that can be created in response to sliding a first electrical connector (e.g., a male connector) and a communications connector (e.g., a male connector) of a first battery module toward and into an electrical connector (e.g., a female connector) and a communications connector (e.g., a female connector) of a second battery module, an assembly of the battery system can be performed in a quick and efficient manner relative to typical battery systems for electrically-powered vehicles.

In various embodiments, the battery module disclosed herein includes a housing with a plurality of cells disposed therein. In various embodiments, the housing is configured to prevent thermal runaway propagation from the battery module to an adjacent battery module of the battery system. Stated another way, thermal runaway may propagate within a battery module disclosed herein; however, the housing of the battery module is configured to contain the event within a single battery module of the battery system. In various embodiments, the housing comprises a vent port. In various embodiments, excluding the vent port, an internal cavity of the battery module that is defined by the housing is hermetically sealed from an external environment. Stated another way, the housing disclosed herein forms an air-tight enclosure around the plurality of cells disposed therein, in accordance with various embodiments. In various embodiments, the gases and/or ejecta from a thermal runaway event are ejected through the vent port into a vent system (e.g., an exhaust duct, an exhaust tube, or the like). Stated another way, since the housing is hermetically sealed excluding the vent port, there are no leakage paths where gases from a thermal runaway event may escape, and accordingly, the gases are directed only through the vent port.

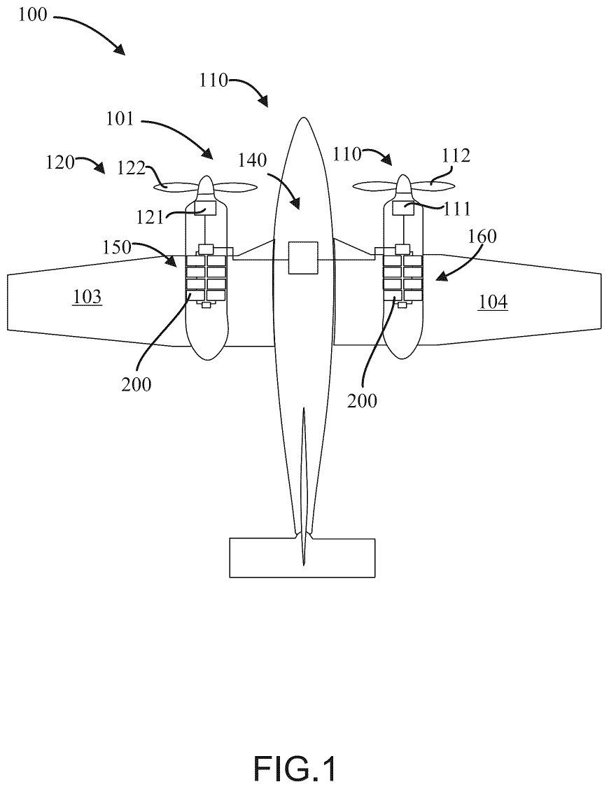

Referring now to FIG. 1, a schematic view of an aircraft 100 with an electric propulsion system 101 is illustrated, in accordance with various embodiments. In various embodiments, the electric propulsion system 101 comprises a propulsor 110 and a propulsor 120. In various embodiments, propulsor 110 and the propulsor 120 each comprise and electric motor and a propeller. For example, the propulsor 110 comprises an electric motor 111 and a propeller 112, and the propulsor 120 comprises an electric motor 121 and a propeller 122. The electric motor 111 is configured to drive a propeller 112, and the electric motor 121 is configured to drive the propeller 122. The propulsor 120 is disposed on a wing 103 of the aircraft 100, and the propulsor 110 is disposed on a wing 104 of the aircraft 100. In various embodiments, the propellers 112, 122 can be variable pitch propellers or fixed pitch propellers, the present disclosure is not limited in this regard. Although described herein with an aircraft having one propulsor per wing, in various other embodiments, any number of propulsors per wing may be used, a propulsor may be disposed on a nose of the aircraft 100, or the like and still be within the scope of this disclosure.

In various embodiments, the electric propulsion system 101 further comprises an electrical system 140. The electrical system 140 comprises a battery system 150 and a battery system 160. The battery system 150 can be configured to power the electric motor 121 and the battery system 160 can be configured to power the electric motor 111. The battery system 150 and the battery system 160 can be independent battery systems, in accordance with various embodiments. In various embodiments, the battery system 150 is disposed aft of the propulsor 120, and the battery system 160 is disposed aft of the propulsor 120. The battery system 150 can be disposed in a nacelle of the wing 103 and the battery system 160 can be disposed in a nacelle of the wing 104. However, this disclosure is not limited with respect to the location of the battery systems.

Although described herein with respect to an aircraft 100, the present disclosure is not limited in this regard. For example, the battery module 200 and the battery systems 150, 160 can be utilized in other electric vehicle applications, such as land vehicles (e.g., trucks, cars, etc.), sea vehicles (e.g., boats, submersibles, submarines, etc.), or air vehicles (e.g., aircraft 100) and still be within the scope of this disclosure.

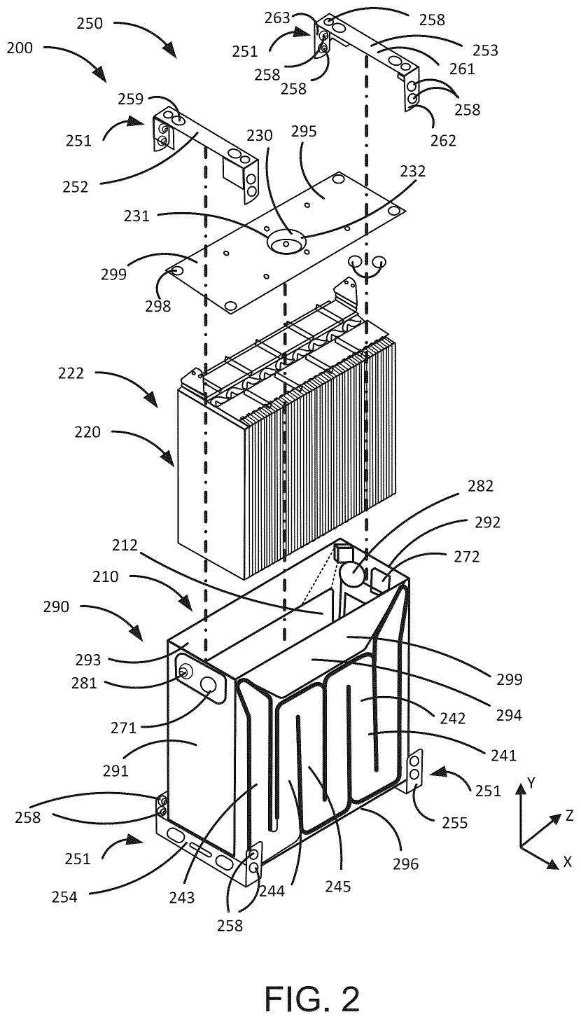

Referring now to FIG. 2, a perspective exploded view of the battery module 200 is illustrated, in accordance with various embodiments. The battery module 200 comprises a housing 210 and a cell-brick assembly 220 disposed therein. In various embodiments, the cell-brick assembly 220 comprises a plurality of cells 222 (e.g., prismatic cells, pouch cells, cylindrical cells, or the like) disposed within the housing 210.

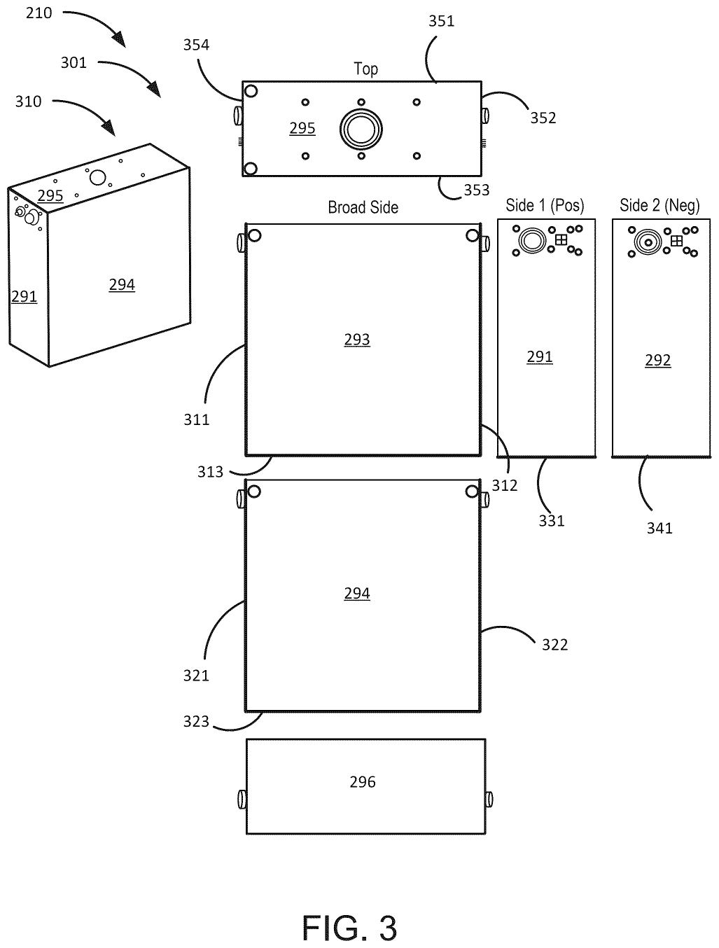

In various embodiments, the housing 210 (e.g., an enclosure assembly) comprises a plurality of sidewalls 290 that form, in an assembled state, a generally cuboid shape (e.g., as shown in FIG. 3 and described further herein). The plurality of sidewalls 290 can include lateral sidewalls (e.g., sidewall 291 and sidewall 292), broad sidewalls (e.g., sidewall 293 and sidewall 294), a top sidewall (e.g., lid 295) and a bottom sidewall (e.g., bottom panel 296). The sidewall 291 is disposed opposite the sidewall 292. Stated another way, the sidewall 291 is spaced apart longitudinally (i.e., in the Z-direction) from the sidewall 292, the sidewall 291 defines a first longitudinal side of the housing 210, and the sidewall 292 defines a second longitudinal side of the housing 210. In a similar manner, the sidewall 293 is disposed opposite the sidewall 294. Stated another way, the sidewall 293 is spaced apart laterally (i.e., in the X-direction) from the sidewall 294, the sidewall 293 defining a first lateral side of the housing 210, and the sidewall 294 defining a second lateral side of the housing 210. Similarly, the bottom panel 296 is disposed opposite the lid 295. Stated another way, the lid 295 is spaced apart vertically (i.e., in the Y-direction) from the bottom panel 296, the lid 295 defines a first vertical side (e.g., a top side) of the housing 210, and the bottom panel 296 defines a second vertical side (e.g., a bottom side) of the housing 210.

In various embodiments, with brief reference to FIG. 3, with like numerals depicting like elements, the generally cuboid shape 310 of the housing 210 includes a plurality of seams 301 (e.g., seams 311, 312, 313, 321, 322, 323, 331, 341, 351, 352, 353, 354). Each of the plurality of seams can at least partially define an edge of the housing 210. In various embodiments all the edges of the housing 210 are defined by a respective seam. In this regard, each edge of the generally cuboid shape 310 can be hermetically sealed by fusing a first of the plurality of sidewalls to a second of the plurality of sidewalls, in accordance with various embodiments. In various embodiments, each of the plurality of seams is formed by a first of the plurality of sidewalls being fused to a second of the plurality of sidewalls. Stated another way, a joint is formed between each pair of adjacent sidewalls, such as a weld joint, a braze joint, or the like. For example, the sidewall 293 can be welded (e.g., laser welded) to the sidewall 291 to form the seam 311. In this regard, the seam 311 formed by fusing adjacent sidewalls (e.g., sidewall 291 and sidewall 293) together can form a hermetic seal (i.e., an air-tight seal) along the seam 311. In various embodiments, each of the plurality of seams 301 of FIG. 3 can be formed as described herein. For the sake of brevity, each seam will not be described, and it should be recognized that each seam can be formed as described with respect to the seam 311.

In various embodiments, each of the plurality of sidewalls 290 comprises a flat plate (e.g., a sheet metal plate). For example, each of the plurality of sidewalls 290 can comprise a sheet metal plate that is commercially pure titanium (e.g., a composition greater than 99% titanium, or greater than 99.5% titanium, or greater than 99.9% titanium), or a sheet metal plate that is a titanium alloy, in accordance with various embodiments.

Typically, housing materials for battery modules utilized in aviation type applications are made from aluminum or a non-metal, such as carbon fiber composite, thermoplastics, etc. A main driver in aviation type applications is weight and cost. Accordingly, aluminum, carbon fiber, and thermoplastics are lighter than pure titanium, or a titanium alloy. However, by utilizing pure titanium, or a titanium alloy for the housing 210, a strength to weight ratio of the housing 210 can be greatly increased relative to aluminum, which can facilitate the housing of heavier battery modules. In various embodiments, thermal properties of the housing 210 can be significantly improved by utilizing titanium relative to aluminum. For example, by utilizing pure titanium for the housing 210, a thermal conductivity of the housing 210 can be approximately ten times less relative to an aluminum housing. In this regard, heat generated during a thermal runaway event can trickle into a frame that is made of aluminum via the housing 210 when the housing is made of titanium as opposed to heating up that frame significantly faster if the housing is made of aluminum.

In various embodiments, by using a flat plate in each of the plurality of sidewalls 290, joining of adjacent sidewalls in the plurality of sidewalls 290 can be simplified. For example, each sidewall can include a flat plate that has a same nominal thickness (i.e., a flat plate that is formed from the same sheet metal stock). In this regard, welding between flat plates of similar thickness can facilitate a strong joint, which can help facilitate the hermetic seal along the respective seam.

In various embodiments, by using a flat plate in each of the plurality of sidewalls 290, a structure for each of the plurality of sidewalls 290 can be simplified, reducing costs and manufacturing time. Although described herein as forming the housing 210 by welding together each adjacent sidewall to form a plurality of seams 301, the present disclosure is not limited in this regard. For example, a majority of the housing 210 (e.g., sidewalls 291, 292, 293, 294 and bottom panel 296) can be formed via a deep drawn process, and the lid 295 can be welded to the edges of the sidewalls 291, 292, 293, 294 to form the housing 210 and still be within the scope of this disclosure.

Referring back to FIG. 2, the housing 210 comprises a cavity 212 disposed within the plurality of sidewalls 290. As described previously herein, the plurality of cells from the cell-brick assembly 220 are disposed within the cavity 212 of the housing 210.

In various embodiments, the housing 210 further comprises a vent port 230. In various embodiments, the vent port 230 may be disposed through one of the plurality of sidewalls (e.g., lid 295). The vent port 230 is in fluid communication with the cavity 212 to facilitate an evacuation of hot gases and debris in response to a thermal runaway event. In this regard, the vent port 230 can be configured to be coupled to a vent (e.g., a vent tube, a vent duct, or the like), which can route the hot gases and debris away from the battery module 200 in response to a thermal runaway event.

In various embodiments, the vent port 230 comprises a generally cylindrical body extending from an edge 231 of the vent port into the cavity 212. The term “generally” when followed by a shape, as referred to herein, includes variations of the shape within an inch profile of the nominal shape. Stated another way, body that may not be considered technically cylindrical would be considered generally cylindrical if the body would fit in an envelope of a nominal cylindrical profile that is plus or minus 1 inch (2.54 cm).

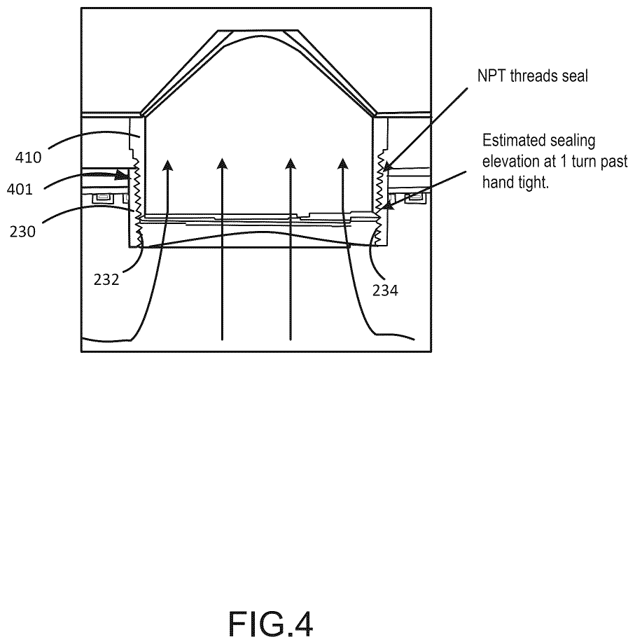

In various embodiments, the vent port 230 is configured to be coupled to a tube or a coupling for a vent system. In this regard, with brief reference to FIG. 4, an inner diameter surface 232 of the vent port 230 can comprise a threaded surface. Although described herein as comprising a threaded surface, the present disclosure is not limited in this regard. For example, the vent port 230 could comprise a flat wall and be configured to interface with a piloted O-ring connection and still be within the scope of this disclosure. In various embodiments, by having a threaded surface and being configured to interface with a male threaded surface of a vent coupling 410 that is of a different material (e.g., aluminum), a vent port interface 401 between the components (e.g., between the vent port 230 and the vent coupling 410) can be self-sealing during a thermal runaway event. Stated another way, the interfacing material of the vent coupling 410 can be configured to expand more than the vent port 230 in response to being heated, causing the interfacing material of the vent coupling 410 to expand radially outward and into the inner diameter surface 232 of the vent port 230 to seal the respective venting system from an external environment during the thermal runway event, protecting various components within a structure of the aircraft 100 from FIG. 1, in accordance with various embodiments. Stated another way, the vent coupling 410 can have a higher coefficient of thermal expansion than the vent port 230.

Referring back to FIG. 2, and in accordance with various embodiments, the edge 231 of the vent port 230 is fused (e.g., via welding, brazing, or the like) to the flat plate 299 of the lid 295. In various embodiments, by fusing the edge 231 of the vent port 230 to the lid 295, the connection between the vent port 230 and the lid 295 can be hermetically sealed.

With continued reference to FIG. 2, in various embodiments, the housing 210 further comprises at least one of a cold plate 241. In various embodiments, each of the broad sidewalls (e.g., sidewall 293 and sidewall 294) comprises a cold plate 241 coupled thereto. For example, the battery module 200 can comprise a first cold plate (e.g., cold plate 241 on a first lateral side of the housing 210) and a second cold plate (e.g., cold plate 241 on a second lateral side of the housing 210), the first cold plate comprising a first broad sidewall (e.g., sidewall 293) of the plurality of sidewalls 290 and a first vane plate (e.g., vane plate 242) coupled thereto, the second cold plate comprising a second broad sidewall (e.g., sidewall 294) of the plurality of sidewalls 290 and a second vane plate (e.g., vane plate 242) coupled thereto. Although described further herein with respect to sidewall 294, the sidewall 293 can include the same features of the sidewall 294, in accordance with various embodiments. Stated another way, in various embodiments, both the sidewall 293 and the sidewall 294 comprise the cold plate 241 described further herein. In this regard, a heating and/or cooling of the battery module 200 during charging of the battery module 200 can be more uniform relative to only having the cold plate 241 on a single side of the battery module 200.

In various embodiments, the sidewall 294 can comprise a flat plate 299 and a vane plate 242 coupled thereto to form the cold plate 241. Stated another way, the flat plate 299 and the vane plate 242 can define a flow path therethrough (e.g., a serpentine flow path or the like). Although illustrated as a serpentine flow path, the present disclosure is not limited in this regard. For example, the flow path could include parallel channels extending longitudinally (i.e., in the Z-direction), or the like and still be within the scope of this disclosure. In various embodiments, by having a serpentine flow path that travels from a top side of the housing 210, to a bottom side of the housing 210, back up to the top side of the housing 210, and so on, the cold plate 241 may be more efficiently purged after charging of the battery systems disclosed herein (e.g., battery system 150 and/or battery system 160 from FIG. 1). Although illustrated as a serpentine flow path that is vertical, the present disclosure is not limited in this regard. For example, a serpentine flow path that is horizontal, or a parallel flowpath with a vertical inlet header and a vertical outlet header are within the scope of this disclosure.

In various embodiments, the vane plate 242 is coupled to the flat plate 299 in a similar manner to the joining of adjacent sidewalls as described previously herein. For example, the vane plate 242 can be fused (e.g., via welding, brazing, or the like) to the flat plate 299 (e.g., along a perimeter of the vane plate 242 and between adjacent channels, such as between channel 243 and channel 244, between channel 244 and channel 245, and so on). Stated another way, in various embodiments, the vane plate 242 is fused to the flat plate 299 of a respective broad sidewall (e.g., sidewall 293 or sidewall 294) of the plurality of sidewalls 290 to form the respective broad sidewall (e.g., sidewall 293 or sidewall 294). Moreover, any suitable way of connecting the vane plate 242 to the flat plate 299 may be used.

For example, in various embodiments, for a battery system 150, 160 from FIG. 1, a fluid may be flowed through the cold plate 241 during charging of the respective battery system 150 (e.g., to cool or heat the cell-brick assembly 220). However, when the battery system 150, 160 is in operation (i.e., when aircraft 100 from FIG. 1 is flying), the cold plate 241 may not be utilized, and this is configured to reduce a weight on-board the aircraft 100. In this regard, a heat transfer fluid may be drained after use during charging, resulting in an empty, or near empty plumbing system on-board the aircraft 100, in accordance with various embodiments. Stated another way, the battery system 150, 160 from FIG. 1 may not utilize active cooling during operation of the aircraft 100, which can facilitate eliminating a cooling source (e.g., fluid) that would otherwise have to be carried on-board the aircraft 100. Accordingly, after a charging of the battery system 150, 160 from FIG. 1, it may be desirable to purge any remaining fluid disposed therein. In various embodiments, the serpentine shape of the flow path for the cold plate 241 can facilitate a purging of fluid of between 70% and 100%, or between 80% and 100%, or approximately between 85% and 99%, in accordance with various embodiments.

In various embodiments, the battery module 200 further comprises a mounting arrangement 250. In various embodiments, the mounting arrangement 250 comprises a plurality of brackets 251. Each of the plurality of brackets 251 is coupled to the housing 210. In this regard, each of the plurality of brackets 251 are configured to facilitate mounting the battery module 200 to a respective support structure (e.g., a support structure within the aircraft 100 from FIG. 1, or the like). In various embodiments, by having the plurality of brackets 251 for interfacing with a respective support structure, the battery module 200 can remain the same across various use cases and only the plurality of brackets 251 and their respective mounting locations may have to be changed, in accordance with various embodiments.

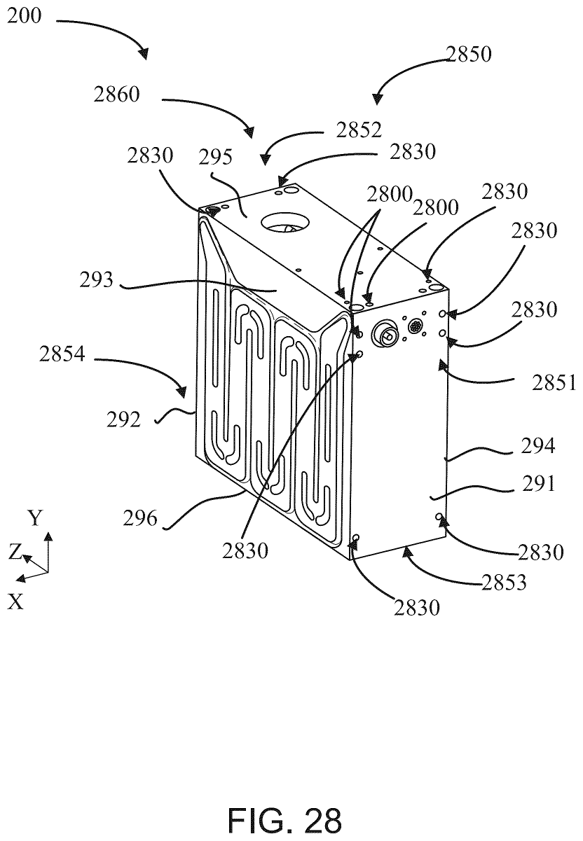

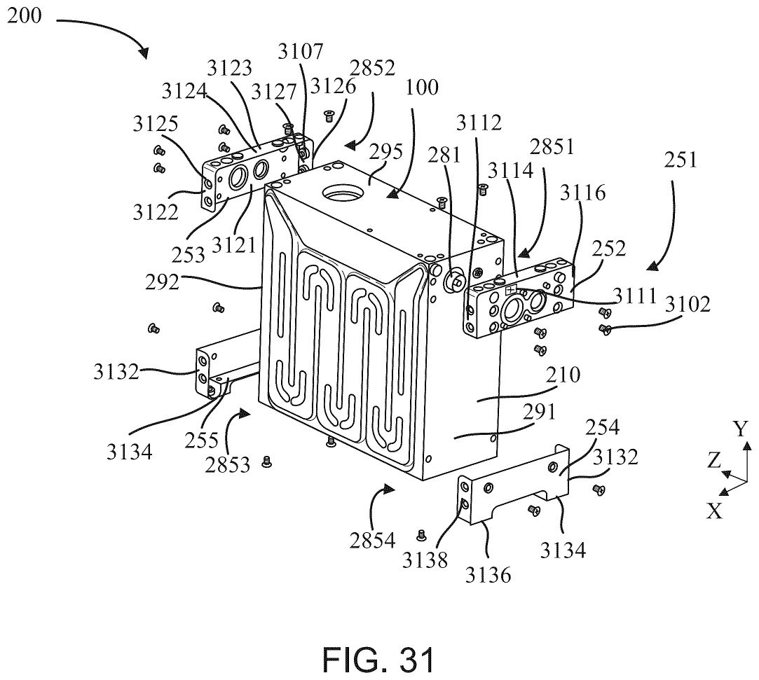

In various embodiments, each of the plurality of brackets 251 can comprise an aperture (e.g., aperture 259 for a first 252 of the plurality of brackets 251) that corresponds to an aperture disposed through one of the plurality of sidewalls 290 (e.g., aperture 298 disposed through the lid 295). In this regard, each of the plurality of brackets 251 can be fused to the housing 210 (e.g., via welding, brazing, or the like), and the fused region can hermetically seal the joining location of the respective bracket in the plurality of brackets 251, in accordance with various embodiments. Although described as being fused to the housing with respect to FIG. 2, the present disclosure is not limited in this regard. For example, as described further herein (e.g., with respect to FIG. 31 and the associated mounting arrangement of FIGS. 28-32), each of the plurality of brackets 251 can be coupled to the housing 210 via fasteners (e.g., bolts, rivets, studs, pins, or any other male fastener) and a set of anchors configured to receive the respective fastener (e.g., anchor sub-arrangement 2851, 2852, 2853, 2854 from FIG. 28).

In various embodiments, a first 252 the plurality of brackets 251 is spaced apart longitudinally (i.e., in the Z-direction) from a second 253 of the plurality of brackets 251. The first 252 and the second 253 of the plurality of brackets 251 can be coupled to the housing 210. Although the first 252 and the second 253 of the plurality of brackets are illustrated as being coupled to the lid 295, the present disclosure is not limited in this regard. For example, the first 252 of the plurality of brackets 251 can be coupled to sidewall 291, sidewall 293, or sidewall 294 and still be within the scope of this disclosure. Similarly, the second 253 of the plurality of brackets 251 can be coupled to the sidewall 292, sidewall 293, and/or sidewall 294 and still be within the scope of this disclosure.

In various embodiments, a third 254 of the plurality of brackets 251 is spaced apart longitudinally (i.e., in the Z-direction) from a fourth 255 of the plurality of brackets 251. The third 254 and the fourth 255 of the plurality of brackets 251 can be coupled to the housing 210. Although the third 254 and the fourth 255 of the plurality of brackets are illustrated as being coupled to the sidewall 291 and the sidewall 292 respectively, the present disclosure is not limited in this regard. For example, the third 254 of the plurality of brackets 251 can be coupled to sidewall 293, sidewall 294, and/or bottom panel 296 and still be within the scope of this disclosure. Similarly, the fourth 255 of the plurality of brackets 251 can be coupled to the sidewall 293, sidewall 294, and/or bottom panel 296 and still be within the scope of this disclosure.

In various embodiments, the third 254 of the plurality of brackets 251 is spaced apart vertically from the first 252 of the plurality of brackets 251. Similarly, the fourth 255 of the plurality of brackets 251 is spaced apart vertically from the second 253 of the plurality of brackets 251. In this regard, the mounting arrangement 250 can include a first mounting side (e.g., on a first lateral side of the housing 210) and a second mounting side (e.g., on a second lateral side of the housing 210). Additionally, in accordance with various embodiments, the mounting arrangement 250 can include a third mounting side (e.g., a top side of the housing 210) and/or a fourth mounting side (e.g., a bottom side of the housing 210). In this regard, the mounting arrangement 250 can facilitate multiple potential interfaces based on a respective use case, in accordance with various embodiments.

In various embodiments, each of the plurality of brackets 251 comprises at least two of a nut 258 coupled thereto. In various embodiments, the nut 258 can be coupled to a respective flange of the respective bracket by any method known in the art (e.g., welding, riveting, brazing, or the like). In various embodiments, the nut can be configured to receive a fastener (e.g., a bolt) to couple a respective support structure to the respective bracket.

In various embodiments, each of the plurality of brackets 251 comprises a main body (e.g., main body 261 for the second 253 of the plurality of brackets 251); a first flange extending outward from a first edge of the main body (e.g., first flange 262 for the second 253 of the plurality of brackets 251); and a second flange extending outward from a second edge of the main body (e.g., second flange 263 for the second 253 of the plurality of brackets 251).

In various embodiments, to facilitate an electrical connection between a first of the battery module 200 and a second of the battery module 200, a first electrical connector 281 (e.g., having a positive electrode as described further herein) is coupled to the sidewall 291 that is on a first longitudinal side of the housing 210, and a second electrical connector 282 (e.g., having a negative electrode as further described herein) is coupled to the sidewall 292 that is opposite the sidewall 291 on the second longitudinal side of the housing 210. Similarly, a first communications connector 271 (e.g., having a plurality of pins to facilitate connection of a communications line of the battery system) is coupled to the sidewall 291 that is on a first longitudinal side of the housing 210, and a second communications connector 272 (e.g., having a plurality of receptacles, each of the plurality of receptacles configured to receive a respective pin from the plurality of pins) is coupled to the sidewall 292 that is opposite the sidewall 291 on the second longitudinal side of the housing 210. Accordingly, as described further herein, a battery connections step during assembly of a battery system (e.g., battery system 150 or battery system 160 from FIG. 1) can include sliding the sidewall 292 of a first of the battery module 200 toward (i.e., in a longitudinal direction/in the z-direction) the sidewall 291 of a second of the battery module 200. In response to the battery connection step being performed, the second electrical connector 282 of the first of the battery module 200 is coupled to the first electrical connector 281 of the second of the battery module 200 and the second communications connector 272 of the first of the battery module 200 is coupled to the first communications connector 271 of the second of the battery module 200.

In various embodiments, although described herein as including the first electrical connector 281 and the first communications connector 271 as both being male connectors, and the second electrical connector 282 and the second communications connector 272 as both being female connectors, the present disclosure is not limited in this regard. For example, the first electrical connector 281 can be a male connector and the first communications connector 271 can be a female connector, as long as the second electrical connector 282 is a female connector and the second communications connector 272 is a male connector. Stated another way, as long as one of the first electrical connector 281 and the second electrical connector 282 is a male connector and the other of the first electrical connector 281 and the second electrical connector 282 is a female connector, an electrical interface between adjacent of the battery module 200 in a battery system 150 or a battery system 160 from FIG. 1 can be facilitated. Similarly, as long as one of the first communications connector 271 and the second communications connector 272 is a male connector and the other of the first communications connector 271 and the second communications connector 272 is a female connector, a communications interface between adjacent of the battery module 200 in a battery system 150 or a battery system 160 from FIG. 1 can be facilitated.

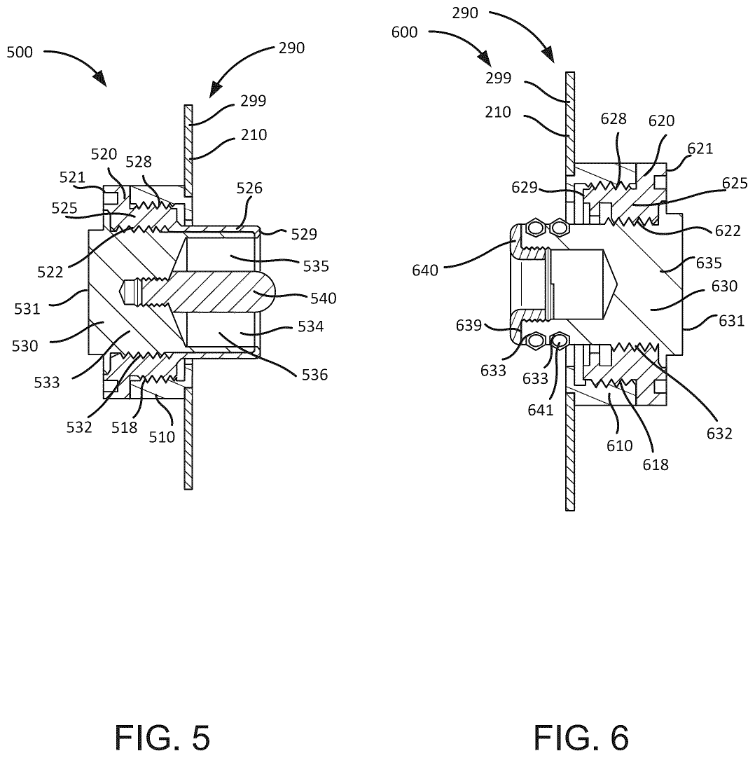

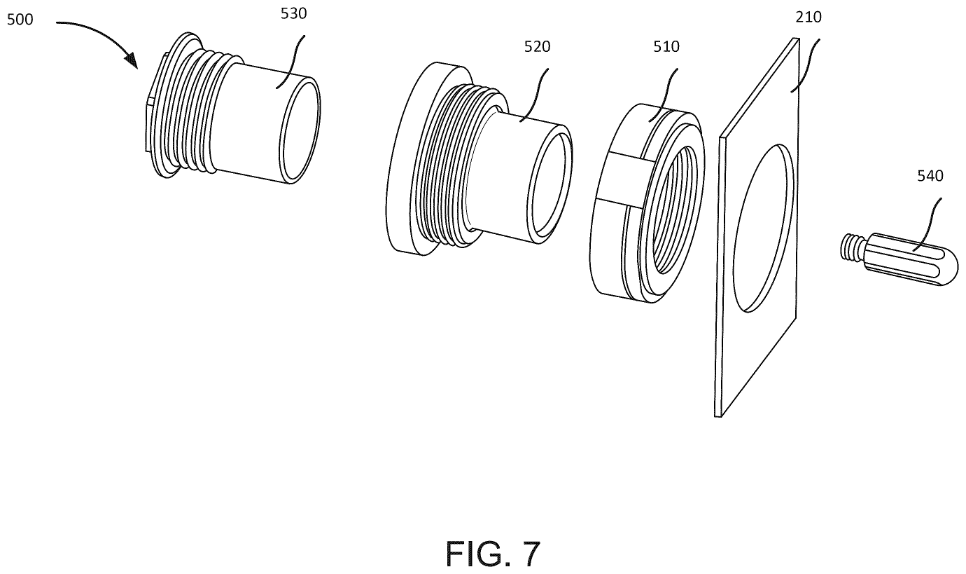

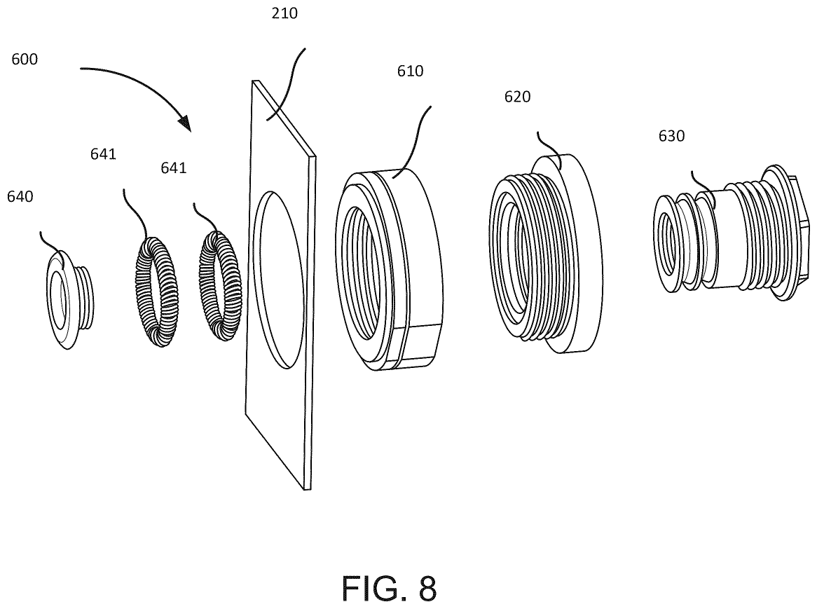

Referring now to FIGS. 5, 6, 7, and 8, a cross-sectional view of an electrical connector 500 that is a female electrical connector (FIG. 5), a cross-sectional view of an electrical connector 600 that is a male electrical connector (FIG. 6), an exploded view of the electrical connector 500 (FIG. 7), and an exploded view of the electrical connector 600 (FIG. 8) are illustrated, in accordance with various embodiments. With combined reference to FIGS. 2, 5, 6, 7, and 8, if the first electrical connector 281 is the electrical connector 500, then the second electrical connector 282 is the electrical connector 600. Similarly, if the first electrical connector 281 is the electrical connector 600, then the second electrical connector 282 is the electrical connector 500. Stated another way, the battery module 200 comprises a male electrical connector (e.g., electrical connector 600) and a female electrical connector (e.g., electrical connector 500) to facilitate electrical couplings between adjacent battery modules in a battery system having a plurality of the battery module 200 (e.g., battery system 150 or battery system 160 from FIG. 1).

In various embodiments, the electrical connector 500 can be configured as a positive terminal of the battery module 200 or a negative terminal of the battery module 200. Similarly, the electrical connector 600 can be configured as a positive terminal of the battery module 200 or a negative terminal of the battery module 200. The present disclosure is not limited in this regard. In various embodiments, if the electrical connector 500 is configured as a positive terminal of the battery module 200, then the electrical connector 600 is configured as a negative terminal of the battery module 200. Similarly, if the electrical connector 500 is configured as the negative terminal of the battery module 200, then the electrical connector 600 is configured as the positive terminal of the battery module 200. Stated another way, the battery module 200 disclosed herein can be configured to facilitate direct series connections with an adjacent of the battery module 200, in accordance with various embodiments. Although described herein as facilitating series connections, the present disclosure is not limited in this regard. For example, the battery module 200 could be configured to facilitate parallel electrical connections with an adjacent of the battery module 200, and still be within the scope of this disclosure.

In various embodiments, the electrical connector 500 and the electrical connector 600 disclosed herein are high voltage connectors. “High voltage,” as referred to herein includes any voltage over 600 volts, or voltages between 601 and 5,000 volts. Although described herein as being high voltage, the electrical connector 500, 600 is not limited in this regard.

In various embodiments, the electrical connector 500 and the electrical connector 600 disclosed herein are significantly lower profile (i.e., take up a smaller envelope) relative to typical high voltage connectors. In various embodiments, the electrical connector 500 and the electrical connector assembly each comprise a simplified construction relative to typical high voltage connectors. In various embodiments, a cost of manufacture for each of the electrical connector 500 and the electrical connector 600 can be approximately 75% less relative to a typical high voltage connector.

In various embodiments, each of the electrical connector 500 and the electrical connector 600 comprise a connector housing 510, 610, a seal 520, 620, and an electrode 530, 630. In various embodiments, the connector housing 510, 610 is configured to be coupled to the housing 210 of the battery module 200 from FIG. 2. For example, the connector housing 510 can be configured to be coupled to a flat plate 299 of one of the plurality of sidewalls 290 (e.g., sidewall 291 for the first electrical connector 281 or sidewall 292 for the second electrical connector 282). In various embodiments, the seal 520, 620 is directly coupled to the connector housing 510, 610 and the electrode 530, 630. In this regard, the seal 520, 620 can comprise a non-conductive material (e.g., a thermoplastic material, such as polyether ether ketone (PEEK) or any other thermoplastic or electrical insulator known in the art).

In various embodiments, a first longitudinal end 531, 631 of the electrical connector 500, 600 is configured to be coupled to a bus bar. In this regard, the first longitudinal end 531, 631 of each of the electrical connector 500, 600 can comprise an axial surface that is configured to be welded to a bus bar, fastened to a bus bar, or the like. The present disclosure is not limited in this regard. Accordingly, the first longitudinal end 531, 631 is disposed in the cavity 212 of the housing 210 of the battery module 200 from FIG. 2 and electrically coupled to the cell-brick assembly 220 (e.g., via a bus bar), in accordance with various embodiments.

In various embodiments, the seal 520, 620 can provide dual functionality for the electrical connector 500, 600. For example, the seal 520, 620 can be configured to seal the cavity 212 of the housing 210 from an external environment through the electrical connector 500, 600. In this regard, a leakage path can be prevented through the electrical connector 500, 600 by the seal 520, 620. For example, in response to a thermal runaway event within a battery module 200 from FIG. 2, the cavity 212 of the housing 210 can be heated up significantly. This increase in temperature can cause the electrical connector 500, 600 to be heated in a similar manner. In various embodiments, the seal 520, 620 can be configured to expand a greater amount radially relative to mating components with the seal 520, 620 (i.e., the connector housing 510, 610 and the electrode 530, 630). Accordingly, the seal 520, 620 can grow radially outward and radially inward and press into the electrode 530, 630 and the connector housing 510, 610, forming a seal therebetween and preventing any of the hot gases or ejecta from the thermal runaway event from escaping to an adjacent module in a battery system 150, 160 from FIG. 1 as described previously herein. Stated another way, the seal 520, 620 may have a higher coefficient of thermal expansion than the connector housing 510, 610 and the electrode 530, 630.

In various embodiments, the seal 520, 620 can further be configured to electrically insulate the electrode 530, 630 from the connector housing 510, 610, and the housing 210. In this regard, since the housing 210 and the connector housing 510, 610 are both made of a metal (e.g., pure titanium, a titanium alloy, or the like), the electrode 530, 630 is configured to be insulated from the connector housing 510, 610 and the housing 210 to prevent a short during operation of the battery module 200 from FIG. 2.

In various embodiments, the seal 520, 620 comprises a body 525, 625 that extends from a first longitudinal end 521, 621 along a longitudinal axis defined by the body 525, 625 to a second longitudinal end 529, 629. In various embodiments, the body 525 comprises an inner diameter surface 522, 622 and an outer diameter surface 528, 628. At least a portion of the inner diameter surface 522, 622 and at least a portion of the outer diameter surface 528, 628 is threaded. In this regard, at least a portion of an outer diameter surface 532, 632, of a respective mating electrode (e.g., electrode 530, 630) is threaded in a complimentary manner to the threaded surface on the inner diameter surface 522, 622 of the seal 520, 620. Similarly, at least a portion of an outer diameter surface 518, 618 of a respective mating connector housing (e.g., connector housing 510, 610) is threaded in a complimentary manner to the threaded surface on the outer diameter surface 528, 628 of the seal 520, 620. In this regard, the connector housing 510, 610 can be secured to the seal 520, 620 via a threaded connection, and electrode 530, 630 can be secured to the seal 520, 620 via a threaded connection. Although described herein as being coupled together via threaded connections, the present disclosure is not limited in this regard. For example, couplings between components of the electrical connector 500, 600 can be facilitated by alternative coupling means, such as press fit, an adhesive, bonding, or the like. The present disclosure is not limited in this regard. However, as described previously herein, the threaded connection, combined with the utilization of a seal 520, 620 that has a different material with a different coefficient of thermal expansion relative to the mating components (e.g., the connector housing 510, 610 and the electrode 530, 630) can facilitate a sealing effect during a thermal runaway event within a cavity 212 of a housing 210 of the battery module 200 from FIG. 2.

In various embodiments, the electrode 530 further comprises a main body 533 and a generally cylindrical body 534 extending along a longitudinal axis defined by the electrical connector 500. The generally cylindrical body 534 can at least partially define a receptacle 536 configured to receive a mating electrode (e.g., electrode 630). An inner diameter surface 535 of the electrode 530 is configured to mate with a mating electrode (e.g., electrode 630 of the electrical connector 600) via a radial connection as described further herein. In various embodiments, the seal 520 further comprises a generally cylindrical body 526 disposed radially outward from the generally cylindrical body 534 of the electrode 530. In this regard, the electrode 530 can be further protected by the seal 520 (e.g., during transport or the like), in accordance with various embodiments.

For example, the electrode 630 can comprise a main body 635 extending along a longitudinal axis defined by the main body 635 from a first longitudinal end 631 to a second longitudinal end 639, and one or more conductive elements 641 coupled to the main body 635. In this regard, disposed in the outer diameter surface 632 of the main body 635, and spaced apart longitudinally from the threaded surface that is configured to mate with the seal 620, is at least one annular groove 633. The annular groove 633 is configured to receive one of the one or more conductive elements 641 therein. In various embodiments, the conductive element 641 is configured to compress in a radial direction (e.g., in response to being inserted into the generally cylindrical body 534 of the electrode 530). In this regard, the conductive element 641 can comprise a conductive coil, a hollow conductive ring, or any other annular structure configured to compress in a radial direction in response to partially contacting a radially inner mating surface (e.g., inner diameter surface 535 of the electrode 530). Although illustrated as comprising two of the one or more conductive elements 641, each disposed in a respective annular groove 633, the present disclosure is not limited in this regard. For example, the electrode 630 can comprise one of the one or more conductive elements 641 disposed in an annular groove 633, two or more of the conductive element 641 disposed in respective grooves, or the like and still be within the scope of this disclosure. In various embodiments, by having more than one (e.g., two or more) of the conductive element 641, a redundant electrical connection can be formed, improving robustness of the electrical connection, in accordance with various embodiments.

In various embodiments, the electrode 530, 630 of the electrical connector 500, 600 protrudes past an outer surface of the housing 210. In this regard, during a battery connection step between electrodes, the connection can be visualized and ensured, as described further herein.

In various embodiments, the connector housing 510, 610 of the electrical connector 500, 600 is fused (e.g., via welding, brazing, or the like) to the housing 210. In this regard, the connector housing 510, 610 can comprise a same material as the housing 210 as described previously herein to facilitate metal-to-metal joining (e.g., via welding, brazing, or the like). In this regard, the cavity 212 of the housing 210 is further sealed from an external environment through a joint between the connector housing 510, 610 and the housing 210.

In various embodiments, the electrical connector 500 and the electrical connector 600 each comprise a protective component (e.g., a plug 540 configured to prevent a finger of a user from entering the receptacle 536 of the electrode 530 and an electrode cap 640 coupled to the second longitudinal end 639 of the electrode 630). In this regard, the protective components (e.g., the plug 540 and the electrode cap 640) can comprise non-conductive material (e.g., a thermoplastic material, or any other non-conductive material known in the art).

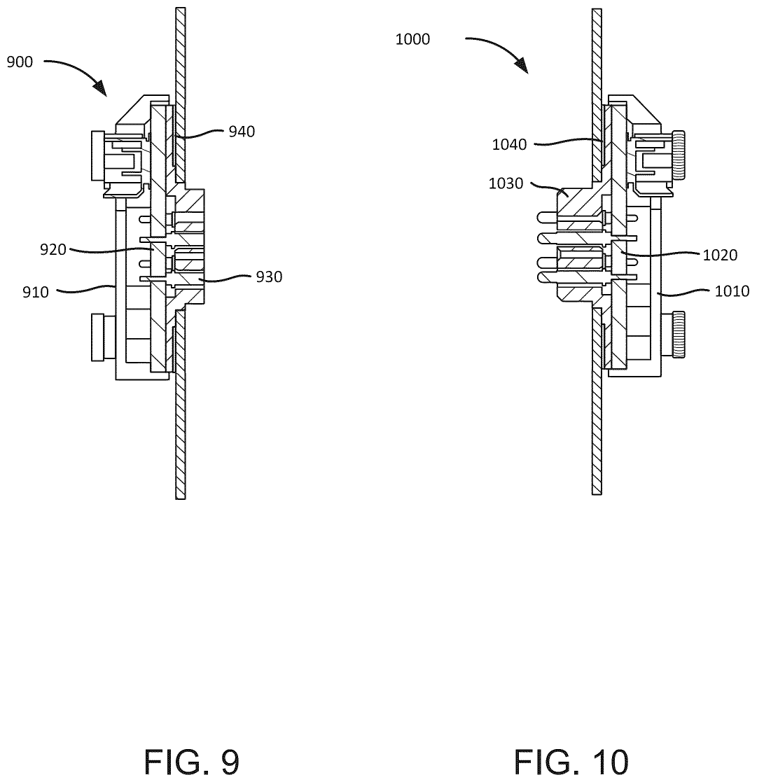

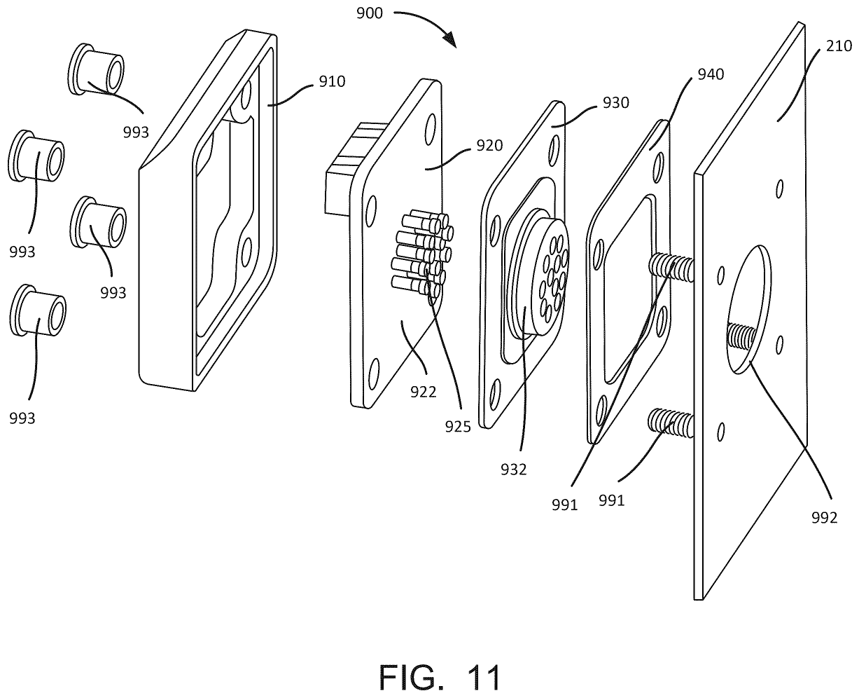

Referring now to FIGS. 9, 10, 11, and 12, a cross-sectional view of a communications connector 900 that is a female communications connector (FIG. 9), a cross-sectional view of a communications connector 1000 that is a male electrical connector (FIG. 10), an exploded view of the communications connector 900 (FIG. 11), and an exploded view of the communications connector 1000 (FIG. 8) are illustrated, in accordance with various embodiments. With combined reference to FIGS. 2, 9, 10, 11, and 12, if the first communications connector 271 is the communications connector 900, then the second communications connector 272 is the communications connector 1000. Similarly, if the first communications connector 271 is the communications connector 1000, then the second communications connector 272 is the communications connector 900. Stated another way, the battery module 200 comprises a male communications connector (e.g., communications connector 1000) and a female communications connector (e.g., communications connector 900) to facilitate communications couplings between adjacent battery modules in a battery system having a plurality of the battery module 200 (e.g., battery system 150 or battery system 160 from FIG. 1). In various embodiments, a male communications connector (e.g., communications connector 1000) can be on a same side of the housing 210 as a male electrical connector (e.g., electrical connector 600 from FIG. 6) or on a different side of the housing 210 as the male electrical connector. The present disclosure is not limited in this regard.

In various embodiments, the communications connector 900 and the communications connector 1000 each comprise a shield 910, 1010, a communications board 920, 1020 (e.g., a target board 922 for the communications connector 900 and a pin board 1022 for the communications connector 1000), a seal 930, 1030, and a gasket 940, 1040. In various embodiments, the shield 910, 1010, and the seal 930, 1030, are configured to prevent gases and/or ejecta from a thermal runaway event within the battery module 200 from FIG. 2 from escaping through the housing at the communications connector 900, 1000 location. Stated another way, the shield 910, 1010, and the seal 930, 1030 are provided in an assembly for the communications connector 900, 1000 to strengthen the location of the communications connector 900, 1000, in accordance with various embodiments.

In various embodiments, the communications connector 900 and the communications connector 1000 disclosed herein are significantly lower profile (i.e., take up a smaller envelope) relative to typical communications connector for a high voltage battery module application. In various embodiments, a cost of manufacture for each of the communications connector 900 and the communications connector 1000 can be greatly reduced relative to typical communications connectors for high voltage applications. In various embodiments, the communications connector 900 and the communications connector 1000 can prevent thermal runaway propagation from one of the battery module 200 to an adjacent of the battery module 200 from FIG. 2.

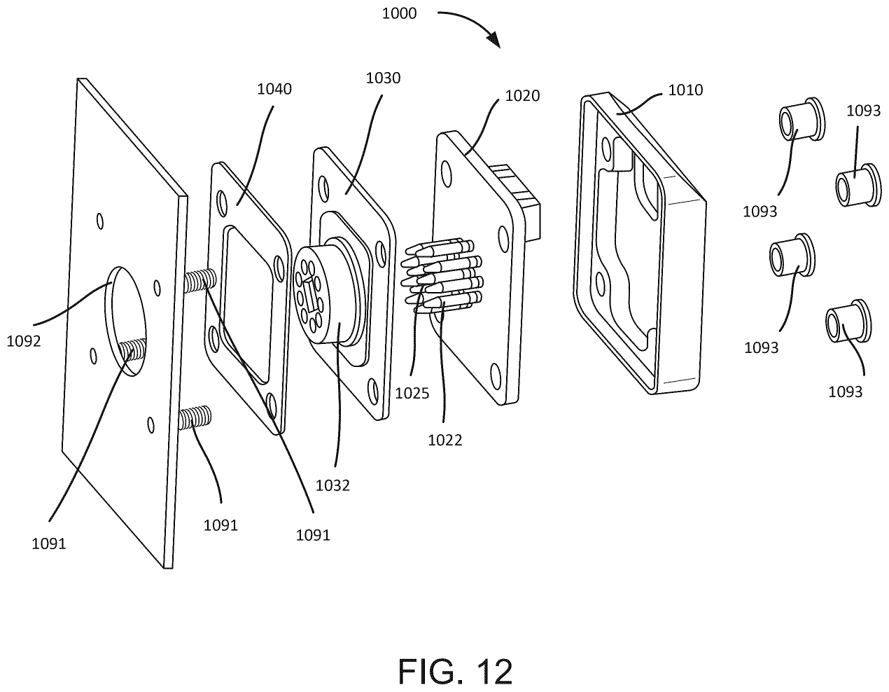

In various embodiments, with reference now to FIGS. 11 and 12, the housing 210 (e.g., one of the plurality of sidewalls 290 from FIG. 2) can comprise a plurality of studs 991, 1091 coupled thereto and extending into the cavity 212 of the housing 210 from FIG. 2. In various embodiments, to prevent a potential leakage path, each of the plurality of studs 991, 1091 can be fused to the housing 210 (e.g., via welding, brazing, or the like).

In various embodiments, a stack up that forms the communications connector 900, 1000 is configured to be coupled to the housing 210 by coupling each of the plurality of studs 991, 1091 to a respective fastener 993, 1093 (e.g., a nut or any other clamping or fastening hardware known in the art).

In various embodiments, the housing 210 for each of the communications connector 900 and the communications connector 1000 comprises an aperture 992, 1092 disposed therethrough. The aperture 992, 1092 is configured to receive an axial protrusion 932, 1032 of the seal 930, 1030 therethrough.

In various embodiments, a plurality of pins 1025 disposed on the pin board 1022 of the communications board 1020 are configured to mate with, and electrically couple to, a plurality of pin receptacles 925 on the target board 922 of the communications board 920. In this regard, in response to a battery connection step as described further herein, the communications connector 900 of a first of the battery module 200 is configured to be electrically coupled to a communications connector 1000 of a second of the battery module 200 to facilitate a daisy chain of communications between battery modules in a respective battery system (e.g., battery system 150 or battery system 160 from FIG. 1).

In various embodiments, similar to the electrical connector 500, 600, the seal 930 and the shield 910 of the communications connector 900, 1000 can comprise an electrically isolating material (e.g., a thermoplastic or the like). In various embodiments, the seal 930 and the shield 910 can each comprise a high-strength thermoplastic material, such as PEEK, or any other high-strength electrically isolating material known in the art. The present disclosure is not limited in this regard.

In various embodiments, the gasket 940 can comprise a flexible material, such as silicone, natural rubber, or the like. In this regard, the gasket 940 can be configured to create a seal between the cavity 212 in the housing 210 from FIG. 2 and an external environment, in accordance with various embodiments.

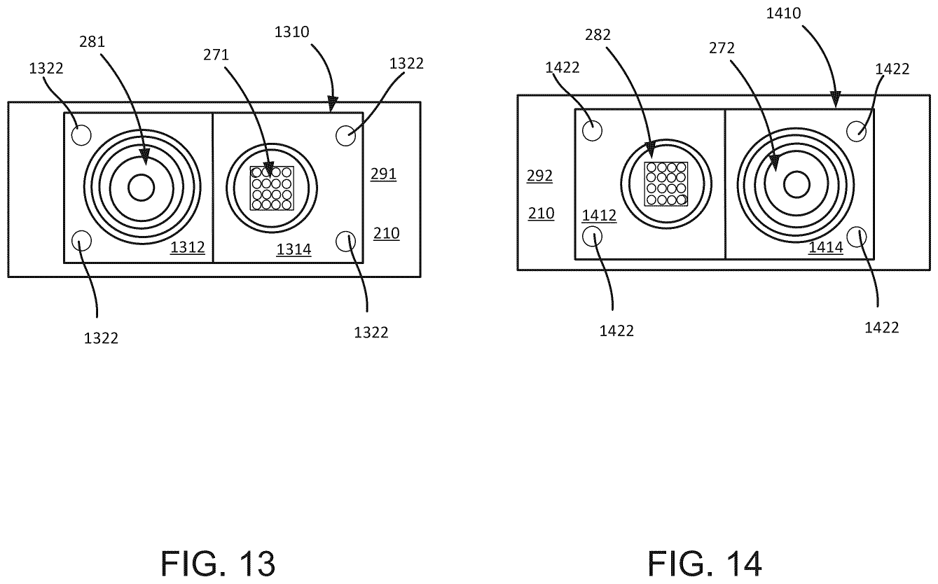

Referring now to FIGS. 13 and 14, a side view of the battery module 200 (e.g., looking towards sidewall 291 for FIG. 13 and looking towards sidewall 292 for FIG. 14) are illustrated in accordance with various embodiments, with like numerals depicting like elements. In various embodiments, the battery module 200 further comprises a connector shield 1310 and a connector shield 1410. In various embodiments, as described further herein, the connector shield 1310 of a first of the battery module 200 is configured to be coupled to the connector shield 1410 of a second of the battery module 200 in response to coupling the first of the battery module 200 to the second of the battery module 200 as described further herein. In this regard, a connection between the connector shield 1310 of the first of the battery module 200 and the connector shield 1410 of the second of the battery module 200 can be configured to protect the electrical connection between the first and the second of the battery module 200 from an external environment.

In various embodiments, each electrical connection (e.g., an electrical connection between the first electrical connector 281 and the second electrical connector 282, a communications connection between the first communications connector 271 and the second communications connector 272, or the like) can be a respective adapter connection. For example, the connector shield 1310 can comprise an adapter 1312 and an adapter 1314, and the connector shield 1410 can comprise an adapter 1412 and an adapter 1414. The adapter 1312 can be configured to be coupled to and interface with the adapter 1412 and the adapter 1314 can be configured to be coupled to and interface with the adapter 1414. In this regard, the adapter 1312, 1412 and the adapter 1314, 1414 can be separate and distinct components, or they can be combined as a single adapter/fitting as illustrated. The present disclosure is not limited in this regard. However, in various embodiments, by having the adapter 1312 and the adapter 1314 formed as a monolithic component, a part count of the assembly can be reduced and fewer mounting locations to the housing 210 can be utilized, in accordance with various embodiments.

In various embodiments, the connector shield 1310, 1410 is coupled to the sidewall 291 of the housing 210. The connector shield 1310 can be coupled to the housing 210 via fasteners or the like. In various embodiments, a plurality of blind nuts 1322, 1422 are fused (e.g., via welding, brazing, or the like) to the housing 210 and configured to receive a respective fastener (e.g., a stud, a bolt, or the like) to mount the connector shield 1310, 1410 to the housing 210. In this regard, by fusing each of the plurality of blind nuts 1322, 1422 to the housing 210, the cavity 212 of the housing 210 can be hermetically sealed from an external environment through the respective joint.

### Battery Systems of the Present Disclosure

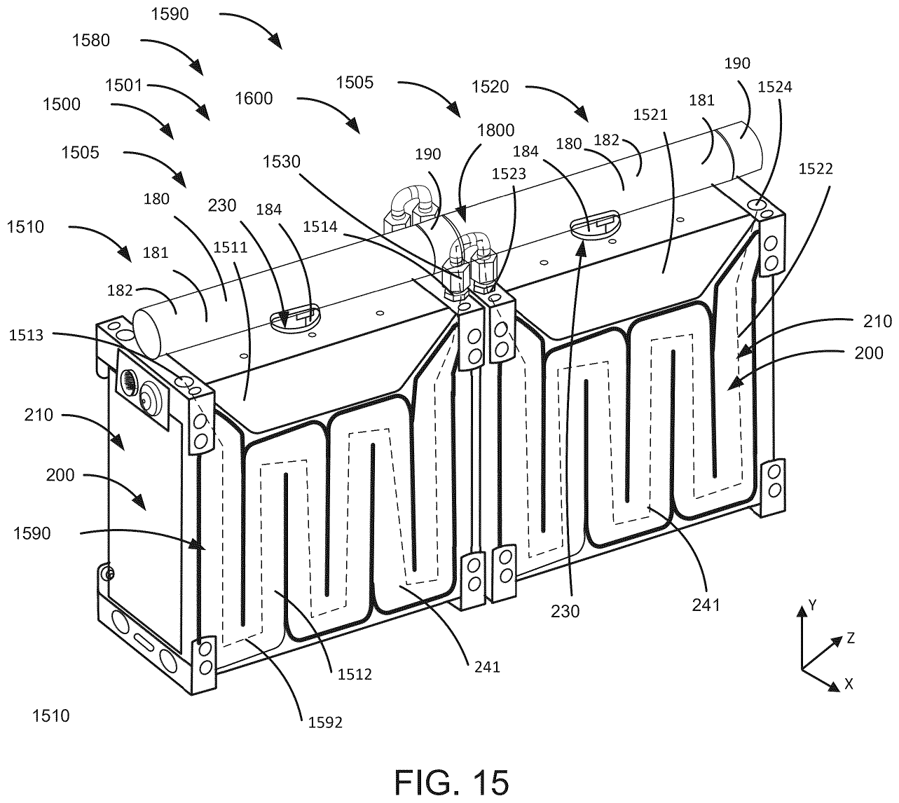

Referring now to FIG. 15, a perspective view of a portion of a battery system 1500 (e.g., battery system 150 and/or battery system 160 from FIG. 1) is illustrated with like numerals depicting like elements, in accordance with various embodiments. The battery system 1500 is illustrated with only two of the battery module 200; however, the present disclosure is not limited in this regard. For example, any number of the battery module 200 could be coupled together in multiple rows, multiple columns, or the like and be within the scope of this disclosure.

In various embodiments, the battery system 1500 (e.g., battery system 150 or battery system 160 from FIG. 1) is for supplying motive power to an electric vehicle (e.g., aircraft 100 from FIG. 1, an electrically powered vessel, or any other electrically powered vehicle). The battery system 1500 comprises a plurality of battery modules (e.g., a plurality of the battery module 200 as shown in FIG. 1). In various embodiments, each of the plurality of battery modules is configured to be coupled to an adjacent of the plurality of battery modules to form a battery (e.g., a battery with a positive terminal and a negative terminal for being electrically coupled to an electric machine, such as an electric motor to power the electric vehicle). In various embodiments each of the plurality of battery modules is the battery module 200 described previously and further herein.

In various embodiments, the battery system 1500 comprises an assembled configuration 1501, which is partially shown in FIG. 15.

The battery system 1500 comprises a plurality of battery modules 1505, the plurality of battery modules 1505 including a first 1510 of the battery module 200 coupled to a second 1520 of the battery module 200. In various embodiments, the first 1510 of the battery module 200 is coupled to the second 1520 of the battery module 200 in series through an electrical connection 1600. Similarly, a communications system of the battery system 1500 includes various communications lines, which extend from the first 1510 of the battery module 200 to the second 1520 of the battery module 200 through the electrical connection 1600 described further herein. Although described herein as being connected in series, the present disclosure is not limited in this regard and similar principles to those described herein can be utilized to form a parallel connection between two or more of the battery module 200 and still be within the scope of this disclosure. In various embodiments, the battery module 200 can comprise various electronic components therein (e.g., sensors, one or more processors, or any other electronic component known in the art). In this regard, the communications system and the communications connection formed between battery modules as described herein can allow the respective components disposed within a respective battery module to communicate with a battery management system of the battery system (e.g., battery system 150 and/or battery system 160 from FIG. 1), in accordance with various embodiments.

In various embodiments, a fluid path between a cold plate 241 of the first 1510 of the battery module 200 and a cold plate 241 of the second 1520 of the battery module 200 can be fluidly coupled together through a fluid conduit 1530 (e.g., a tube assembly, a fitting assembly, or the like). In this regard, a plumbing system 1590 (e.g., configured to form thermal management system during charging and/or configured to be inactive during discharging) for the battery system 1500 can include a fluid path defined in series through a plurality of the battery module 200, in accordance with various embodiments. In various embodiments, the assembled configuration 1501 comprises the plumbing system 1590. The plumbing system 1590 can be configured to receive a fluid during charging of the battery to provide thermal management of the plurality of battery modules 1505 during the charging. The plumbing system 1590 comprising an inlet (e.g., at a first end of the plumbing system), an outlet (e.g., disposed at a second end of the plumbing system), and a fluid path extending from the inlet through at least a portion of the plurality of battery modules 1505 (e.g., along fluid path 1592) to the outlet. In various embodiments, the plumbing system 1590 can comprise two distinct fluid paths (e.g., one that traverses along a first lateral side of each battery module and one that traverses along a second lateral side of each battery module), or a single distinct fluid path (e.g., one that traverses along a first lateral side of each battery module and is then routed back along a second lateral side of each battery module). In various embodiments, different rows of battery modules can have a different portion of the plumbing system 1590. In this regard, a first row of battery modules could receive fluid from a main header and a second row of battery modules could also receive the fluid from the main header along a different flow path. In this regard the flow path could include an inlet header, an outlet header, and a plurality of fluid paths disposed in parallel between rows of battery modules. In various embodiments the plumbing system 1590 can comprise a combination of fluid conduits (e.g., disposed between battery modules) and cold plates (e.g., associated with each of the plurality of battery modules).

In various embodiments, the plumbing system 1590 does not include a fluid source. In this regard, the plumbing system 1590 can be configured to be without a fluid disposed therein during discharging of the battery formed from the plurality of battery modules 1505. In various embodiments, by only supplying fluid through the plumbing system 1590 during charging of the battery system 1500, a weight of the battery system 1500 can be reduced significantly when powering an electrically powered aircraft (e.g., aircraft 100 from FIG. 1).

In various embodiments, when the aircraft 100 (e.g., an electrically powered aircraft) from FIG. 1 comprises the battery system 1500 in the assembled configuration 1501, the inlet and the outlet of the plumbing system 1590 can each be configured to be coupled to a fluid source that is off-board from the electrically powered aircraft during charging of the battery system 1500. For example, the inlet and the outlet of the plumbing system 1590 can comprise quick disconnect fittings configured to removably couple and de-couple from a fluid source (or plumbing that is fluidly coupled to the fluid source), in accordance with various embodiments. In various embodiments, the plumbing system 1590 is configured to receive a fluid during charging, and the plumbing system is configured to be without the fluid during operation of the electrically powered aircraft (e.g., aircraft 100 from FIG. 1).

In various embodiments, to facilitate the electrical connection 1600 between the first 1510 of the battery module 200 and the second 1520 of the battery module 200, the first 1510 of the battery module 200 and the second 1520 of the battery module 200 are pushed together in a longitudinal direction (i.e., the Z-direction). In this regard, with combined reference to FIGS. 2 and 13, the sidewall 292 of the first 1510 of the battery module 200 is pushed towards the sidewall 291 of the second 1520 of the battery module 200. In response to pushing the first 1510 of the battery module 200 together with the second 1520 of the battery module 200, the electrical connection 1600 between the first 1510 of the battery module 200 and the second 1520 of the battery module 200 is formed without any tooling hardware, or any additional external connections. Stated another way, an electrical connection (i.e., an electrical connection between cells and an electrical connection between communications) can be formed simply in response to pushing the first 1510 of the battery module 200 and the second 1520 of the battery module 200 together.

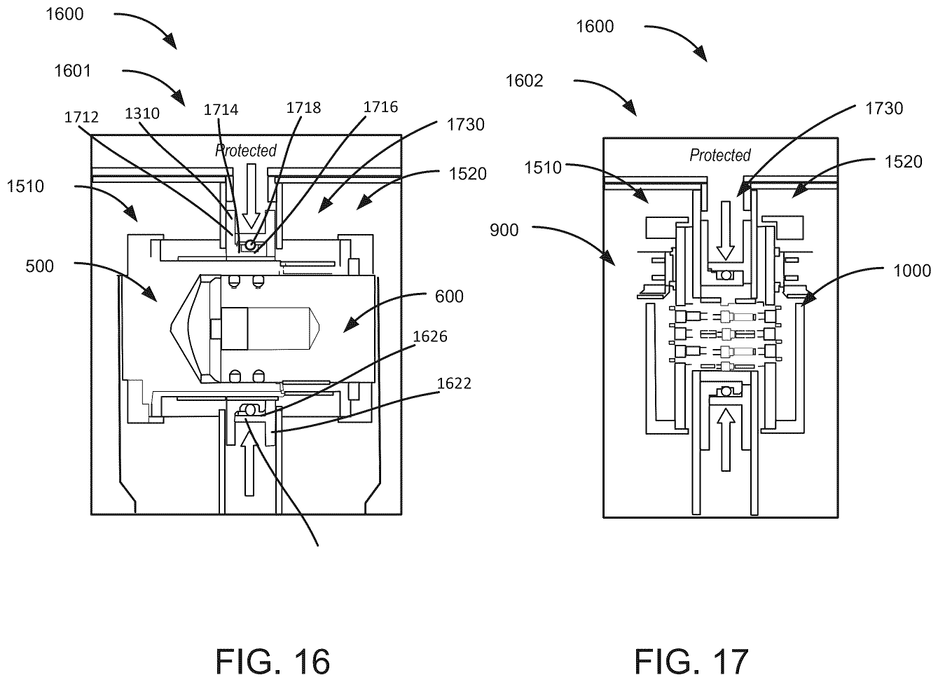

Referring now to FIGS. 16 and 17, a cross-sectional view of the electrical connection 1600 formed between the first 1510 of the battery module 200 and the second 1520 of the battery module 200 is illustrated, in accordance with various embodiments. The electrical connection 1600 includes a first connection 1601 between the electrical connector 500 and the electrical connector 600 and a second connection 1602 between the communications connector 900 and the communications connector 1000 described previously herein.

In various embodiments, in response to forming the electrical connection 1600, an additional seal can be provided between the first connection 1601 and the second connection 1602 to protect the electrical connection from an external environment. For example, the connector shield 1310 can comprise a generally cylindrical body 1714 protruding from a flange 1712 of the connector shield 1310, the generally cylindrical body 1714 including a radially outer surface with a groove 1716 disposed therein. Disposed within the groove 1716 is an O-ring 1718 (e.g., made of a flexible material, such as silicone, natural rubber, or the like). The O-ring 1718 is configured to interface with, and form a seal with, a radially inner surface of a generally cylindrical body 1626 extending outward from a flange 1622 of the connector shield 1410. In this regard, a portion of connector shield 1310 and a portion of the connector shield 1410 are configured to be coupled together and create a seal around the electrical connection formed between the electrical connector 500 and the electrical connector 600, in accordance with various embodiments. In this regard, a piloted O-ring connection 1730 between the connector shield 1310 coupled to the first 1510 of the battery module 200 and the second 1520 of the battery module 200 can protect the electrical connection from an external environment.

In this regard, in a similar manner, the connector shield 1310 and the connector shield 1410 can form a piloted O-ring connection 1730 around the electrical connection between the communications connector 900 of the first 1510 of the battery module 200 and the second 1520 of the battery module 200, in accordance with various embodiments.

### Low-Profile Connector Assemblies for Battery Systems

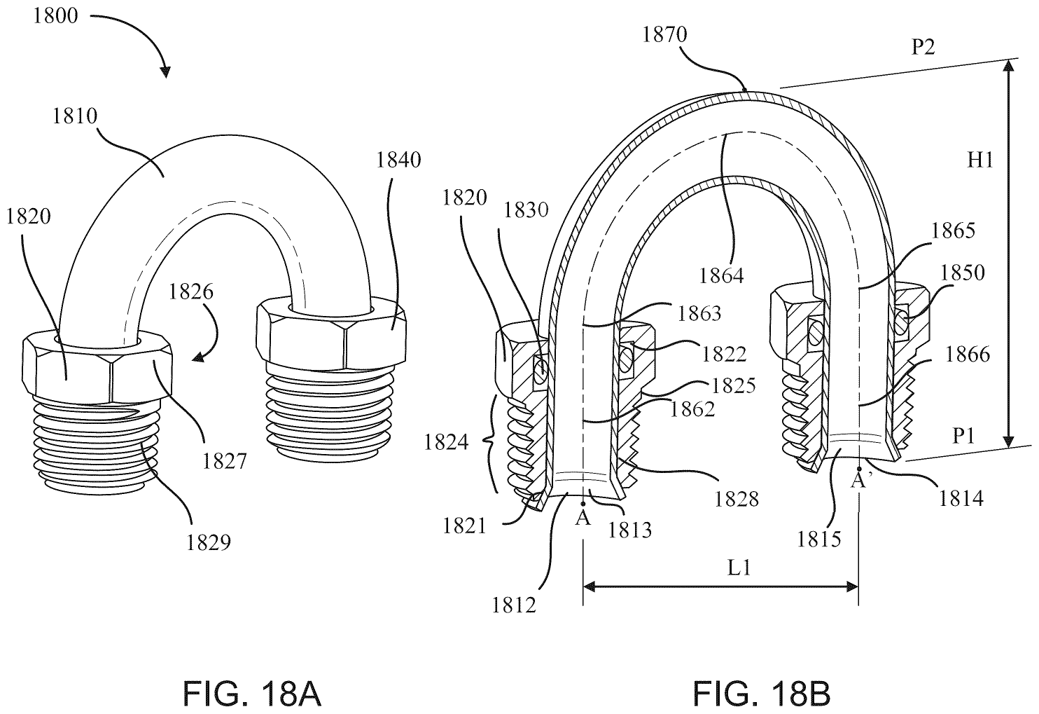

Referring now to FIGS. 18A and 18B, a perspective view (FIG. 18A), and a perspective cross-sectional view (FIG. 18B) of a tube assembly 1800 (e.g., a low-profile connector assembly, such as the fluid conduit 1530 from FIG. 15), is illustrated, in accordance with various embodiments.

In various embodiments, the tube assembly 1800, comprises: a tube 1810, a first fitting 1820, a first dynamic seal 1830, a second fitting 1840, and a second dynamic seal 1850. In various embodiments, the first fitting 1820 and the second fitting 1840 are the same (i.e., have the same geometry and/or shape). Accordingly, a part count can be reduced by utilizing the same fitting at both longitudinal ends of the tube assembly 1800. Similarly, in various embodiments, the first dynamic seal and the second dynamic seal are the same. Any structure associated with first fitting 1820 can be associated with second fitting 1840. Similarly, any structure associated with the first dynamic seal 1830 can be associated with the second dynamic seal 1850, in accordance with various embodiments.

In various embodiments, the tube can be made of a metal alloy (e.g., a nickel alloy, a stainless-steel alloy, a titanium alloy, an aluminum alloy, etc.). In various embodiments, the tube can comprise an aluminum alloy tube. However, the present disclosure is not limited in this regard. In various embodiments, by utilizing an aluminum alloy, the tube can be significantly lighter than alternative tube assemblies.

The tube 1810 extends from a first longitudinal end 1812 to a second longitudinal end 1814. The tube defines a longitudinal axis A-A′. The first longitudinal end 1812 can include a first flared end 1813. The first fitting 1820 is disposed proximate the first longitudinal end 1812. The first flared end 1813 of the tube 1810 is configured to retain the first fitting 1820 in response to coupling the first fitting 1820 to a first port. The first dynamic seal 1830 is configured to interface with an outer surface of the tube 1810 and an inner surface of the first fitting 1820.

In various embodiments, the tube assembly 1800 further comprises a second fitting 1840 disposed proximate the second longitudinal end 1814. In various embodiments, the second fitting 1840 is in accordance with the first fitting 1820. Stated another way, the first fitting 1820 and the second fitting 1840 can have the same geometry and/or shape, in accordance with various embodiments.

In various embodiments, the second longitudinal end 1814 of the tube 1810 includes a second flared end 1815, the second flared end 1815 end configured to retain the second fitting 1840 in response to coupling the second fitting 1840 to a second port (e.g., a fluid port of a plumbing system of a battery module).

In various embodiments, the longitudinal axis A-A′ of the tube 1810 includes a first line 1862 extending from the first longitudinal end 1812 to a first intermediate point 1863, an arcuate line 1864 extending from the first intermediate point 1863 to a second intermediate point 1865, and a second line 1866 extending from the second intermediate point 1865 to the second longitudinal end 1814. In various embodiments, the arcuate line 1864 defines a radius of curvature.

In various embodiments, the arcuate line 1864 transitions from a first direction defined by the first line 1862 to a second direction defined by the second line 1866, the first direction defining an angle between 1870 degrees and 190 degrees with the second direction.

In various embodiments, the first fitting 1820 defines an annular groove 1822, the first dynamic seal 1830 disposed within the annular groove 1822.

In various embodiments, the first dynamic seal 1830 is configured to seal a cavity defined by the tube from an external environment in response to installing the tube assembly 1800 in a plumbing system (e.g., a plumbing system for a battery system 150 from FIG. 1, battery system 1500 from FIG. 15, or the like).

In various embodiments, the first dynamic seal 1830 is an O-ring.

In various embodiments, the first fitting 1820 includes an engagement portion 1824 disposed on a radially outer surface 1825, and the engagement portion 1824 is configured to engage a complementary engagement portion of a port in response to coupling the first fitting 1820 to the port. In various embodiments, the engagement portion 1824 includes a male thread.

In various embodiments, a radially outer surface of the tube defines an apex 1870 between the first longitudinal end 1812 and the second longitudinal end 1814. In various embodiments, a height H1 is defined vertically from first a plane P1 defined by the first longitudinal end 1812 and the second longitudinal end 1814 and a second plane P2, the second plane P2 defined as parallel to the first plane P1 and having a point defined by the apex 1870 in the second plane P2. In various embodiments, the height is less than 1.1 inches (2.8 cm). Stated another way, the tube assembly 1800 can comprise a low-profile connector assembly, in accordance with various embodiments.

In various embodiments, the first longitudinal end 1812 is spaced apart from the second longitudinal end 1814 by a distance D1. D1 is measured from a first point defined by an intersection between the plane P1 and the longitudinal axis A-A′ at the first longitudinal end 1812 and a second point defined by an intersection between the plane P1 and the longitudinal axis A-A′ at the second longitudinal end 1814. In various embodiments, a ratio of height H1 to length L1 of the tube assembly 1800 can be 1.15:1 or less. For example, the height H1 can be less than or equal to 1.1 inches (2.8 cm) and the length L1 can be approximately 1 inch (2.54 cm), in accordance with various embodiments. In various embodiments, the height to length ratio is significantly smaller relative to typical 180-degree swivel connector tube assemblies, in accordance with various embodiments.

Referring back to FIG. 15, the battery system 1500 includes the first 1510 of the battery module 200, the second 1520 of the battery module 200, and at least one of the tube assembly 1800 (e.g., fluid conduit 1530). In various embodiments, the first 1510 of the battery module 200 is in accordance with the second 1520 of the battery module 200. Stated another way, the first 1510 of the battery module 200 and the second 1520 of the battery module 200 can have the same shape, be the same design, and include the same interfaces.

In various embodiments, the first 1510 of the battery module 200 includes a first sidewall 1511 defining a first fluid conduit 1512 therein, the first fluid conduit 1512 defined between a first port 1513 and a second port 1514. In various embodiments, the first sidewall 1511 forms the cold plate 241 of the first 1510 of the battery module 200. In various embodiments, the first 1510 of the battery module 200 can include two sidewalls in accordance with the first sidewall 1511 (i.e., being spaced apart in a lateral direction relative to each other). However, the present disclosure is not limited in this regard. In this regard, each broad side of the first 1510 of the battery module 200 can include the first sidewall 1511 (e.g., cold plate 241), which can provide a more uniform cooling (or heating) arrangement during operation of the respective plumbing system of the battery system 1500, in accordance with various embodiments.

Similarly, in various embodiments, the second 1520 of the battery module 200 includes a second sidewall 1521 defining a second fluid conduit 1522 therein, the second fluid conduit 1522 defined between a third port 1523 and a fourth port 1524.

In various embodiments, with combined reference to FIGS. 18A-B, 15, and 19, the tube assembly 1800 includes the first fitting 1820, the second fitting 1840, a first dynamic seal 1830, a second dynamic seal 1850, and the tube 1810 extending from the first longitudinal end 1812 to the second longitudinal end 1814 as illustrated in FIGS. 18A-B and described previously herein. The first fitting 1820 is coupled to the second port 1514, the second fitting 1840 is coupled to the third port 1523. The tube assembly 1800 fluidly couples the first fluid conduit 1512 to the second fluid conduit 1522 through the tube 1810.

In various embodiments, the first fitting 1820 can directly couple to the second port 1514, without an adapter or other components therebetween. In this regard, the tube assembly 1800 can facilitate the lower profile relative to typical arrangements by not having to have an adapter between a female fitting of a tube assembly (e.g., a B-nut on a ferrule end of a tube) and a female port (e.g., second port 1514).

In various embodiments, the first longitudinal end 1812 of the tube includes the first flared end 1813, the second longitudinal end 1814 of the tube 1810 includes a second flared end 1815, the first flared end 1813 is configured to retain the first fitting 1820 on the tube assembly 1800, and the second flared end 1815 is configured to retain the second fitting 1840 on the tube assembly 1800. In various embodiments, the tube assembly 1800 is configured to turn a fluid between 170 degrees and 190 degrees.

In various embodiments, the first dynamic seal 1830 and the second dynamic seal 1850 are both O-rings.

In various embodiments, the second port 1514 and the third port 1523 both includes a female thread, the first fitting 1820 and the second fitting 1840 both include a male thread (e.g., along the engagement portion 1824), and the male thread is configured to interface with the female thread.

In various embodiments, the second port 1514 and the third port 1523 both includes a female thread, the first fitting 1820 and the second fitting 1840 both include a male thread (e.g., along the engagement portion 1824), and the male thread is configured to interface with the female thread.

In various embodiments, the first fitting 1820 and the second fitting 1840 each comprise: a body 1826 including a head portion 1827 and a threaded portion 1829 (i.e., engagement portion 1824) extending axially from the head portion 1827; and an aperture 1828 disposed axially through the head portion 1827 and the threaded portion 1829 and defining a radially inner surface, the radially inner surface disposed adjacent to a radially outer surface of the tube 1810.

In various embodiments, the first fitting 1820 and the second fitting 1840 each further comprise: the annular groove 1822 disposed in the radially inner surface of the body 1826; and a chamfer 1821 in the radially inner surface at an end of the body opposite the head portion 1827, wherein the chamfer 1821 interfaces with a flared end (e.g., first flared end 1813 or second flared end 1815) of the tube 1810.

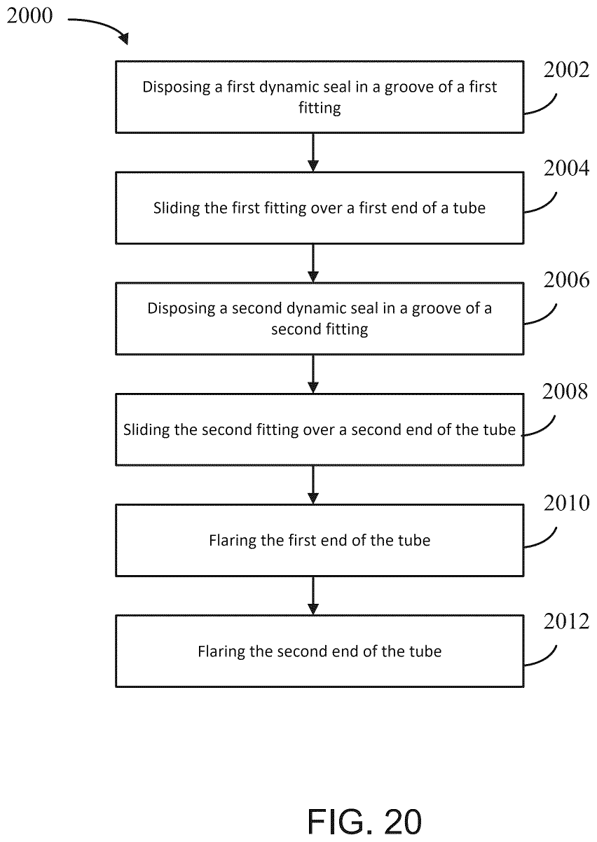

Referring now to FIG. 20, a method 2000 of manufacturing a tube assembly 1800 from FIG. 1 is illustrated, in accordance with various embodiments.

With combined reference now to FIGS. 18A-B and 20, in various embodiments, the method 2000 comprises disposing a first dynamic seal 1830 in an annular groove 1822 of a first fitting 1820 (step 2002). The method 2000 further comprises sliding the first fitting 1820 over a first longitudinal end 1812 of a tube 1810 (step 2004). The first dynamic seal 1830 can interface with a radially outer surface of the tube 1810 in response to sliding the first fitting 1820 over the first longitudinal end 1812. The method 2000 further comprises disposing a second dynamic seal 1850 in an annular groove 1822 of a second fitting 1840 (step 2006). The method 2000 further comprises sliding the second fitting 1840 over second longitudinal end 1814 of the tube 1810 (step 2008). The second dynamic seal 1850 can interface with the radially outer surface of the tube 1810 in response to sliding the second fitting 1840 over the second longitudinal end 1814. The method 2000 can further comprise flaring the first longitudinal end 1812 radially outward to form a first flared end 1813 (step 2010). The method 2000 further comprises flaring the second longitudinal end 1814 radially outward to form a second flared end 1815 (step 2012). The method 2000 can further comprise bending the tube 1810 prior to the sliding the first fitting 1820 over the first longitudinal end 1812, wherein in response to the bending, the tube 1810 includes a single bend between the first longitudinal end 1812 and the second longitudinal end 1814.

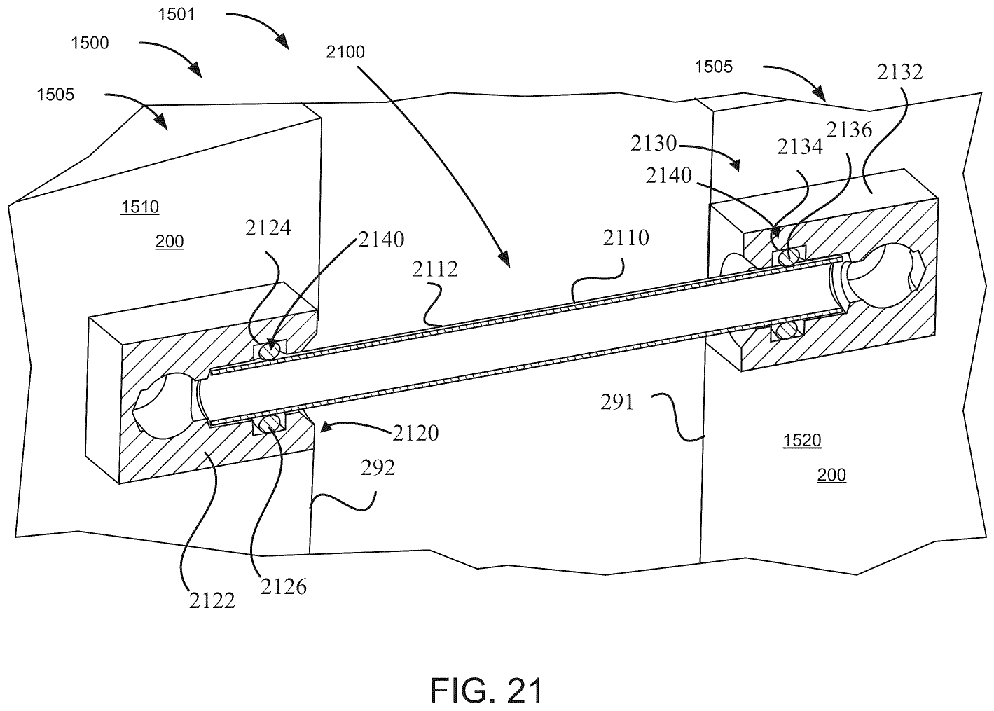

Referring now to FIG. 21, a perspective cross-sectional view of the battery system 1500 from FIG. 15 that replaces the tube assembly 1800 with a plumbing arrangement 2100 is illustrated, in accordance with various embodiments. In various embodiments, by utilizing the plumbing arrangement 2100 with a straight tube 2110, connector 2122, connector 2132, and one or more of a dynamic seal 2140 associated with each connector (e.g., O-ring 2126 for connector 2122 and O-ring 2136 for connector 2132), the fluid connection between the cold plate 241 of a first 1510 of the battery module 200 and the cold plate 241 of a second 1520 of the battery module 200 can be simpler, less expensive, less weight, and/or less cost relative to the tube assembly 1800 from FIG. 18. Although illustrated as O-rings 2126, 2136, various other dynamic seals, such as gaskets, face seals, or the like may be readily apparent to one skilled in the art and would be within the scope of this disclosure. In various embodiments, the plumbing arrangement 2100 could include more than one of the dynamic seal 2140 per connector (e.g., two of the O-ring 2126 for the connector 2122 and/or two of the O-ring 2136 for the connector 2132). In this regard, redundant sealing could be provided in case of wear, in accordance with various embodiments. For example, the gap between the first 1510 of the battery module 200 and the second 1520 of the battery module 200 can be relatively small (e.g., approximately 0.200 inches (0.51 cm)), the straight tube 2110 can be straight (i.e., without bends), which can be ordered as tube stock without any fabrication processes, such as tube bending, the straight tube 2110 can be without fittings (e.g., fittings to couple to another plumbing component, such as first fitting 1820 and second fitting 1840 from FIG. 18), and/or a vertical profile of the connection (e.g., as shown in FIG. 18) can be eliminated, in accordance with various embodiments.

In various embodiments, each of the battery module 200 comprises a first port (e.g., port 2130 of the second 1520 of the plurality of the battery module 200) disposed through a first lateral sidewall (e.g., sidewall 291 of the second 1520 of the battery module 200), the first port in fluid communication with a fluid conduit of the respective battery module 200 (e.g., the fluid conduit disposed through the cold plate 241 as shown in FIG. 2). In various embodiments, each of the battery module 200 further comprise a second port (e.g., port 2120 of the first of the plurality of the battery module 200) disposed through the second lateral sidewall (e.g., sidewall 292 of the first 1510 of the battery module 200), the second port in fluid communication with the fluid conduit of the respective battery module.

In various embodiments, the assembled configuration 1501 of the battery system 1500 comprises a straight tube 2110 extending from the second port (e.g., port 2120) of the first 1510 of the battery module 200 to the first port (e.g., port 2130) of the second 1520 of the battery module 200. The straight tube 2110 is secured to the second port (e.g., port 2120) of the first 1510 of the battery module 200 and the first port (e.g., port 2130) of the second 1520 of the battery module 200, the straight tube 2110 defining a portion of the fluid path of the plumbing system described previously herein.

In various embodiments, the plumbing arrangement 2100 is disposed on both lateral sides of a respective row of battery modules in the battery system 1500. For example, with brief reference to FIG. 2, sidewall 293 and sidewall 294 can each comprise a cold plate 241 as described previously herein. In this regard, the plumbing system from FIG. 15 can include a portion of a first flow path that travels in a Z-direction along a first lateral side of the row of battery modules and a portion of a second flow path that travels in the Z-direction along a second lateral side of the row of battery modules on a second lateral side opposite the first lateral side. In this regard, with combined reference to FIGS. 2 and 21, each of the plurality of battery modules 1505 can further comprise a second vane plate (e.g., a second of the vane plate 242) coupled to the second broad sidewall (e.g., sidewall 293), a second fluid conduit at least partially defined between the second vane plate and the second broad sidewall, a third port (e.g., second of the port 2130 spaced apart laterally from the port 2130 shown in FIG. 21) disposed through the first lateral sidewall (e.g., sidewall 291), the third port in fluid communication with the second fluid conduit; and a fourth port (e.g., a second of the port 2120 spaced apart laterally from the port 2120 shown in FIG. 21) disposed through the second lateral sidewall (e.g., sidewall 292), the fourth port in fluid communication with the second fluid conduit.

In various embodiments, the assembled configuration 1501 further comprises a second straight tube (e.g., a second of the straight tube 2110) extending from the fourth port of the first 1510 of the battery module 200 to the third port of the second 1520 of the battery module 200. In this regard, the second tube can be spaced apart laterally from the straight tube 2110 and fluidly couple a cold plate from the first 1510 of the battery module 200 that is disposed on an opposite broad sidewall from that shown in FIG. 21 to a cold plate from the second 1520 of the battery module 200 that is disposed on an opposite broad sidewall from that shown in FIG. 21.

In various embodiments, the first port (e.g., port 2130) and the second port (e.g., port 2120) for each of the plurality of battery modules 1505 each comprise a central axis aligned in a longitudinal direction relative to the first 1510 and the second 1520 of the plurality of battery modules 1505.

In various embodiments, each of the plurality of battery modules 1505 further comprises a first connector (e.g., connector 2132 for the second 1520 of the battery module 200) disposed within the first port (e.g., port 2130 for the second 1520 of the battery module 200); and a second connector (e.g., connector 2122 for the first 1510 of the battery module 200) disposed within the second port (e.g., port 2120 for the first 1510 of the battery module 200), the first connector and the second connector each comprising an annular groove (e.g., annular groove 2124 for connector 2122 and annular groove 2134 for connector 2132). In various embodiments, the assembled configuration 1501 comprises a first O-ring disposed in the annular groove of the second connector of the first of the plurality of battery modules (e.g., O-ring 2126 disposed in the annular groove 2124 of the connector 2122 for the first 1510 of the battery module 200) and a second O-ring disposed in the annular groove of the first connector of the second of the plurality of battery modules (e.g., O-ring 2136 disposed in the annular groove 2134 of the connector 2132 for the second 1520 of the battery module 200). In various embodiments, in the assembled configuration 1501, the first O-ring is compressed between the annular groove of the second connector of the first of the plurality of battery modules and an outer diameter surface of the first straight tube and the second O-ring is compressed between the annular groove of the first connector of the second of the plurality of battery modules and the outer diameter surface of the first straight tube.

In various embodiments, in the assembled configuration 1501, the fluid path is at least partially defined from the first port of the first 1510 of the plurality of battery modules 1505, through the first fluid conduit (e.g., disposed through the cold plate 241 from FIG. 2 of the first 1510 of the battery module 200), out the second port (e.g., port 2120) of the first of the plurality of battery modules, through the first straight tube (e.g., straight tube 2110), into the first port (e.g., port 2130) of the second 1520 of the plurality of battery modules 1505, through the first fluid conduit of the second of the plurality of battery modules (e.g., the cold plate 241 for the second 1520 of the battery module 200), out the second port of the second of the plurality of battery modules, and through a second straight tube to at least a portion of a remaining number of the plurality of battery modules 1505. In this regard, the plumbing arrangement 2100 only illustrates a small portion of the plumbing system for the battery system 1500, in accordance with various embodiments.

In various embodiments, the assembled configuration 1501 further comprises a second straight tube extending from the from the second port of the second of the plurality of battery modules to the first port of a third of the plurality of battery modules, the second straight tube secured to the second port of the second of the plurality of battery modules and the first port of the third of the plurality of battery modules. For example, a second of the straight tube 2110 can be spaced apart laterally from the straight tube 2110 and fluidly couple cold plates of the first 1510 of the battery module 200 and the second 1520 of the battery module from an opposite broad sidewall relative to the one illustrated in FIG. 21, in accordance with various embodiments.

In various embodiments, the straight tube 2110 is without fittings, adapters or attachment features. In this regard, an outer diameter surface 2112 can be configured as a sealing surface for the O-ring 2126 disposed in the annular groove 2124 of the connector 2122 and the sealing surface for the O-ring 2136 disposed in the annular groove 2134 of the connector 2132 without any additional components. Accordingly, the straight tube 2110 can be significantly less expensive relative to the tube assembly 1800, which utilizes multiple components, a tube bending process, and assembly of the fittings 1820, 1840, in accordance with various embodiments.

### Custom Gang Vent Adapters for Battery Modules

Disclosed herein are vent adapters for use in exhaust systems for a battery system, in accordance with various embodiments. The vent adapters can be configured to provide a sealing interface with a vent port of a battery module and configured to interface with an adjacent component for an exhaust system. In this regard, the vent adapter can facilitate a simple interface for a customer to incorporate a custom exhaust system with a battery system utilizing battery modules with the vent port, in accordance with various embodiments. Stated another way, battery modules for use in aircrafts have various standards the battery module has to meet in order to be considered airworthy (i.e., in order for the battery to be considered safe to power an aircraft). Accordingly, by having a simple vent adapter for interfacing with a vent port of a battery module that is designed and configured to meet an airworthiness standard, and which may be certified to the airworthiness standard, the battery module will not have to be re-certified to interface with a custom exhaust configuration, in accordance with various embodiments.

Referring back to FIG. 4, the inner diameter surface 232 of the vent port 230 is configured to interface with a mating component (e.g., an adapter as described further herein). In various embodiments, the inner diameter surface 232 defines a threaded portion 234 (e.g., having a female thread extending over an axial distance). The threaded portion 234 includes a pitch diameter to thread pitch ratio that is greater than 30:1, or between 30:1 and 60:1, or approximately 42:1. Typical standard pitch diameter to thread ratios for standard threads are between 3:1 and 15:1. Pitch diameter to thread pitch ratios as provided herein are significantly greater than typical standards, which increases manufacturing costs, often utilizes custom tooling for inspection, and reduces pressure capability of the interface. However, by utilizing the pitch diameter to thread pitch ratio disclosed herein, the port interface of the vent port 230 is configured to provide a large throat area (i.e., a large diameter aperture) to facilitate exhausting debris in response to a thermal runaway event of a cell within the housing 210 and facilitate self-sealing of the interface during the thermal runaway event to prevent gases from escaping the exhaust system, in accordance with various embodiments. In various embodiments, the pitch diameter to thread ratio provided herein can be further facilitated by the low-pressure environment of the interface of the vent port 230. For example, during operation, the vent port 230 is exposed to little to no pressure, and even during a thermal runaway event, the vent port 230 is exposed to a small amount of pressure (e.g., less than 10 psi). In this regard, although the interface may have reduced pressure capability from the large pitch diameter to thread ratio, the interface may still meet a design intent, in accordance with various embodiments.

In various embodiments, a starting thread pitch diameter of the threaded portion 174 is between 1 inch (2.54 cm) and 2 inches (3.1 cm). In various embodiments a thread pitch of the threaded portion 174 is between 20 to 40 threads per inch.

In various embodiments, the lid 295 and the vent port 230 can each be made of titanium or a titanium alloy as described previously herein. Moreover, any suitable material may be used that is capable of withstanding thermal runaway conditions. The lid 295 and the vent port 230 can provide thermal runaway containment capabilities, in accordance with various embodiments.

Referring back to FIG. 15, the first 1510 of the battery module 200 and the second 1520 of the battery module 200 each comprises a local vent 180 (e.g., a tube assembly 181 including a tube 182 extending from a first longitudinal end to a second longitudinal end and defining a longitudinal axis, and a fitting 184 extending radially outward from the longitudinal axis). The fitting 184 can be coupled to the tube 182 (e.g., via welding, brazing, etc.). In various embodiments, the fitting 184 is welded to the tube 182.

The local vent 180 is configured to be in fluid communication with a cavity defined by the housing 210 of a respective battery module (e.g., first 1510 of the battery module 200, second 1520 of the battery module 200, etc.) during a thermal runaway event. In various embodiments, the fluid communication between the cavity defined by the housing 210 and the local vent 180 can occur due to the thermal runaway event or exist prior to the thermal runaway event. The present disclosure is not limited in this regard. In various embodiments, the local vent 180 for each battery module is coupled to an adjacent vent via a coupler 190 (e.g., a polymeric coupler with a metallic hose clamp) configured to couple a first of the local vent 180 to an adjacent of the local vent 180. Stated another way, the local vent 180 of the first 1510 of the battery module 200 is coupled to the local vent 180 of the second 1520 of the battery module 200 via a respective coupler 190. In this regard, the battery system 1500 can comprise a venting structure (e.g., an exhaust system) that includes a plurality of the local vent 180 coupled together to form a single venting channel for a row of battery modules (e.g., first 1510 of the battery module 200, second 1520 of the battery module 200, etc.). In various embodiments, the coupler 190 can accommodate misalignment between adjacent tube assemblies and manage high-temperatures (e.g., temperatures in excess of 2,000 deg F. (1,093 deg C.)).

In various embodiments, the fitting 184 is configured to interface with the vent port 230 described previously herein. In this regard, the fitting 184 can include a male thread configured to engage the threaded portion 174 of the vent port 230 described previously herein. Although described herein as the fitting 184 including the male thread and the vent port 230 including the female thread, the present disclosure is not limited in this regard. For example, the vent port 230 can include a male thread and the fitting 184 can include a female thread and would still be within the scope of this disclosure. However, by having the vent port 230 with a female thread, the vent port 230 can encompass a smaller envelope relative to providing the vent port 230 with a male thread, in accordance with various embodiments.

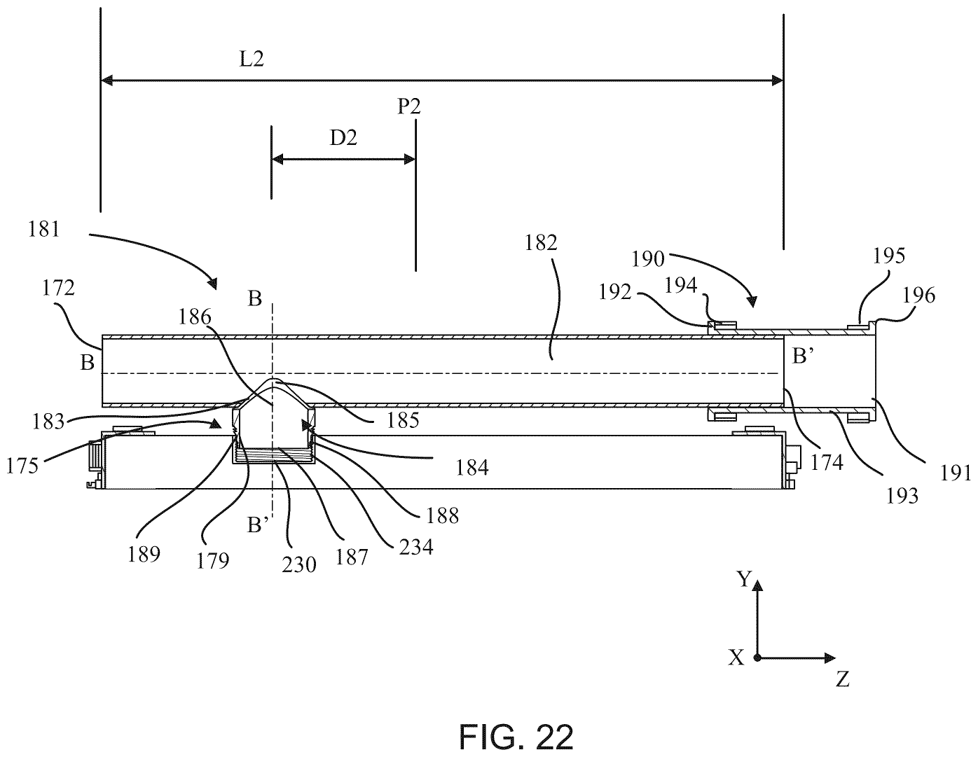

For example, with reference now to FIG. 22, a cross-sectional view of an interface 175 (e.g., a threaded interface) between the vent port 230 and the fitting 184) is illustrated, in accordance with various embodiments. In various embodiments, the fitting 184 is coupled to the tube 182 of the tube assembly 181 via welding or the like. In this regard, the tube 182 can include a cutout 185 having a complementary shape to a first longitudinal end 186 of the fitting 184. The fitting 184 extends from a first longitudinal end 186 to a second longitudinal end 187. In various embodiments, the fitting 184 includes a threaded portion 188 disposed on a radially outer surface 189 of the fitting 184. The threaded portion can include a male thread configured to engage the threaded portion 234 of the vent port 230.

In various embodiments, the fitting 184 is made of a first material, the vent port 230 is made of a second material, and the first material is different from the second material. For example, the first material can include a first metal or metal alloy (e.g., stainless steel) and the second material can include a second metal or metal alloy (e.g., titanium). In various embodiments, the interface 175 between the fitting 184 and the vent port 230 can be configured to self-seal in response to a temperature exceeding a threshold temperature (e.g., an environment exceeding 400 deg F. (or 204 deg C.)). In this regard, heat in a cavity of the housing 210 of the battery module 200 from FIG. 2 can exceed 400 deg F. (or 204 deg C.) in response to a cell disposed in the housing 210 entering thermal runaway. During thermal runaway, it is desirable to contain gases that are emitted within the exhaust system. In this regard, by having the interface 175 configured to self-seal, gases that are emitted during thermal runaway can be contained within the exhaust system, in accordance with various embodiments. The self-sealing can occur at least in part due to the thermal expansion being different between the materials and the large pitch diameter to thread ratio described previously herein.

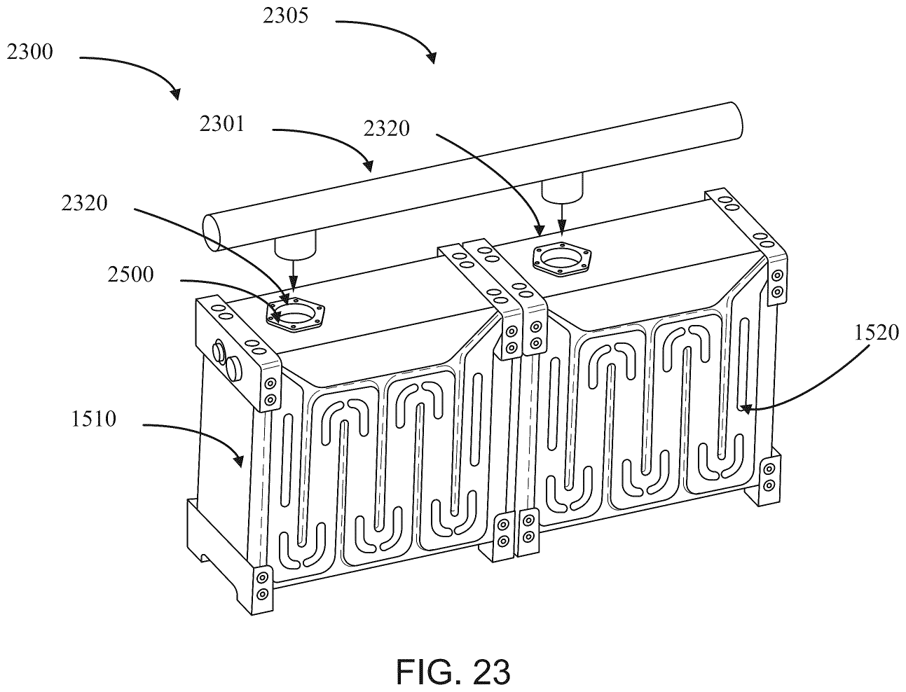

Referring now to FIG. 23, in various embodiments, it may be desirable for a customer (e.g., an airframer or any other customer of a high voltage battery powered solution), to provide a custom vent system 2301 to instead of utilizing the exhaust system designed and configured for the battery system 1500 from FIG. 15. Accordingly, in order to ensure that the first 1510 of the battery module 200, the second 1520 of the battery module 200, etc. of the battery system 2300 with the custom vent system 2301 meet certification standards and/or airworthiness standards, the tube assembly 181 with the fitting 184 disclosed previously herein can be replaced with a stand-alone fitting (e.g., an adapter 2500) to facilitate a common interface with the custom vent system 2301. In this regard, FIG. 23 illustrates a portion of an exhaust system 2305 for the battery system 2300 in accordance with various embodiments.

The exhaust system 2305 includes a plurality of battery modules (e.g., the first 1510 of the battery module 200, the second 1520 of the battery module 200, etc.) and a plurality of adapters 2320 (e.g., a plurality of the adapter 2500). Each battery module in the plurality of battery modules includes the vent port 230 described previously herein.

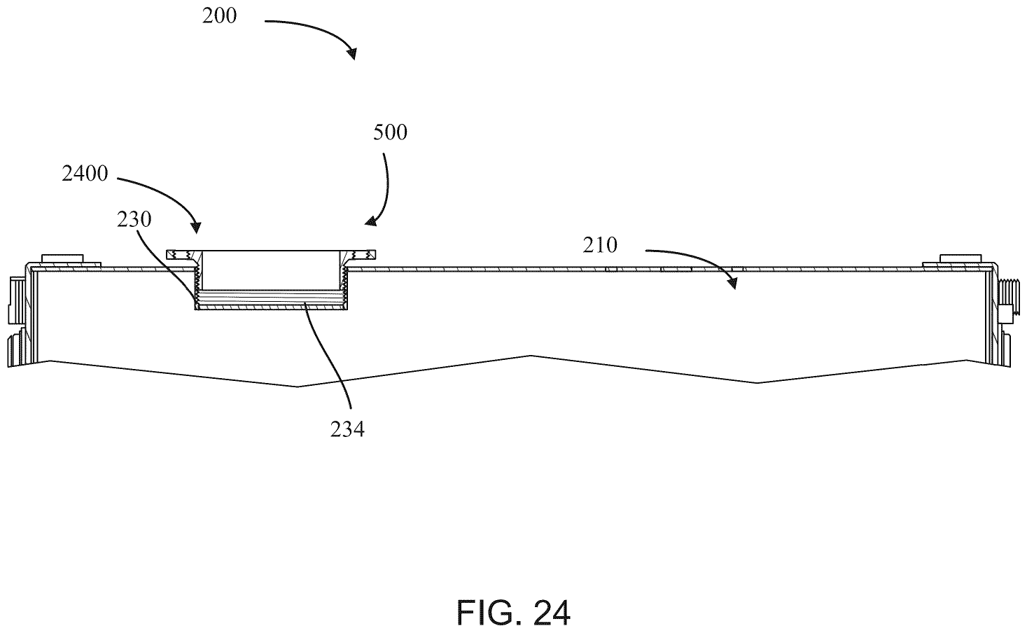

Referring now to FIG. 24, a cross-sectional view of an interface 2400 between the adapter 2500 (e.g., a vent adapter configured to interface with the custom vent system 2301 from FIG. 23) and the vent port 230 of the housing 210 of the battery module 200 is illustrated, in accordance with various embodiments.

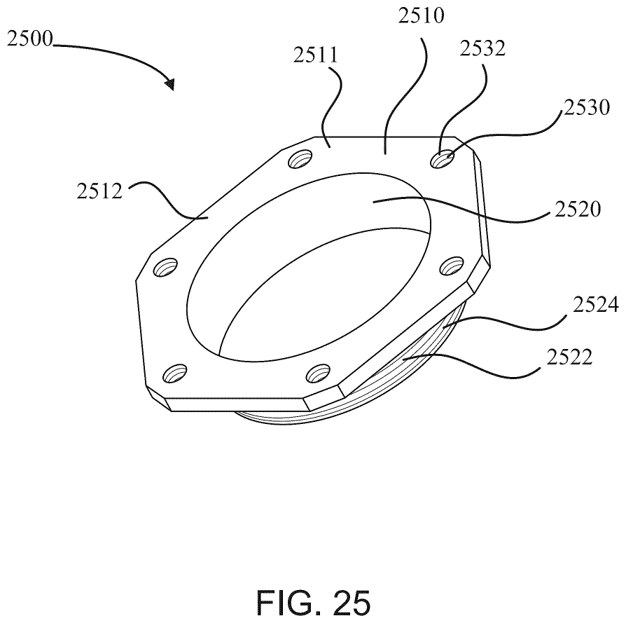

With reference now to FIG. 25, a perspective view of the adapter 2500 is illustrated, in accordance with various embodiments. In various embodiments, the adapter 2500 comprises a flange 2510, and a tubular element 2520 extending axially from the flange 2510, the tubular element 2520 including a radially outer surface 2522, the radially outer surface 2522 including a threaded portion 2524 (e.g., a male thread configured to interface with the threaded portion 234 of the vent port 230). In various embodiments, the threaded portion 2524 includes a male threaded portion having a pitch diameter to thread pitch ratio that is greater than 30:1 for reasons described previously herein. In various embodiments, the pitch diameter to thread ratio is between 30:1 and 60:1. In various embodiments, a starting thread pitch diameter for the threaded portion 2524 is between 1 inch (2.54 cm) and 2 inches (3.1 cm), and wherein a thread pitch is between 20 to 40 threads per inch. In various embodiments, the flange 2510 defines a hexagonal shape 2512. In this regard, the flange 2510 can include a mating interface 2511, in accordance with various embodiments. In this regard, the adapter 2500. In various embodiments, the mating interface 2511 can be a flat surface, such that the mating interface 2511 can mate with a seal (e.g., a gasket seal a metal-to-metal seal, a negative slip seal, or the like). The present disclosure is not limited in this regard. Although illustrated as having a hexagonal shape 2512, the flange 2510 is not limited in this regard.

In various embodiments, a plurality of apertures 2530 are spaced apart circumferentially about the flange 2510. In various embodiments, each aperture in the plurality of apertures 2530 is threaded with a threaded portion 2532.

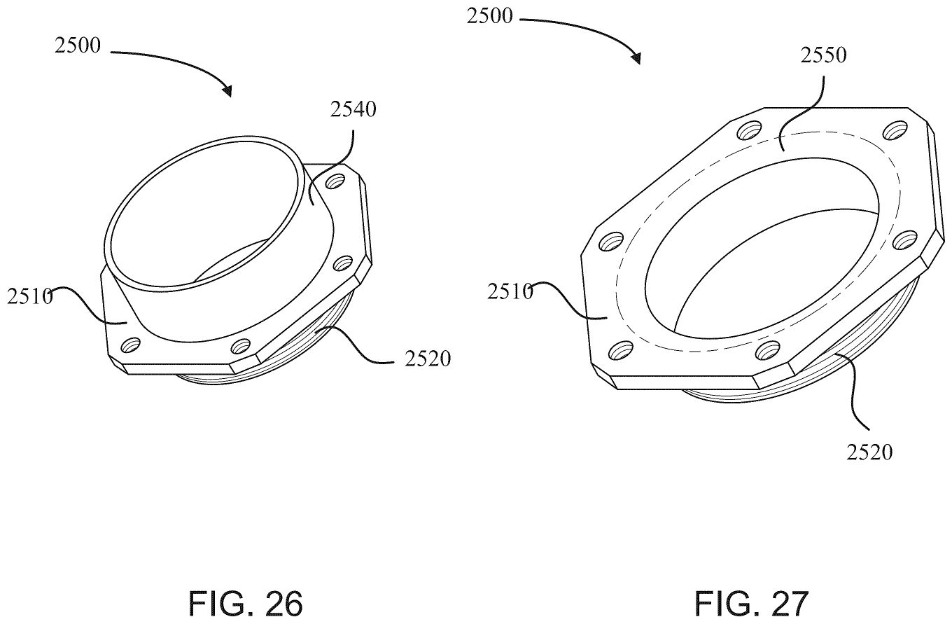

Referring back to FIG. 24, in various embodiments, the adapter 2500 is made of a material that is dissimilar from the material of the vent port 230 in a similar manner to the fitting 184 of the tube assembly 181 from FIGS. 15 and 22 described previously herein. For example, the adapter 2500 can be a first metal (e.g., stainless steel, nickel, a nickel alloy, an iron-based alloy, or any other material known in the art) and the vent port 230 can be a second metal (e.g., titanium or a titanium alloy), in accordance with various embodiments. In various embodiments, the adapter 2500 is not limited to the adapter illustrated in FIG. 25. For example, with reference now to FIG. 26, the adapter 2500 can further include a second tubular element 2540 extending from the flange 2510 in an axially opposite direction relative to the tubular element 2520. In this regard, the adapter 2500 of FIG. 26 can be configured for a metal-to-metal seal or a positive slip seal, in accordance with various embodiments. With reference now to FIG. 27, the adapter 2500 can further include a groove 2550 extending between the flange 2510 and a radially inner surface of the tubular element 2520, in accordance with various embodiments. The groove 2550 can facilitate various seal arrangements, in accordance with various embodiments.

### Battery Housing Anchor Arrangement

Disclosed herein is a battery module that defines a core battery building block. In this regard, the battery module is adaptable for use in various applications that have significant standards for certification (e.g., aviation applications or the like). For example, the battery module can include a design that facilitates mounting to various support structures, is adaptable to various mounting brackets, and can provide a common interface for ingress protection of the battery module. In various embodiments, as described further herein, the battery module comprises a plurality of anchors, each of the plurality of anchors coupled to, or integral with, the housing 210 from FIG. 1.

Each of the plurality of anchors are multi-functional from a single component approach that enables variable system level architecture. In particular, each of the plurality of anchors in the anchor arrangement disclosed herein provide (1) mounting location for the core of the battery module 200 transmitting battery inertial loads into a respective frame (e.g., an airframe of an aircraft 100 from FIG. 1); (2) ingress seal protection of the plurality of cells 222 from FIG. 2 from an external environment; and (3) module level thermal runaway sealing for containment (i.e., no ejecta or debris escapes through the housing 210 from FIG. 2 via a respective anchor). In various embodiments, by combining these three functions into a single component, a reduction in battery mass is obtained, which can be a significant factor for aeronautical applications, and/or optionality for installation can be achieved (i.e., various mounting orientations can be achieved).

In various embodiments, the anchor arrangement disclosed herein can facilitate a small gap (e.g., between 0.100 inches (0.25 cm) and 0.300 inches (0.76 cm), or approximately 0.200 inches (0.51 cm)) between modules (e.g., between the first 1510 of the battery module 200 and the second 1520 of the battery module 200 in FIG. 15). In various embodiments, the anchor arrangement is configured to transmit loads induced by a thermal runaway event of a cell in the battery module 200 from FIG. 2 directly into a frame that the battery module 200 is mounted to. Stated another way, loads induced by a thermal runaway event of a cell in the plurality of cells 222 from FIG. 2 that propagates throughout the plurality of cells 222 form FIG. 2 can produce significant loads that the anchor arrangement is configured to transmit into the frame, maintain structural integrity, and seal the internal cavity of the housing 210 from the external environment, in accordance with various embodiments. In various embodiments, by combining the three functions into a single component, a part count can be reduced, which can improve manufacturability and cost, in accordance with various embodiments.

Referring now to FIG. 28, a perspective view of the battery module 200 from FIG. 2 prior to attaching the plurality of brackets 251 to the housing 210, with like numerals depicting like elements is illustrated, in accordance with various embodiments. The battery module 200 further comprises a plurality of anchors 2830. In various embodiments, the plurality of anchors 2830 form an anchor arrangement 2850. In various embodiments, each anchor in the plurality of anchors 2830 is coupled to a sidewall in a set of sidewalls 2860 (sidewall 291, sidewall 292, lid 295, and bottom panel 296).

In various embodiments, the anchor arrangement 2850 includes at least two anchor sub-arrangements (e.g., anchor sub-arrangement 2851, anchor sub-arrangement 2852, anchor sub-arrangement 2853, and/or anchor sub-arrangement 2854). In various embodiments, each anchor sub-arrangement of the anchor arrangement 2850 includes at least two anchors coupled to the first lateral sidewall (e.g., sidewall 291) and at least two anchors coupled to an adjacent sidewall (e.g., the lid 295 or the bottom panel 296 for the sidewall 291 and the lid 295 or the bottom panel 296 for sidewall 292). In this regard, each anchor sub-arrangement (e.g., anchor sub-arrangement 2851, anchor sub-arrangement 2852, anchor sub-arrangement 2853, and/or anchor sub-arrangement 2854) is configured to transmit inertial loads experienced by the battery module 200 into a frame that the battery module 200 is mounted to (e.g., an airframe). In this regard, by each anchor-sub-arrangement (e.g., anchor sub-arrangement 2851, anchor sub-arrangement 2852, anchor sub-arrangement 2853, and/or anchor sub-arrangement 2854) including a first mounting plane (e.g., defined by a first sidewall such as sidewall 291) and a second mounting plane (e.g., defined by a second sidewall, such as lid 295 or bottom panel 296), structural criteria (e.g., low-cycle fatigue, high cycle fatigue, damage tolerance, or any other structural criteria known in the art) can be met.

In various embodiments, although described herein as including no anchors on the sidewall 293 or the sidewall 294, the present disclosure is not limited in this regard. For example, any of the anchor sub-arrangements could include an anchor coupled to the sidewall 293 or the sidewall 294 and still be within the scope of this disclosure. However, since sidewall 293 and sidewall 294 are each configured with respective fluid conduits for a thermal management system, utilizing other sidewalls for the anchor arrangement 2850 can reduce a complexity of the respective sidewalls, in accordance with various embodiments. Additionally, the potential locations for installing an anchor on the sidewall 293 or the sidewall 294 can be very limited due to the design intent of the respective fluid conduits and the space taken up in order to meet the design intent of the fluid conduits, in accordance with various embodiments.

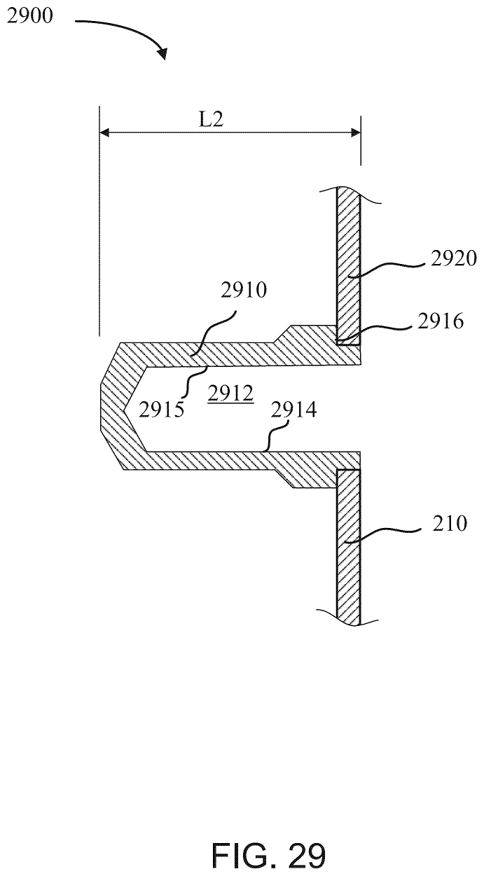

With reference now to FIG. 29, a sidewall assembly 2900 including an anchor 2910 in the plurality of anchors 2830 from FIG. 28 coupled to a sidewall 2920 (e.g., sidewall 291, sidewall 292, lid 295, or bottom panel 296) in the set of sidewalls 2860 from FIG. 28 is illustrated, in accordance with various embodiments. In various embodiments, the sidewall 2920 is formed of sheet metal and the anchor 2910 is formed via another manufacturing method (e.g., machining, additive manufacturing, or the like). In various embodiments, the anchor 2910 is formed from machining. In this regard, by having the sidewall 2920 and the anchor 2910 formed by different manufacturing methods and coupled together, the manufacturing process can be significantly faster compared to forming the anchor 2910 and sidewall 2920 as a monolithic component (e.g., via machining or additive manufacturing), in accordance with various embodiments.

In various embodiments, the anchor 2910 defines a blind aperture 2912. In this regard, the blind aperture 2912 can prevent any leakage of gases from an internal cavity of the housing 210 from FIGS. 2 and 28 during a thermal runaway event, in accordance with various embodiments. In various embodiments, the blind aperture 2912 defines an engagement portion 2914 on a radially inner wall 2915. In various embodiments the engagement portion 2914 comprises a thread (e.g., a female thread). In various embodiments, comprises a helical insert. The present disclosure is not limited in this regard.

In various embodiments, the anchor 2910 further comprises a shoulder 2916 defined at a first longitudinal end of the anchor 2910. The shoulder 2916 is configured to abut the sidewall 2920 prior to welding the sidewall 2920 to the anchor 2910 (e.g., to form a corner joint in response to the welding). In various embodiments, the anchor 2910 comprise a length L2 between 0.25 (0.635 cm) to 1 inch (2.54 cm). In this regard, by having a short length, the anchor 2910 can provide a large internal envelope for components disposed within the housing 210, in accordance with various embodiments.

In various embodiments, the blind aperture 2912 can accommodate #4-40 class 1-3 threads to ¼-20 threads. For example, the blind aperture 2912 can include a basic diameter between 0.1120 inches (0.284 cm) and 0.25 inches (0.635 cm). In this regard, a ratio of length to diameter for the anchor 2910 can be between 9:1 and 1:1, or between 5:1 and 1:1, or between 4:1 and 1:1, or between 3:1 and 1:1, or between 2:1 and 1:1, in accordance with various embodiments.

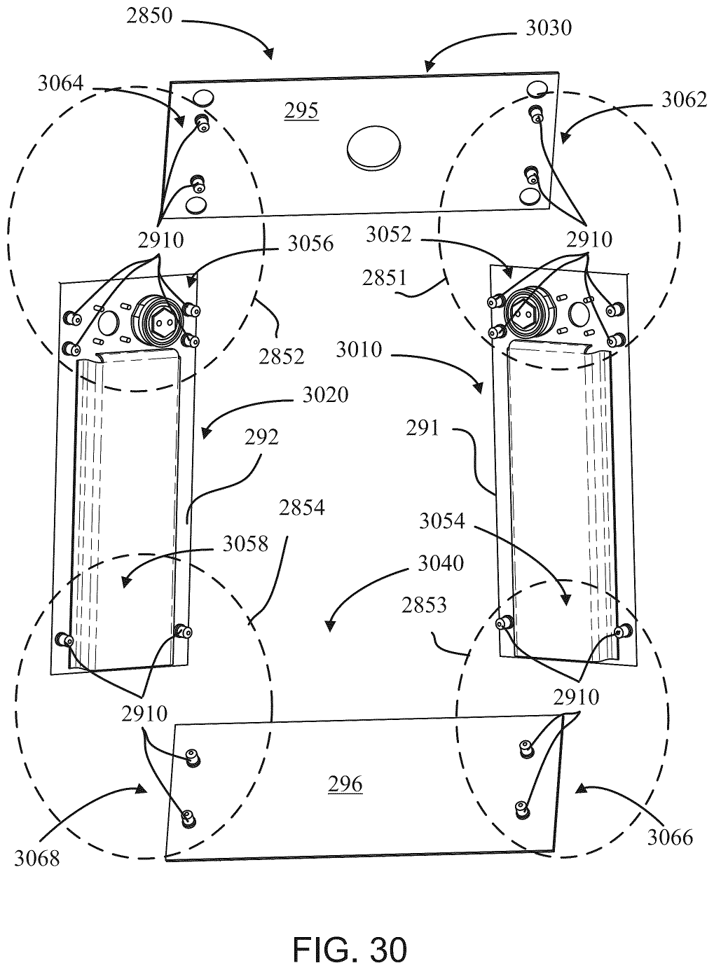

Referring to FIG. 30, a perspective view of each sidewall assembly (e.g., sidewall assembly 3010 with sidewall 291, sidewall assembly 3020 with sidewall 292, sidewall assembly 3030 with lid 295, and sidewall assembly 3040 with bottom panel 296) is illustrated, in accordance with various embodiments. Each sidewall assembly includes a portion of anchor sub-arrangement (e.g., sidewall assembly 3010 includes a portion of anchor sub-arrangement 2851 and a portion of anchor sub-arrangement 2853, sidewall assembly 3020 includes a portion of anchor sub-arrangement 2852 and a portion of anchor sub-arrangement 2854, sidewall assembly 3030 includes a portion of the anchor sub-arrangement 2851 and a portion of the anchor sub-arrangement 2852, and the sidewall assembly 3040 includes a portion of anchor sub-arrangement 2853 and a portion of anchor sub-arrangement 2854). In various embodiments, each of the anchor sub-arrangements includes at least four of the anchor 2910 from FIG. 29. Although illustrated with four anchor sub-arrangements, the present disclosure is not limited in this regard. For example, the anchor arrangement 2850 could include two of the anchor sub-arrangements (e.g., anchor sub-arrangement 2853 and anchor sub-arrangement 2854) and still be within the scope of this disclosure.

In various embodiments, each anchor sub-arrangement is configured as a mounting configuration for a bracket. For example, first 252 of the plurality of brackets 251 from FIG. 2 is configured to mount to anchor sub-arrangement 2851, second 253 of the plurality of brackets 251 from FIG. 2 is configured to mount to anchor sub-arrangement 2852, third 254 of the plurality of brackets 251 from FIG. 2 is configured to mount to anchor sub-arrangement 2853, and fourth 255 of the plurality of brackets 251 from FIG. 2 is configured to mount to anchor sub-arrangement 2854.

In various embodiments, each anchor sub-arrangement includes at least two anchors oriented in a first direction and at least two anchors oriented in a second direction, the first direction being substantially normal to a first plane defined by a first sidewall, and the second direction being substantially normal to a second plane defined by a second sidewall. In various embodiments, the first sidewall and the second sidewall are substantially perpendicular to each other.

In various embodiments, each sidewall assembly (e.g., sidewall assembly 3010, 3020, 3030, 3040) can include a first set of anchors (e.g., set of anchors 3052 for sidewall assembly 3010, set of anchors 3056 for sidewall assembly 3020, set of anchors 3062 for sidewall assembly 3030, and set of anchors 3066 for sidewall assembly 3040) and a second set of anchors (e.g., set of anchors 3054 for sidewall assembly 3010, set of anchors 3058 for sidewall assembly 3020, set of anchors 3064 for sidewall assembly 3030, and set of anchors 3068 for sidewall assembly 3040). The set of anchors 3052 for the sidewall assembly 3010 comprises at least two of the anchor 2910 and forms a portion of the anchor sub-arrangement 2851 as described previously herein. The set of anchors 3056 for the sidewall assembly 3020 comprises at least two of the anchor 2910 and forms a portion of the anchor sub-arrangement 2852 described previously herein. The set of anchors 3062 for the sidewall assembly 3030 comprises at least two of the anchor 2910 and forms a portion of the anchor sub-arrangement 2851 as described previously herein. The set of anchors 3066 for the sidewall assembly 3040 comprises at least two of the anchor 2910 and forms a portion of the anchor sub-arrangement 2853 as described previously herein. Similarly, the set of anchors 3054 for the sidewall assembly 3010 comprises at least two of the anchor 2910 and forms a portion of the anchor sub-arrangement 2851, the set of anchors 3058 for the sidewall assembly 3020 comprises at least two of the anchor 2910 and forms a portion of the anchor sub-arrangement 2854, the set of anchors 3064 for the sidewall assembly 3030 comprises at least two of the anchor 2910 and forms a portion of the anchor sub-arrangement 2852, and the set of anchors 3068 for the sidewall assembly 3040 comprises at least two of the anchor 2910 and forms a portion of the anchor sub-arrangement 2854.

For the lateral sidewalls (e.g., sidewall 291 and sidewall 292), the set of anchors 3052, 3056 can be spaced apart vertically from the set of anchors 3054, 3058 (e.g., set of anchors 3054 are spaced apart from the set of anchors 3052 in a vertical direction for sidewall 291). For the top and bottom sidewalls (e.g., lid 295 and bottom panel 296), the set of anchors 3062, 3066 can be spaced apart longitudinally from the set of anchors 3064, 3068 (e.g., set of anchors 3062 are spaced apart longitudinally from the set of anchors 3064 for the lid 295).

In various embodiments, a mounting interface for a bracket corresponds to at least two sets of anchors, where each of the two sets of anchors are coupled to different, yet adjacent sidewalls. For example, a mounting interface for the first 252 of the plurality of brackets 251 from FIG. 2 can comprise the set of anchors 3052 from sidewall assembly 3010 and the set of anchors 3062 from the sidewall assembly 3030. Similarly, a mounting interface for the second 253 of the plurality of brackets 251 from FIG. 2 can comprise the set of anchors 3056 from the sidewall assembly 3020 and the set of anchors 3064 from the sidewall assembly 3030, a mounting interface for the third 254 of the plurality of brackets 251 from FIG. 2 can comprise the set of anchors 3054 from the sidewall assembly 3010 and the set of anchors 3066 from the sidewall assembly 3040, and a mounting interface for the fourth 255 of the plurality of brackets 251 from FIG. 2 can comprise the set of anchors 3058 from the sidewall assembly 3020 and the set of anchors 3068 from the sidewall assembly 3040.

In various embodiments, one of the set of anchors for each the lateral sidewalls (e.g., sidewall 291 and sidewall 292) comprises a two row by two column arrangement of anchors. For example, set of anchors 3052 for the sidewall assembly 3010 can comprise a two row by two column arrangement of anchors and the set of anchors 3056 for the sidewall assembly 3020 can comprise a two row by two column arrangement of anchors. In this regard set of anchors 3052, 3056 can include a first row of anchors with a first of the anchor 2910 spaced apart laterally from a second of the anchor 2910 and a second row of anchors with a third of the anchor 2910 spaced apart laterally from a fourth of the anchor 2910. The first row of anchors (e.g., the first and the second of the anchor 2910) can be spaced apart vertically from the second row of anchors (e.g., the third and the fourth of the anchor 2910).

In various embodiments, a second of the set of anchors for each of the lateral sidewalls (e.g., sidewall 291 and sidewall 292) can include a first of the anchor 2910 spaced apart laterally from a second of the anchor 2910. In various embodiments, the second of the set of anchors for each of the lateral sidewalls can define a third row of anchors on the respective sidewall (e.g., sidewall assembly 3010 or sidewall assembly 3020). In various embodiments, the third row of anchors is spaced apart vertically from the second row of anchors. In various embodiments, a vertical distance between the second row of anchors and the third row of anchors is significantly greater (e.g., two times, three times, four times, or more) than a vertical distance between the first row of anchors and the second row of anchors.

Referring now to FIG. 31, an exploded perspective view of the battery module 200 from FIG. 2 with like numerals depicting like elements is illustrated, in accordance with various embodiments. In various embodiments, each of the plurality of brackets 251 (e.g., first 252, second 253, third 254, and fourth 255 of the plurality of brackets 251) are coupled to the housing 210 via a plurality of fasteners 3102. In this regard, anchor in each anchor sub-arrangement (e.g., anchor sub-arrangement 2851, 2852, 2853, 2854) from the anchor arrangement 2850 is configured to receive a corresponding fastener in the plurality of fasteners 3102. In various embodiments, the first 252 of the plurality of brackets 251 can be a mirror image of the second 253 of the plurality of brackets 251 (e.g., relative to a lateral plane X-Y through a center of the battery module 200). In various embodiments, the battery module 200 can include two of the plurality of brackets 251. Stated another way, in order to reduce a part count of the battery module 200, the plurality of brackets 251 can be used on opposite lateral sides of the battery module 200, on opposite longitudinal sides of the battery module 200, or any other combination of a less than four of the plurality of brackets 251 and would still be within the scope of this disclosure.

In various embodiments, the plurality of brackets 251 can be coupled to the housing 210 of the battery module 200 (e.g., via fasteners 3102). In this regard, each bracket in the plurality of brackets 251 (e.g., first 252, second 253, third 254, and fourth 255 of the plurality of brackets 251) is coupled to a set of anchors (e.g., anchor sub-arrangement 2851 for the first 252 of the plurality of brackets 251, anchor sub-arrangement 2852 for the second 253 of the plurality of brackets 251, anchor sub-arrangement 2853 for the third 254 of the plurality of brackets 251, and anchor sub-arrangement 2854 for the fourth 255 of the plurality of brackets 251).

In various embodiments, each of the plurality of brackets 251 includes a mounting interface configured to be coupled to a support structure (e.g., mounting interface 3112, mounting interface 3114, and/or mounting interface 3116 for the first 252 of the plurality of brackets 251, mounting interface 3122, mounting interface 3124, and/or mounting interface 3126 for the second 253 of the plurality of brackets 251, and/or mounting interface 3132, mounting interface 3134, mounting interface 3136, and/or mounting interface 3138 for each of the third 254 and the fourth 255 of the plurality of brackets 251). In various embodiments, the support structure that the brackets are configured to mount to can include an aircraft component (e.g., a spar in a wing, an airframe, or any other support structure known in the art).

In various embodiments, each of the plurality of brackets 251 includes a plurality of the nuts 3107 (e.g., a nutplate, a clinch nut, or any other nut known in the art) opposite a respective mounting interface. Each of the plurality of nuts 3107 is configured to receive a fastener to couple the respective bracket to the support structure. In this regard, each of the plurality of nuts 3107 can include a threaded portion, such as a female thread, in accordance with various embodiments. In various embodiments, the nut 3107 can be coupled to the bracket by any method, such as riveting, welding, or any other method fastening a nut to a bracket known in the art. In various embodiments, each mounting interface described herein includes one or more of the plurality of nuts 3107. In various embodiments, some of the mounting interfaces disclosed herein can have two of the plurality of nuts 3107. In various embodiments, each of the mounting interfaces has two of the plurality of nuts 3107 with the exception of the mounting interface 3134, 3136 of the third 254 and fourth 255 of the plurality of brackets 251, which each may only have one of the plurality of nuts 3107 corresponding thereto.

In various embodiments, each of the plurality of brackets 251 is coupled to a respective set of anchors as described previously herein. In various embodiments, each of the plurality of brackets 251 is configured to provide a secondary ingress protection for the battery module 200 (i.e., to protect the interior of the housing 210 from intrusion of objects, water, dust, or any other foreign object).

In various embodiments, the first 252 and the second 253 of the plurality of brackets 251 can each comprises a label (e.g., label 3111 for the first 252 of the plurality of brackets 251) for the first electrical connector (e.g., electrical connector 281) to indicate whether the first electrical connector 281 is a positive terminal or a negative terminal. In various embodiments, the set of anchors for coupling a bracket proximate the electrical terminals (e.g., for the first 252 of the plurality of brackets 251 and the second 253 of the plurality of brackets 251) include at least two anchors coupled to the first lateral sidewall (e.g., sidewall 291 or sidewall 292) and at least two anchors coupled to the top sidewall (e.g., lid 295).

In various embodiments, each of the plurality of brackets 251 comprises a main flange configured to interface with the first lateral sidewall (e.g., sidewall 291 or sidewall 292), a secondary flange configured to interface with the top sidewall (e.g., lid 295) or the bottom sidewall (e.g., bottom panel 296), and at least one wing defining a first mounting interface (e.g., configured to interface with an airframe or any other support structure). For example, the second 253 of the plurality of brackets 251 comprises a main flange 3121, a secondary flange 3123, a first wing 3125, and a second wing 3127. The main flange 3121 and the secondary flange 3123 are configured to interface with the housing 210 and be coupled thereto, in accordance with various embodiments. In various embodiments, the second wing 3127 can be disposed laterally opposite the first wing 3125. The first wing 3125 can define the mounting interface 3122, and the second wing 3127 can define the mounting interface 3126. In various embodiments, the secondary flange 3123 can extend laterally outward from the housing 210 and define the mounting interface 3124.

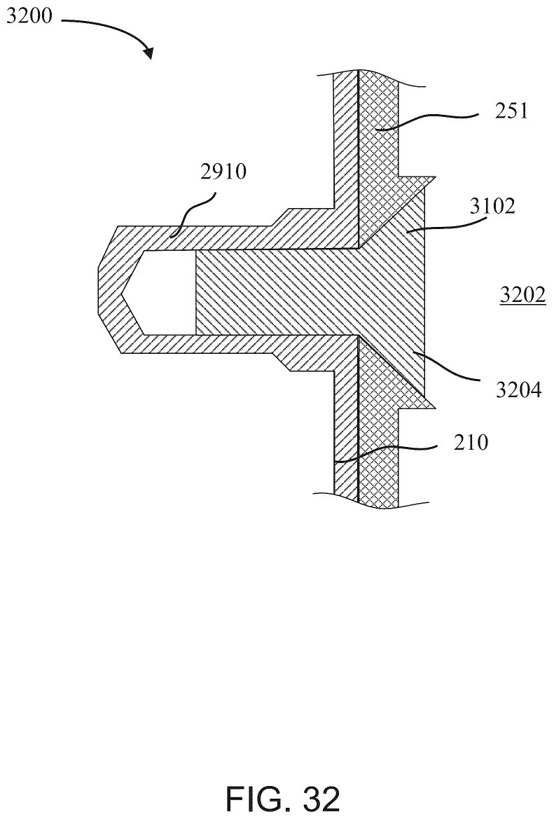

Referring now to FIG. 32, a cross-sectional view of a coupling arrangement 3200 between one of the plurality of brackets 251 and the housing 210 is illustrated, in accordance with various embodiments. In various embodiments, the coupling arrangement 3200 can be light and low profile-relative to typical coupling arrangements. Furthermore, as described previously herein, the coupling arrangement 3200 can provide (1) mounting location for the core of the battery module 200 to transmit battery inertial loads from the housing 210 of the battery module 200 into a respective frame (e.g., an airframe of an aircraft 100 from FIG. 1); (2) ingress seal protection of the plurality of cells 222 from FIG. 2 from an external environment 3202; and (3) module level thermal runaway sealing for containment (i.e., no ejecta or debris escapes through the housing 210 from FIG. 2 via a respective anchor). In various embodiments, by combining these three functions into a single component (e.g., the anchor 2910), a reduction in battery mass is obtained, which can be a significant factor for aeronautical applications, and/or optionality for installation can be achieved (i.e., various mounting orientations can be achieved).

In various embodiments, a first 3204 of the plurality of fasteners 3102 is coupled to the anchor 2910 (e.g., via a threaded engagement). In this regard, the first 3204 of the plurality of fasteners 3102 generates a compressive force between a respective sidewall of the housing 210 (e.g., sidewall 291, sidewall 292, lid 295, or bottom panel 296) and the respective bracket of the plurality of brackets 251 (e.g., the first 252, the second 253, the third 254, or the fourth 255 of the plurality of brackets 251 from FIG. 31).

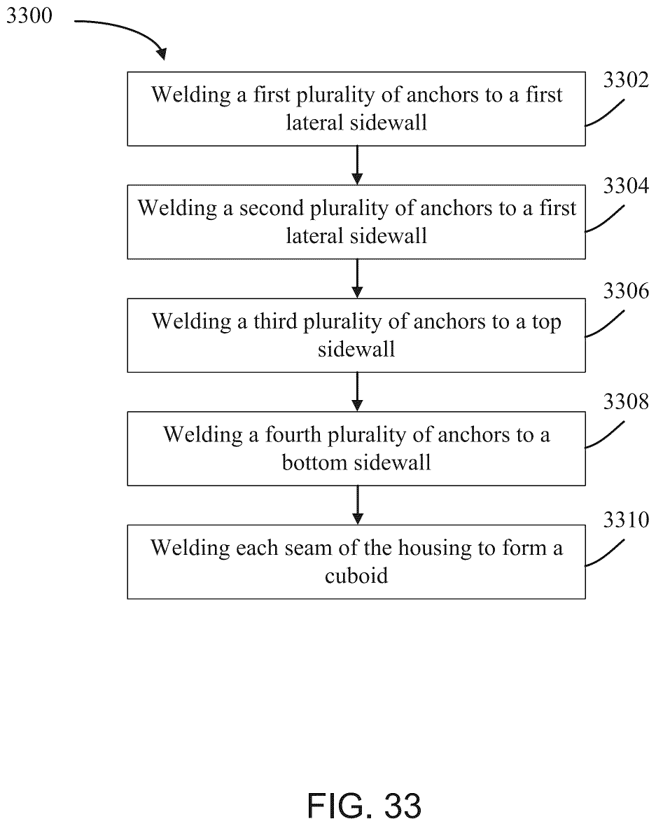

Referring now to FIGS. 28 and 33, a method 3300 (FIG. 33) of manufacturing a housing 210 for a battery module 200 in FIG. 28, is illustrated, in accordance with various embodiments. The method 3300 comprises welding a first plurality anchors (e.g., a set or sub-arrangement of the plurality of anchors 2830) to a first lateral sidewall (e.g., sidewall 291) (step 3302), welding a second plurality of anchors (e.g., a set or sub-arrangement the plurality of anchors 2830) to a second lateral sidewall (e.g., sidewall 292) (step 3304), welding a third plurality of anchors (e.g., a set or a sub-arrangement of the plurality of anchors 2830) to a top sidewall (e.g., lid 295) (step 3306), welding a fourth plurality of anchors (e.g., a set or a sub-arrangement of the plurality of anchors 2830) to a bottom sidewall (e.g., bottom panel 296) (step 3308), and welding each seam between adjacent sidewalls of the housing to form a generally cuboid shape, the housing 210 defining a battery containment structure (step 3310).

In various embodiments, welding each seam includes welding a seam between a first broad sidewall (e.g., sidewall 293) and the first lateral sidewall (e.g., sidewall 291), the second lateral sidewall (e.g., sidewall 292), the top sidewall (e.g., lid 295) and the bottom sidewall (e.g., bottom panel 296) on a first lateral side (e.g., a positive X side), and welding a seam between a second broad sidewall (e.g., sidewall 294 spaced apart laterally (i.e., in the negative X-direction) from the first broad sidewall) and the first lateral sidewall (e.g., sidewall 291), the second lateral sidewall (e.g., sidewall 292), the top sidewall (e.g., lid 295) and the bottom sidewall (e.g., bottom panel 296) on a second lateral side (e.g., the negative X side). In various embodiments, the first lateral sidewall, the second lateral sidewall, the top sidewall, and the bottom sidewall are each made of one of titanium or a titanium alloy. In various embodiments, the first lateral sidewall, the second lateral sidewall, the top sidewall, and the bottom sidewall are each comprise a flat plate.

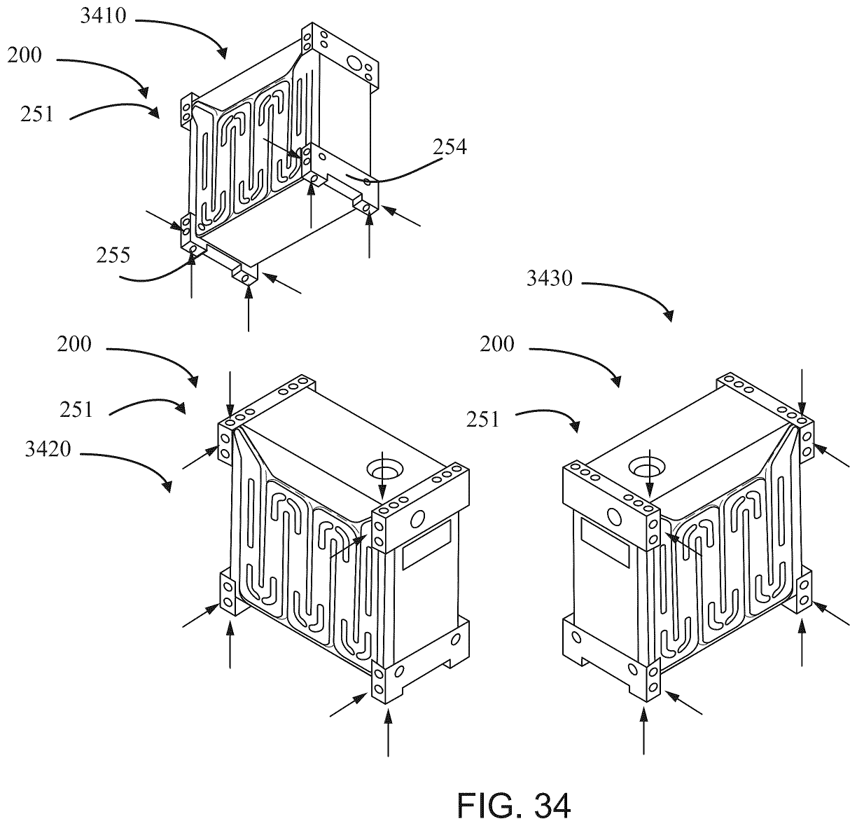

Referring now to FIG. 34, three separate mounting arrangements of the battery module 200 from FIG. 31 to a respective support structure (e.g., an airframe of an aircraft 100 from FIG. 1) is illustrated with like numerals depicting like elements, in accordance with various embodiments. In various embodiments, the plurality of brackets 251 can provide various potential options for mounting the battery module 200 to a respective support structure.

For example, the mounting arrangement 3410 could utilize only the third 254 and the fourth 255 of the plurality of brackets 251. The mounting arrangement 3420 could utilize each of the plurality of brackets 251 on a first lateral side. The mounting arrangement 3430 could utilize all the plurality of brackets 251 on n opposite lateral side relative to the mounting arrangement 3420. In various embodiments the mounting arrangements 3410, 3420, 3430 are meant to show the flexibility that the battery module 200 offers to an airframer for mounting the respective battery module 200 thereto and is not limited to the specific arrangement shown in FIG. 34.

With combined reference now to FIGS. 28, 29, 30, 31, 32, and 34, disclosed herein is a battery module 200. The battery module 200 can be configured to (1) provide mounting locations for the core of the battery module 200 transmitting battery inertial loads into a respective frame (e.g., an airframe of an aircraft 100 from FIG. 1); (2) provide ingress seal protection of the plurality of cells 222 from FIG. 2 from an external environment; and (3) provide module level thermal runaway sealing for containment (i.e., no ejecta or debris escapes through the housing 210 from FIG. 2 via a respective anchor) via an anchor arrangement 2850. In this regard, the battery module 200 disclosed herein comprises a metal housing (e.g., housing 210) including a plurality of sidewalls (e.g., sidewalls 291, 292, 293, 294, lid 295 and bottom panel 296) forming a generally cuboid shape. The battery module can further comprise a plurality of metal anchors (e.g., a plurality of the anchor 2910) forming an anchor arrangement (e.g., anchor arrangement 2850) for the metal housing (e.g., housing 210), each of the plurality of metal anchors fused to a sidewall (e.g., via welding, brazing, or any other fusion technique known in the art) in the plurality of sidewalls, each of the plurality of metal anchors defining a blind aperture (e.g., blind aperture 2912). In various embodiments, the anchor arrangement comprises a first anchor sub arrangement (e.g., any of anchor sub-arrangement 2851, 2852, 2853, 2854) and a second anchor sub-arrangement (e.g., another of anchor sub-arrangement 2851, 2852, 2853, 2854). The first anchor sub-arrangement can include a first set of the plurality of metal anchors coupled to a first of the plurality of sidewalls and a second set of the plurality of metal anchors coupled to a second of the plurality of sidewalls. In various embodiments, the second anchor sub-arrangement includes a third set of the plurality of metal anchors coupled to the first of the plurality of sidewalls and a fourth set of the plurality of metal anchors coupled to a third of the plurality of sidewalls. The battery module 200 comprises a plurality of cells disposed within the metal housing (e.g., the plurality of cells 222 from FIG. 2).

In various embodiments, the battery module 200 with a multi-purpose anchor arrangement (e.g., anchor arrangement 2850) further comprises: the plurality of sidewalls including a first broad sidewall, a second broad sidewall, a first lateral sidewall, a second lateral sidewall, a top sidewall, and a bottom sidewall, the first of the plurality of sidewalls is one of the first lateral sidewall, the second lateral sidewall, the top sidewall and the bottom sidewall, the second of the plurality of sidewalls is adjacent to the first of the plurality of sidewalls and is another of the first lateral sidewall, the second lateral sidewall, the top sidewall, and the bottom sidewall relative to the first of the plurality of sidewalls, and the third of the plurality of sidewalls is adjacent to the first of the plurality of sidewalls, spaced apart from the second of the plurality of sidewalls, and another of the first lateral sidewall, the second lateral sidewall, the top sidewall, and the bottom sidewall relative to the first of the plurality of sidewalls and the second of the plurality of sidewalls.

In various embodiments, the battery module 200 with a multi-purpose anchor arrangement (e.g., anchor arrangement 2850) further comprises a first bracket mounted to each of the first set of the plurality of metal anchors and the second set of the plurality of metal anchors, and a second bracket mounted to each of the third set of the plurality of metal anchors and the fourth set of the plurality of metal anchors. the first bracket and the second bracket each comprise a first flange mated to the first of the plurality of sidewalls, a second flange mated to either the second of the plurality of sidewalls or the third of the plurality of sidewalls, and a third flange spaced apart from one of the first broad sidewall or the second broad sidewall. In various embodiments, the first bracket and the second bracket each comprise a fourth flange spaced apart from another of the first broad sidewall or the second broad sidewall. In various embodiments, the first bracket and the second bracket each comprise a first attachment aperture and a second attachment aperture. In various embodiments, the first attachment aperture is disposed through one of the first flange or the second flange, and the second attachment aperture is disposed through the third flange. In various embodiments, the first attachment aperture and the second attachment aperture for each of the first bracket and the second bracket comprises a nut configured to receive a fastener. In various embodiments, the first flange defines a first plane, the second flange defines a second plane, and the third flange defines a third plane. In various embodiments, the first plane, the second plane, and the third plane are each substantially perpendicular to one another.

In various embodiments, the first set, the second set, the third set, and the fourth set of the plurality of metal anchors each comprise at least two metal anchors.

In various embodiments, each of the first set, the second set, the third set, and the fourth set of the plurality of metal anchors include a first metal anchor spaced apart laterally from a second metal anchor. In various embodiments, the first metal anchor and the second metal anchor for each of the first set, the second set, the third set, and the fourth set of the plurality of metal anchors are spaced apart substantially equidistant from an edge defined by adjacent sidewalls of the first anchor sub-arrangement or the second anchor sub-arrangement respectively.

In various embodiments, the anchor arrangement further comprises: a third anchor sub-arrangement including a fifth set of the plurality of metal anchors coupled to the second of the plurality of sidewalls and a sixth set of the plurality of metal anchors coupled to a fourth of the plurality of sidewalls; and a fourth anchor sub-arrangement including a seventh set of the plurality of metal anchors coupled to the third of the plurality of sidewalls and an eighth set of the plurality of metal anchors coupled to the fourth of the plurality of sidewalls.

In various embodiments, the first of the plurality of sidewalls, the second of the plurality of sidewalls, the third of the plurality of sidewalls, and the fourth of the plurality of sidewalls each comprise an outer surface relative to an interior of the metal housing. In various embodiments, the outer surface of the first of the plurality of sidewalls defines a first plane that is substantially parallel to a second plane that is defined by the outer surface of the fourth of the plurality of sidewalls. In various embodiments, the outer surface of the second of the plurality of sidewalls defines a third plane that is substantially parallel to a fourth plane that is defined by the outer surface of the third of the plurality of sidewalls. In various embodiments, the first plane is substantially perpendicular to each of the third plane and the fourth plane.

In various embodiments, the battery module 200 with a multi-purpose anchor arrangement (e.g., anchor arrangement 2850) further comprises a first bracket coupled to the first set and the second set of the plurality of metal anchors; a second bracket coupled to the third set and the fourth set of the plurality of metal anchors; a third bracket coupled to the fifth set and the sixth set of the plurality of metal anchors; and a fourth bracket coupled to the seventh set and the eighth set of the plurality of metal anchors.

In various embodiments, the battery module 200 with a multi-purpose anchor arrangement (e.g., anchor arrangement 2850) further comprises a mounting arrangement defined by at least two brackets from the first bracket, the second bracket, the third bracket, and the fourth bracket, wherein the mounting arrangement comprises: a first mounting plane defined by a first mounting aperture, a second mounting aperture, and a third mounting aperture from the at least two brackets, a fourth mounting aperture from the at least two brackets is within the first mounting plane, a second mounting plane defined by a fifth mounting aperture and a sixth mounting aperture from the at least two brackets, and a normal direction that is substantially parallel to the first mounting plane, and a third mounting plane that is substantially parallel to the second mounting plane and spaced apart in the normal direction from the second mounting plane, the third mounting plane including a seventh mounting aperture and an eighth mounting aperture from the at least two brackets.

In various embodiments, a battery system (e.g., battery system 150 or battery system 160 from FIG. 1), comprises a plurality of the battery module 200 with the multi-purpose anchor arrangement (e.g., anchor arrangement 2850), wherein a row of the plurality of the battery module are configured to be mounted along the first mounting plane (e.g., a broad side plane, a bottom side plane, or a top side plane as shown in FIG. 34).

In various embodiments, an electrically powered aircraft (e.g., aircraft 100 from FIG. 1) comprises the battery system, the electrically-powered aircraft comprising an airframe, wherein a module-to-airframe interface between a first of the plurality of the battery module and the airframe is defined by the first mounting plane.

In various embodiments, the row of the plurality of the battery module each have mounting interfaces with the airframe that are each within the first mounting plane, the second mounting plane, and the third mounting plane.

In various embodiments, the electrically powered aircraft further comprises an electric motor, the battery system configured to power the electric motor.

In various embodiments, the plurality of sidewalls and the plurality of metal anchors are all made of one of a titanium alloy or pure titanium.

In various embodiments, the blind aperture for each of the plurality of metal anchors is threaded.

In various embodiments, each of the plurality of metal anchors comprises a length between 0.25 (0.635 cm) to 1 inch (2.54 cm).

Short and Long Vent tube Arrangements for the Battery Systems

Referring back to FIG. 15, each of the plurality of battery modules 1505 in the battery system can comprise a local vent 180 (e.g., a tube assembly 181 including a tube 182 extending from a first longitudinal end to a second longitudinal end and defining a longitudinal axis and a fitting 184 extending radially outward from the longitudinal axis). The fitting 184 can be coupled to the tube 182 (e.g., via welding, brazing, or any other coupling method known in the art). In various embodiments, the fitting 184 is welded to the tube 182.

In various embodiments, by having a local vent 180 for each of the plurality of battery modules 1505 and a coupler 190 that couples adjacent vents (e.g., local vent 180 of the first 1510 of the battery module 200 to the local vent 180 of the second 1520 of the battery module 200), the exhaust system 1580 can structurally protect a remaining of the plurality of battery modules 1505 from one of the plurality of battery modules 1505 that has a cell that enters thermal runaway, where the thermal runaway event propagates to adjacent cells (e.g., in the plurality of cells 222 from FIG. 2 for a respective battery module 200). For example, in response to a cell in the first 1510 of the plurality of battery modules 1505 entering thermal runaway, the event will propagate to the remaining cells in the first 1510 of the plurality of battery modules 1505. Due to the propagation, within the battery module, the thermal runaway event will intensify and cause ejecta and gases to be exhausted out the local vent 180. The local vent 180 of the first 1510 of the plurality of battery modules 1505 will be experiencing significantly higher temperatures relative to the local vent 180 of the second 1520 of the plurality of battery modules 1505. If the local vent 180 of the first 1510 of the plurality of battery modules 1505 and the local vent 180 of the second 1520 of the plurality of battery modules were made from a single tube, the temperature gradient would cause the interface between the local vent 180 of the second 1520 of the plurality of battery modules 1505 to expand significantly more relative to the vent port of the second 1520 of the plurality of battery modules 1505, which could potentially cause structural issues for the second 1520 of the plurality of battery modules 1505.

In various embodiments, the coupler 190 allows for the thermal expansion of the local vent 180 of the respective battery that is entering thermal runaway to naturally expand from the event without affecting the structural condition of adjacent battery modules in the battery system 1500, in accordance with various embodiments.

The local vent 180 is configured to be in fluid communication with a cavity defined by the housing 210 of a respective battery module (e.g., first 1510 and second 1520 of the plurality of battery modules 1505) during a thermal runaway event. In various embodiments, the fluid communication between the cavity defined by the housing 210 and the local vent 180 can occur due to the thermal runaway event or exist prior to the thermal runaway event. The present disclosure is not limited in this regard. In various embodiments, each local vent 180 is coupled to an adjacent vent via a coupler 190 (e.g., a polymeric coupler with a metallic hose clamp as described further herein) configured to couple one local vent 180 to an adjacent vent tube (e.g., in accordance with local vent 180). In this regard, the battery system 1500 can comprise a venting structure that includes a plurality of the local vent 180 coupled together to form a single venting channel for a row of battery modules (e.g., the first 1510, the second 1520, and so on of the plurality of battery modules 1505). However, as described further herein, various venting configurations are within the scope of this disclosure. In various embodiments, the coupler 190 can accommodate misalignment between adjacent tube assemblies due to having a flexible material (e.g., a polymeric material) and manage high-temperatures (e.g., temperatures in excess of 2,000 deg F. (1,093 deg C.)).

In various embodiments, the fitting 184 is configured to interface with the vent port 230 described previously herein. In this regard, the fitting 184 can include a male thread configured to engage the threaded portion 234 of the vent port 230 described previously herein. Although described herein as the fitting 184 including the male thread and the vent port 230 including the female thread, the present disclosure is not limited in this regard. For example, the vent port 230 can include a male thread and the fitting 184 can include a female thread and would still be within the scope of this disclosure. However, by having the vent port 230 with a female thread, the vent port 230 can encompass a smaller envelope relative to providing the vent port 230 with a male thread, in accordance with various embodiments.

For example, with reference now to FIG. 22, a cross-sectional view of an interface 175 (e.g., a threaded interface) between the vent port 230 and the fitting 184 is illustrated, in accordance with various embodiments. In various embodiments, the fitting 184 is coupled to the tube 182 of the tube assembly 181 via welding or the like. In this regard, the tube 182 can include a cutout 185 having a complementary shape to a first longitudinal end 183 of the fitting 184. The fitting 184 extends from a first longitudinal end 183 to a second longitudinal end 187. In various embodiments, the fitting 184 includes a threaded portion 188 disposed on a radially outer surface 189 of the fitting. The threaded portion 188 can include a male thread configured to engage the threaded portion 234 of the vent port 230.

The threaded portion for each the vent port 230 and the fitting 184 (e.g., threaded portion 188 of the fitting and threaded portion 234 of the vent port) includes a pitch diameter to thread pitch ratio that is greater than 30:1, or between 30:1 and 60:1, or approximately 42:1. Typical standard pitch diameter to thread ratios for standard threads are between 3:1 and 15:1. Pitch diameter to thread pitch ratios as provided herein are significantly greater than typical standards, which increases manufacturing costs, often utilizes custom tooling for inspection, and reduces pressure capability of the interface. However, by utilizing the pitch diameter to thread pitch ratio disclosed herein, the port interface of the vent port 230 is configured to provide a large throat area (i.e., a large diameter aperture) to facilitate exhausting debris in response to a thermal runaway event of a cell within the housing 210 and/or facilitate self-sealing of the interface during the thermal runaway event to prevent gases from escaping the exhaust system, in accordance with various embodiments. In various embodiments, the pitch diameter to thread ratio provided herein can be further facilitated by the low-pressure environment of the interface of the vent port 230. For example, during operation, the vent port 230 is exposed to little to no pressure, and even during a thermal runaway event, the vent port 230 is exposed to a small amount of pressure (e.g., less than 10 psi). In this regard, although the interface may have reduced pressure capability from the large pitch diameter to thread ratio, the interface may still meet a design intent, in accordance with various embodiments.

In various embodiments, the fitting 184 is made of a first material, the vent port 230 is made of a second material, and the first material is different from the second material. For example, the first material can include a first metal or metal alloy (e.g., stainless steel) and the second material can include a second metal or metal alloy (e.g., titanium). In various embodiments, the interface L3 between the fitting 184 and the vent port 230 can be configured to self-seal in response to a temperature exceeding a threshold temperature (e.g., an environment exceeding 400 deg F. (or 204 deg C.)). In this regard, heat in a cavity of the housing 210 of the battery module 200 can exceed 400 deg F. (or 204 deg C.) in response to a cell disposed in the housing 210 entering thermal runaway. During thermal runaway, it is desirable to contain gases that are emitted within the exhaust system. In this regard, by having the interface L3 configured to self-seal, gases that are emitted during thermal runaway can be contained within the exhaust system, in accordance with various embodiments. The self-sealing can occur at least in part due to the thermal expansion being different between the materials and the large pitch diameter to thread ratio described previously herein.

In various embodiments, the tube assembly 181 of the local vent 180 comprises the tube 182 extending from a first longitudinal end 172 to a second longitudinal end 174, the tube defining a first longitudinal axis B-B′; and a fitting 184 coupled to the tube 182, the fitting defining a second longitudinal axis B-B′, the second longitudinal axis B-B′ substantially perpendicular to the first longitudinal axis B-B′, the fitting 184 defining a radially inner surface 179 and a radially outer surface 189, the radially outer surface 189 including a threaded portion 188, the threaded portion having a pitch diameter to thread pitch ratio that is greater than 30:1. In various embodiments, substantially perpendicular, as referred to herein, is plus or minus 10 degrees from perpendicular, or plus or minus 5 degrees from perpendicular.

In various embodiments, the coupler 190 includes a coupler body 191, a first hose clamp 194 and a second hose clamp 380. The coupler body 191 includes a first radial flange 192 disposed at a first longitudinal end and a second radial flange 196 disposed at a second longitudinal end, and a main body 193 extending therebetween. In various embodiments, the first hose clamp 194 is configured to couple the first longitudinal end of the coupler body 191 to the tube assembly 181. Similarly, the second hose clamp 195 is configured to couple the second longitudinal end of the coupler body 191 to an adjacent tube assembly (e.g., an adjacent tube assembly in accordance with the tube assembly 181 or different from the tube assembly 181). In this regard, the first hose clamp 194 can secure the coupler body 191 in a radial direction by a clamping force in the radial direction between the coupler body 191 and the tube 182. In various embodiments, the first hose clamp 194, the second hose clamp 380, the first radial flange 192, and the second radial flange 196 can be configured to retain the coupler body 191 axially in response to being installed. In various embodiments, the coupler body 191 is made of a polymeric material that is configured for fifteen (15) minutes of direct contact with a 2000° F. (1093.3° C.) flame with no backside penetration (e.g., Rishon® material sold by RCF Technologies, headquartered in Vidalia, Georgia). In this regard, the polymeric material can withstand high-temperatures, and provide flexibility to accommodate misalignment between adjacent tube assemblies in an exhaust system as described further herein.

In various embodiments, the vent port 230 also defines a longitudinal axis. In this regard, the second longitudinal axis B-B′ of the fitting 184 also defines the longitudinal axis of the vent port 230. In various embodiments, the longitudinal axis of the vent port 230 (e.g., longitudinal axis B-B′) is offset from a lateral plane P2 (i.e., an X-Y plane) by a distance D2. In various embodiments, D2 is between 15% and 35% of a longitudinal length L1 of the housing 210, or between 20% and 30% of the longitudinal length L1, or approximately 25% of the longitudinal length L1. In various embodiments, as described further herein, by having the vent port 230 offset from the central lateral plane P2 of the housing 210, an exhaust system can be reconfigurable in various configurations.

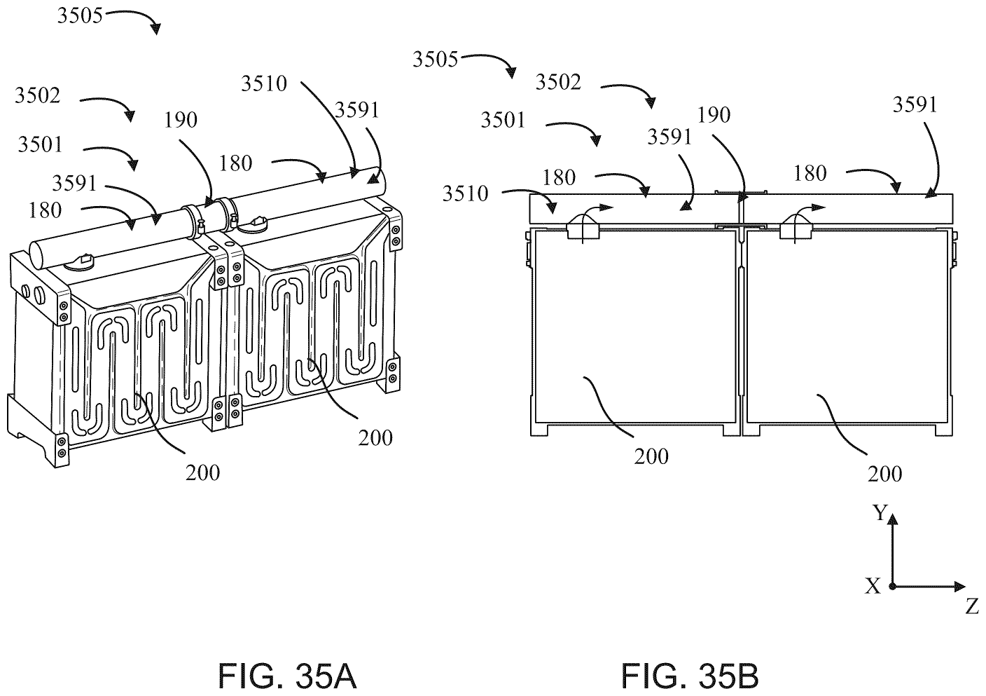

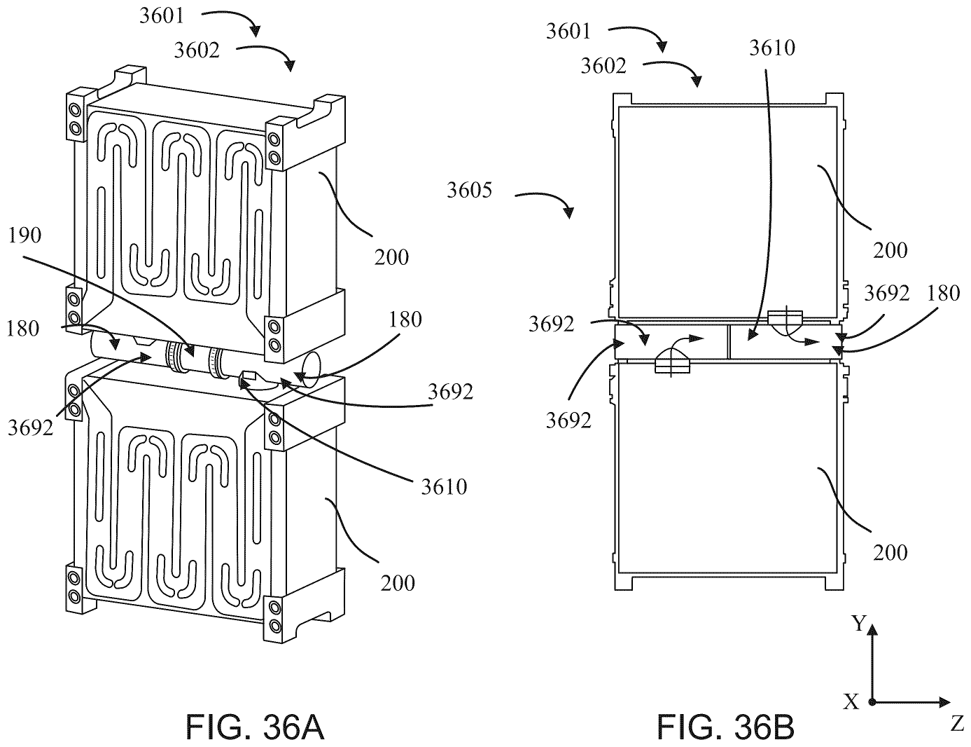

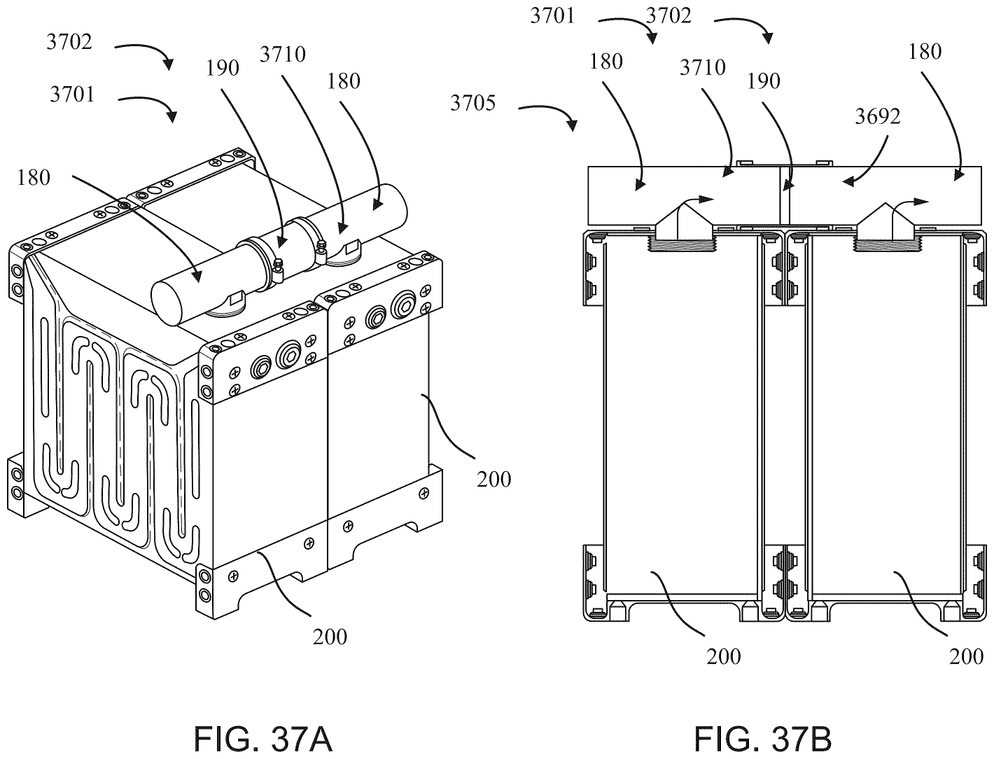

For example, with reference now to FIGS. 35A, 35B, 36A, 36B, 37A, and 37B, a portion of an exhaust system (e.g., exhaust system 3501 in FIGS. 35A-B, exhaust system 3601 in FIGS. 36A-B, and exhaust system 3701 in FIGS. 37A-6B) for a battery system having a plurality of the battery module 200 in various configurations (i.e., configurations 3502, 3602, 3702). In various embodiments, each exhaust system includes a vent tube (e.g., local vent 180 in exhaust system 3501 and vent tube 400 in exhaust systems 3601, 3701) for each battery module 200.

In various embodiments, the local vent 180 for the long tube configuration 3502 from FIGS. 35A-B can have a tube 182 that has a length that is longer than a tube 182 of the local vent 180 for the short tube configurations 3602, 3702 from FIGS. 36A-B and 37A-6B. In this regard, the local vent 180 from FIGS. 35A-B is a long tube assembly 3591 relative to the local vent 180 from FIGS. 36A-B and 37A-B, which is a short tube assembly 3692. The long tube configuration 3502 can facilitate a venting configuration that has gang vents along a longitudinal direction (i.e., a Z-direction) of the battery system 3505 (e.g., common vent 3510).

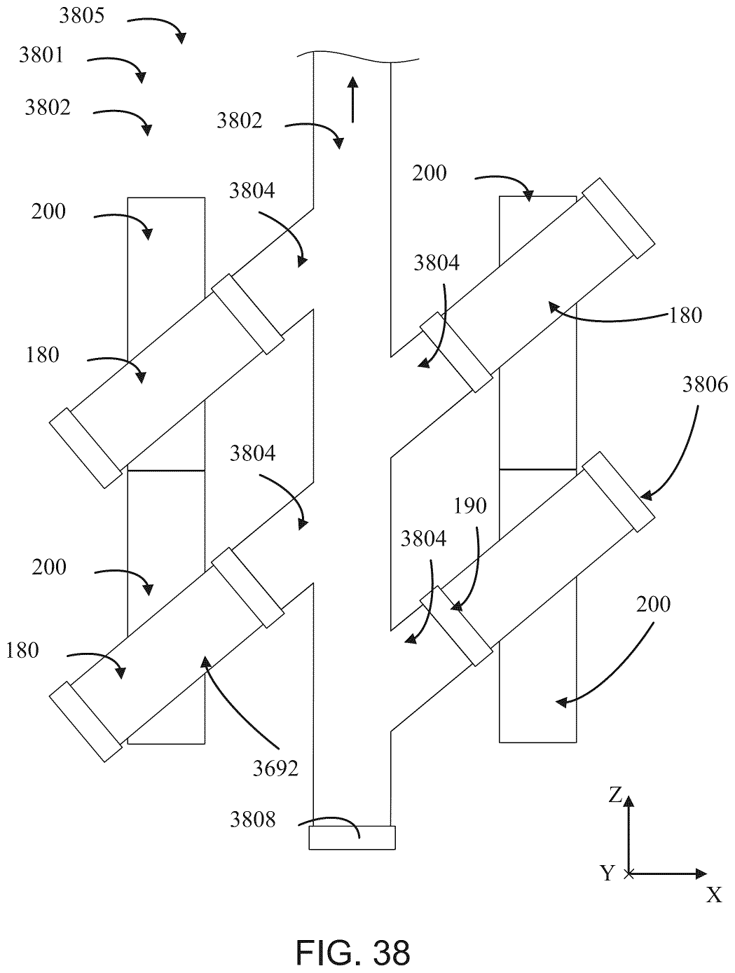

The short tube configurations can be significantly more adaptable compared to the long tube configuration 3502. For example, the short vent tubes as shown in FIGS. 36A-B and 37A-6B can facilitate a common vent 3610 vertically between adjacent battery modules 200 (e.g., as shown in FIGS. 36A-B) in a longitudinal direction (i.e., a Z-direction), or a common vent 3710 laterally (i.e., in a X-direction) between adjacent, non-electrically connected (at least directly), battery modules 200, or the like. In various embodiments, with reference now to FIG. 38, the short tube assembly 3692 can further be configured at an angle relative to a central longitudinal common vent 3802 with a plurality of branches 3804, each branch in the plurality of branches extending at a complementary angle relative to the short tube assembly 3692 and configured to be coupled to the short tube assembly 3692 (e.g., via the coupler 190). In various embodiments, each short tube assembly 3692 can be capped at an opposite longitudinal end relative to the coupler 190 (e.g., via a cap 3806). Similarly, in various embodiments with brief reference to FIG. 38, one end of the common vent 3802 (e.g., a common manifold) cab comprise a cap 3808. In this regard, any exhaust that is emitted from one of the battery module 200 in the debris and/or ejecta only have one direction to go (i.e., toward the common outlet). In various embodiments, for the tube configurations of FIGS. 35A-B, 36A-B, 37A-B, one end of a row of tubes can be capped (e.g., via a cap 3806 as shown in FIG. 38) and the other end of the row of tubes can connect to a common outlet manifold, or exhaust directly to the external environment. The present disclosure is not limited in this regard.

With reference now to FIGS. 35A-B, 36A-B, 37A-B, and 38, an exhaust system (e.g., exhaust system 3501, 3601, 3701, 3801) for a battery system having a plurality of the battery module 200 is disclosed herein. The exhaust system includes a plurality of tube assemblies (e.g., a plurality of the short tube assembly 3692 or a plurality of the long tube assembly 3591) and a coupler 190. Each tube assembly in the plurality of tube assemblies is in accordance with the tube assembly 181 described in FIG. 22 previously herein.

In various embodiments, each tube assembly in the plurality of tube assemblies includes a tube and a fitting coupled to the tube, the tube extending from a first longitudinal end to a second longitudinal end, the fitting coupled to the tube and extending in a direction radially outward from the tube, the fitting including a threaded portion having a pitch diameter to thread pitch ratio that is greater than 30:1.

In various embodiments, the coupler 190 is coupled to the first longitudinal end of a first tube assembly in the plurality of tube assemblies and the second longitudinal end of a second tube assembly in the plurality of tube assemblies, the first tube assembly, the second tube assembly, and the coupler defining a portion of a common vent.

In various embodiments, the exhaust system further comprises a plurality of the coupler, wherein each tube assembly in the plurality of tube assemblies is coupled to an adjacent tube assembly in the plurality of tube assemblies by a respective coupler in the plurality of the coupler.

In various embodiments, the fitting of the first tube assembly defines a first port oriented in a first direction, and the fitting of the second tube assembly defines a second port oriented in a second direction.

In various embodiments, the first direction is approximately 180 degrees relative to the second direction (e.g., 180 degrees plus or minus 5 degrees).

In various embodiments, the first direction is a same direction as the second direction relative to a longitudinal axis defined by the tube.

With continued reference to FIGS., 35A-B, 36A-B, 37A-B, and 38, a battery system (e.g., battery system 3505, 3605, 3705, 3805) having a plurality of the battery module 200 is disclosed herein. The battery system includes a plurality of tube assemblies (e.g., a plurality of the short tube assembly 3692 or a plurality of the long tube assembly 3591), a coupler 190, and a plurality of the battery module 200. Each tube assembly in the plurality of tube assemblies is in accordance with the tube assembly 181 described in FIG. 22 previously herein.

In various embodiments, the battery systems disclosed herein comprise: a plurality of battery modules, each battery module including a vent port; and an exhaust system for the battery system, the exhaust system including a plurality of tube assemblies, each tube assembly including a tube and a fitting coupled to the tube, the tube extending from a first longitudinal end to a second longitudinal end, the fitting coupled to the tube and extending in a direction radially outward from the tube, the fitting of each tube assembly coupled to the vent port of a respective battery module in the plurality of battery modules.

In various embodiments, each battery module includes a housing defining a longitudinal direction, a lateral direction and a vertical direction, the vent port disposed in a top wall of the housing.

In various embodiments, a first tube assembly in the plurality of tube assemblies is coupled to the vent port of a first battery module in the plurality of battery modules, a second tube assembly in the plurality of tube assemblies is coupled to the vent port of a second battery module in the plurality of battery modules, and the first tube assembly is coupled to the second tube assembly by a coupler.

In various embodiments, the first tube assembly and the second tube assembly are disposed between the top wall of the housing of the first battery module and the top wall of the housing of the second battery module.

In various embodiments, a first direction defined by a first port of the fitting of the first battery module is approximately 180 degrees relative to a second direction defined by a second port of the fitting of the second battery module.

In various embodiments, the tube of the first tube assembly and the second tube assembly are co-axial.

In various embodiments, an axis of the tube of the first tube assembly and the second tube assembly is parallel to the longitudinal direction.

In various embodiments, an axis of the tube of the first tube assembly and the second tube assembly is parallel to the lateral direction.

In various embodiments, the coupler includes a polymeric material.

In various embodiments, the first tube assembly is coupled to a first port of a common vent tube, and the second tube assembly is coupled to a second port of the common vent tube.

### System Level Embodiments for the Battery System

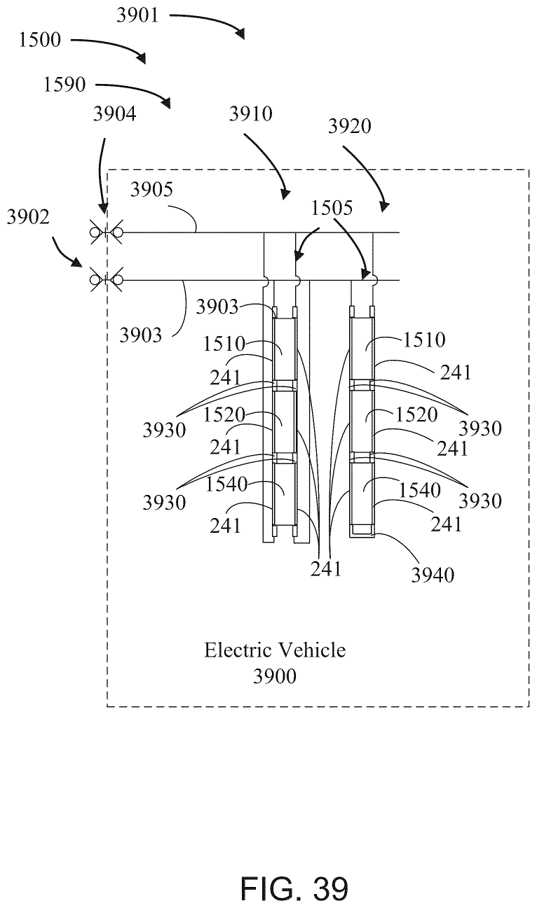

With reference now to FIG. 39 various potential system level embodiments for the plumbing system 1590 of the battery system 1500 described previously herein are illustrated with like numerals depicting like elements, in accordance with various embodiments. For example, the plumbing system 3901 comprises an inlet port 3902 (e.g., a quick disconnect fitting, a coupler, an adapter, or any other plumbing attachment known in the art) and an outlet port 3904 (e.g., a quick disconnect fitting, a coupler, an adapter, or any other plumbing attachment known in the art). The inlet port 3902 and the outlet port 3904 can be accessible by personnel that are external the electric vehicle 3900 (e.g., aircraft 100 from FIG. 1).

In various embodiments, each row in a battery system 1500 can include a plumbing arrangement 3910, a plumbing arrangement 3920, or any other plumbing arrangement that may be readily apparent to one skilled in the art. Although illustrated with an inlet header 3903 and an outlet header 3905, the present disclosure is not limited in this regard. For example, during charging of the electric vehicle 3900, the fluid could be routed through all of the battery modules in a plurality of battery modules 1505 of the battery system 1500 in series and out the outlet port 3904. However, in such an arrangement, the battery modules at the end of the series would be receiving a fluid that is a significantly different temperature relative to the battery modules at the beginning of the series.

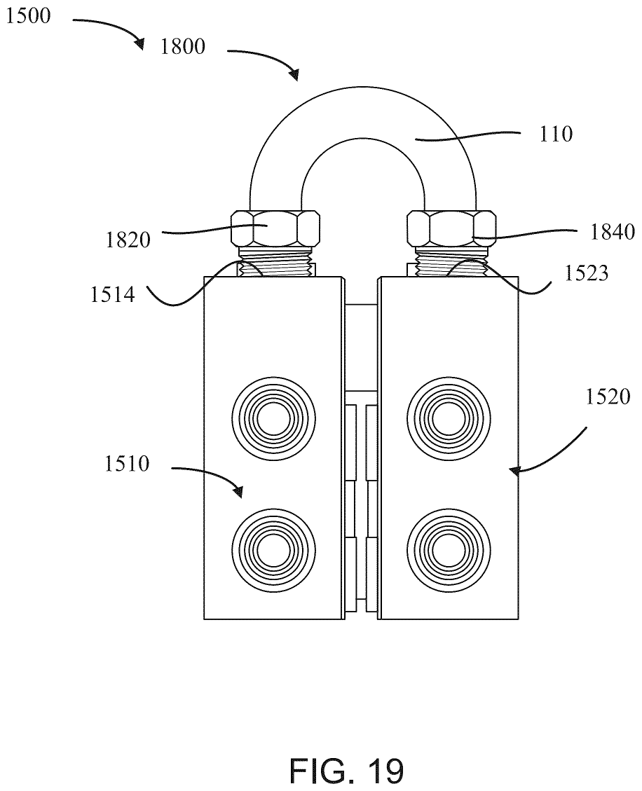

In various embodiments, in the plumbing arrangement 3910, the fluid can be routed from the inlet header 3903 through a first port 1513 of a cold plate 241 of a first 1510 of the plurality of battery modules 1505 in the respective row, then out the second port 1514 of the cold plate 241 of the first 1510 of the plurality of battery modules 1505 and into the tube 3930 (e.g., tube assembly 1800 from FIG. 19 or straight tube 2110 from plumbing arrangement 2100 from FIG. 21), into the third port 1523 of cold plate 241 of a second 1520 of the plurality of battery modules 1505 in the respective row, and so on until the second port at a last battery module in a respective row is routed back to the outlet header 3905. In various embodiments, for the 3910 arrangement, one side of the plurality of battery modules 1505 in the row of battery modules can be routed from the inlet header 3903 through the first 1510 of the plurality of battery modules 1505 in the row of battery modules to the last 1540 of the plurality of battery modules 1505 in the row of battery modules, and the other side of the plurality of battery modules 1505 in the row of battery modules can be routed from the inlet header 3903 to the last 1540 of the plurality of battery modules 1505 in the row of battery modules to the first 1510 of the plurality of battery modules 1505 in the row of battery modules and out the outlet header 3905. In this regard, a more uniform temperature gradient can be achieved across battery modules.

In various embodiments, in the plumbing arrangement 3920, the plumbing arrangement can allow the fluid to flow from the inlet header 3903 along a first side of the plurality of battery modules 1505 in the row of battery modules and back to the outlet header along a second side of the plurality of battery modules 1505 in the row of battery modules. In this regard, an amount of plumbing can be significantly reduced relative to the plumbing arrangement 3910. In various embodiments, the charging system can include a reversing valve to facilitate a change of direction of a fluid being provided during charging to alter a temperature gradient based on a flow direction during charging, in accordance with various embodiments. In various embodiments, in the plumbing arrangement 3920 a tube assembly 3940 can be included to couple a port of the cold plate 241 on one side of the last 1540 of the plurality of battery modules 1505 in the respective row to a port of the cold plate 241 on the other side (i.e., an opposite lateral side) of the last 1540 of the plurality of battery modules 1505 in the respective row. In various embodiments, the plumbing arrangements 3910, 3920 are meant to be illustrative and non-limiting to the low-profile connector embodiment described previously herein. One skilled in the art may recognize various alternative plumbing arrangements that would still be within the scope of this disclosure.

### Additional Embodiments for the Battery Systems

In various embodiments, a generally cuboid shape of the housing 210 disclosed previously herein is formed by the first lateral sidewall (e.g., sidewall 291), the second lateral sidewall (e.g., sidewall 292), the first broad sidewall (e.g., sidewall 293), the second broad sidewall (e.g., sidewall 294), the lid (e.g., lid 295), and the bottom panel (e.g., bottom panel 296).

In various embodiments, each of the plurality of battery modules 1505 of the battery system 1500 disclosed previously herein comprises: a first seam, wherein the first lateral sidewall is fused to the first broad sidewall by the first seam; a second seam, wherein the first lateral sidewall is fused to the second broad sidewall along the second seam; a third seam, wherein the second lateral sidewall is fused to the first broad sidewall along the third seam; and a fourth seam, wherein the second lateral sidewall is fused to the second broad sidewall along the fourth seam. In various embodiments, each of the plurality of battery modules 1505 of the battery system 1500 a fifth seam, wherein the lid is fused to the first lateral sidewall, the second lateral sidewall, the first broad sidewall, and the second broad sidewall along the fifth seam, and wherein the fifth seam defines a first perimeter around the lid. In various embodiments, each of the plurality of battery modules 1505 of the battery system 1500 comprises a sixth seam, wherein the bottom panel is fused to the first lateral sidewall, the second lateral sidewall, the first broad sidewall, and the second broad sidewall along the sixth seam, the sixth seam defining a second perimeter around the bottom panel.

In various embodiments, each of the plurality of battery modules 1505 described previously herein further comprises: a first electrical connector coupled to the first lateral sidewall of the housing and a second electrical connector coupled to the second lateral sidewall of the housing.

In various embodiments, the assembled configuration 1501 described previously herein comprises the second electrical connector of the first 1510 of the plurality of battery modules 1505 directly coupled to the first electrical connector of the second 1520 of the plurality of battery modules 1505. In various embodiments, each of the plurality of battery modules 1505 further comprises: a first communications connector coupled to the first lateral sidewall of the housing; and a second communications connector coupled to the second lateral sidewall of the housing; and the assembled configuration comprises the second communications connector of the first 1510 of the plurality of battery modules 1505 directly coupled to the first communications connector of the second 1520 of the plurality of battery modules 1505.

In various embodiments, the assembled configuration 1501 comprising an electrical path extending from the first electrical connector of the first 1510 of the plurality of battery modules 1505 through the plurality of cells of each of the plurality of battery modules 1505 and out the second electrical connector of a last of the plurality of battery modules 1505. In various embodiments, the first electrical connector of the first 1510 of the plurality of battery modules is a negative terminal of the battery, and the second electrical connector of the last of the plurality of battery modules 1505 is a positive terminal of the battery.

Benefits, other advantages, and solutions to problems have been described herein regarding specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods, and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching.

Finally, any of the above-described concepts can be used alone or in combination with any or all the other above-described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible considering the above teaching.

What is claimed is:

1. A battery system for supplying motive power to an electric vehicle, the battery system, comprising:
a plurality of battery modules, each of the plurality of battery modules configured to be coupled to an adjacent of the plurality of battery modules to form a battery, each of the plurality of battery modules comprising:
a housing comprising a first lateral sidewall, a second lateral sidewall, a first broad sidewall, a second broad sidewall, a bottom panel, and a lid, the first lateral sidewall spaced apart longitudinally from the second lateral sidewall, the first broad sidewall spaced apart laterally from the second broad sidewall;
a plurality of cells disposed within the housing;
a first vane plate coupled to the first broad sidewall, a first fluid conduit at least partially defined between the first vane plate and the first broad sidewall;
a first port disposed through the first lateral sidewall, the first port in fluid communication with the first fluid conduit; and
a second port disposed through the second lateral sidewall, the second port in fluid communication with the first fluid conduit; and
an assembled configuration of the battery system, the assembled configuration configured to form the battery by electrically coupling each of the plurality of battery modules together, the assembled configuration comprising:
a plumbing system configured to receive a fluid during charging of the battery to provide thermal management of the plurality of battery modules during the charging, the plumbing system comprising an inlet, an outlet, and a fluid path extending from the inlet through at least a portion of the plurality of battery modules to the outlet;
a first straight tube extending from the second port of a first of the plurality of battery modules to the first port of a second of the plurality of battery modules, the first straight tube secured to the second port of the first of the plurality of battery modules and the first port of the second of the plurality of battery modules, the first straight tube defining a portion of the fluid path.

2. The battery system of claim 1, wherein each of the plurality of battery modules further comprises:
a second vane plate coupled to the second broad sidewall, a second fluid conduit at least partially defined between the second vane plate and the second broad sidewall;
a third port disposed through the first lateral sidewall, the third port in fluid communication with the second fluid conduit; and
a fourth port disposed through the second lateral sidewall, the fourth port in fluid communication with the second fluid conduit.

3. The battery system of claim 2, wherein the assembled configuration further comprises a second straight tube extending from the fourth port of the first of the plurality of battery modules to the third port of the second of the plurality of battery modules.

4. The battery system of claim 1, wherein the first port and the second port each comprise a central axis aligned in a longitudinal direction relative to the first and the second of the plurality of battery modules.

5. The battery system of claim 1, wherein:
each of the plurality of battery modules further comprises:
a first connector disposed within the first port; and
a second connector disposed within the second port, the first connector and the second connector each comprising an annular groove, and
the assembled configuration comprises a first O-ring disposed in the annular groove of the second connector of the first of the plurality of battery modules and a second O-ring disposed in the annular groove of the first connector of the second of the plurality of battery modules.

6. The battery system of claim 5, wherein in the assembled configuration, the first O-ring is compressed between the annular groove of the second connector of the first of the plurality of battery modules and an outer diameter surface of the first straight tube and the second O-ring is compressed between the annular groove of the first connector of the second of the plurality of battery modules and the outer diameter surface of the first straight tube.

7. The battery system of claim 1, wherein in the assembled configuration, the fluid path is at least partially defined from the first port of the first of the plurality of battery modules, through the first fluid conduit of the first of the plurality of battery modules, out the second port of the first of the plurality of battery modules, through the first straight tube, into the first port of the second of the plurality of battery modules, through the first fluid conduit of the second of the plurality of battery modules, out the second port of the second of the plurality of battery modules, and through a second straight tube to at least a portion of a remaining number of the plurality of battery modules.

8. The battery system of claim 1, wherein the assembled configuration further comprises a second straight tube extending from the from the second port of the second of the plurality of battery modules to the first port of a third of the plurality of battery modules, the second straight tube secured to the second port of the second of the plurality of battery modules and the first port of the third of the plurality of battery modules.

9. The battery system of claim 8, wherein the plumbing system does not include a fluid source, and wherein the plumbing system is configured to be without a fluid disposed therein during discharging of the battery.

10. An electrically powered aircraft, comprising the battery system of claim 9, wherein the inlet and the outlet of the plumbing system are each configured to be coupled to the fluid source that is off-board the electrically powered aircraft during charging of the battery system.

11. The electrically powered aircraft of claim 10, wherein the plumbing system is configured to receive a fluid during charging, and wherein the plumbing system is configured to be without the fluid during operation of the electrically powered aircraft.

12. The battery system of claim 1, wherein the first straight tube is without fittings, adapters or attachment features.

13. The battery system of claim 1, wherein a generally cuboid shape is formed by the first lateral sidewall, the second lateral sidewall, the first broad sidewall, the second broad sidewall, the lid, and the bottom panel of the housing.

14. The battery system of claim 1, wherein each of the plurality of battery modules comprises:
a first seam, wherein the first lateral sidewall is fused to the first broad sidewall by the first seam;
a second seam, wherein the first lateral sidewall is fused to the second broad sidewall along the second seam;
a third seam, wherein the second lateral sidewall is fused to the first broad sidewall along the third seam; and
a fourth seam, wherein the second lateral sidewall is fused to the second broad sidewall along the fourth seam.

15. The battery system of claim 14, wherein each of the plurality of battery modules comprises a fifth seam, wherein the lid is fused to the first lateral sidewall, the second lateral sidewall, the first broad sidewall, and the second broad sidewall along the fifth seam, and wherein the fifth seam defines a first perimeter around the lid.

16. The battery system of claim 15, wherein each of the plurality of battery modules comprises a sixth seam, wherein the bottom panel is fused to the first lateral sidewall, the second lateral sidewall, the first broad sidewall, and the second broad sidewall along the sixth seam, the sixth seam defining a second perimeter around the bottom panel.

17. The battery system of claim 1, wherein:
each of the plurality of battery modules further comprises:
a first electrical connector coupled to the first lateral sidewall of the housing;
a second electrical connector coupled to the second lateral sidewall of the housing; and
the assembled configuration comprises the second electrical connector of the first of the plurality of battery modules directly coupled to the first electrical connector of the second of the plurality of battery modules.

18. The battery system of claim 17, wherein:
each of the plurality of battery modules further comprises:
a first communications connector coupled to the first lateral sidewall of the housing; and
a second communications connector coupled to the second lateral sidewall of the housing; and
the assembled configuration comprises the second communications connector of the first of the plurality of battery modules directly coupled to the first communications connector of the second of the plurality of battery modules.

19. The battery system of claim 18, the assembled configuration comprising an electrical path extending from the first electrical connector of the first of the plurality of battery modules through the plurality of cells of each of the plurality of battery modules and out the second electrical connector of a last of the plurality of battery modules.

20. The battery system of claim 19, wherein:
the first electrical connector of the first of the plurality of battery modules is a negative terminal of the battery, and
the second electrical connector of the last of the plurality of battery modules is a positive terminal of the battery.

21-92. (canceled)
